(19) United States
(12) Patent Application Publication
(10) Pub. No.: US 2024/0214194 A1
(43) Pub. Date: Jun. 27, 2024

(54) Systems and Methods for Facilitating Interactions between Tokens and Digital Wallets

(71) Applicant: Artema Labs, Inc, Los Angeles, CA (US)

(72) Inventors: Ajay Kapur, Valencia, CA (US); Bjorn Markus Jakobsson, New York, NY (US); Stephen C. Gerber, Austin, TX (US); Perry Raymond Cook, Jacksonville, OR (US); Joe M. Rohde, Santa Barbara, CA (US); Keir Finlow-Bates, Eura (FI); Kenneth Rosen, Portola Valley, CA (US)

(73) Assignee: Artema Labs, Inc, Los Angeles, CA (US)

(21) Appl. No.: 18/395,308

(22) Filed: Dec. 22, 2023

Related U.S. Application Data
(60) Provisional application No. 63/476,875, filed on Dec. 22, 2022.
(60) Provisional application No. 63/581,234, filed on Sep. 7, 2023.

(51) Int. Cl. H04L 9/08; G06Q 20/36

(52) U.S. Cl. CPC H04L 9/0866; G06Q 20/3678

(57) ABSTRACT

Systems and techniques to facilitate content access within an NFT platform are illustrated. One embodiment includes a method for verifying user identity. The method associates a biometric identifier of a user with: a token; and a cryptographic key, wherein the cryptographic key is associated with a set of access rights to the token. The method obtains, from a sensor, biometric data, wherein the biometric data corresponds to the user. The method verifies whether the biometric data matches the biometric identifier. When the biometric data matches the biometric identifier beyond a pre-determined threshold: the method obtains access to at least part of the cryptographic key; and accesses the token. Access is performed: using the cryptographic key, and according to the set of access rights.

### CROSS-REFERENCE TO RELATED APPLICATIONS

The current application claims the benefit of and priority under 35 U.S.C. § 119(e) to U.S. Provisional Patent Application No. 63/476,875, entitled “Immersive Personalized NFT Wallet Interactions,” filed Dec. 22, 2022, and U.S. Provisional Patent Application No. 63/581,234, entitled “Identity Assurance System,” filed Sep. 7, 2023, the disclosures of which are hereby incorporated by reference in their entireties for all purposes.

### FIELD OF THE INVENTION

The present invention generally relates to the use of tokens as identifiers, and more specifically, as assurances of identity.

### BACKGROUND

Non-fungible tokens (NFTs) provide a means for access management within computer systems and token marketplaces. This provides computer services and information vendors with an opportunity to sell NFTs as ownable assets providing access to particular content. In particular, an NFT may be used for assigning a digital representation of ownership for digital items, such as images, but also other physical items. A current holder of an NFT is typically provided asset usage rights for the underlying NFT asset. NFTs and other forms of tokens representing content have the capability to bolster a number of industries including but not limited to art, music, and technology.

### SUMMARY OF THE INVENTION

Systems and techniques to facilitate content access within an NFT platform are illustrated. One embodiment includes a method for verifying user identity. The method associates a biometric identifier of a user with: a token; and a cryptographic key, wherein the cryptographic key is associated with a set of access rights to the token. The method obtains, from a sensor, biometric data, wherein the biometric data corresponds to the user. The method verifies whether the biometric data matches the biometric identifier. When the biometric data matches the biometric identifier beyond a pre-determined threshold: the method obtains access to at least part of the cryptographic key; and accesses the token. Access is performed: using the cryptographic key, and according to the set of access rights.

In a further embodiment, the token is a non-fungible token (NFT).

In a further embodiment: the NFT is associated with media content; and the NFT is stored in a digital wallet owned by the user.

In a still further embodiment, an access right of the set of access rights is selected from the group consisting of viewing the media content associated with the token, editing the media content associated with the token, copying the token, transferring the token, deleting digital assets associated with the token, assigning at least one access right to another entity, and revoking the association between the biometric identifier and the set of access rights.

In a still yet further embodiment, the sensor is a camera. The sensor is additionally configured to: detect when the user views the media content associated with the token; and identify aspects of the media content that the user focuses on.

In a further embodiment, the method curates additional content in the digital wallet according to the aspects; and/or sends a creator of the token a royalty when the user views the media content associated with the token.

In another embodiment, the set of access rights is determined based on a policy associated with the token.

In a further embodiment, the policy is associated with a smart contract.

In another embodiment, the association between the biometric identifier and the set of access rights is at least one of: an association expressed using a certificate; an association that has a pre-determined duration based on a policy associated with the token; or an association that is revocable by a party with an access right.

In another embodiment, access to a remaining part of the cryptographic key is obtained using a digital signature.

One embodiment includes a non-transitory computer-readable medium storing instructions that, when executed by a processor, are configured to cause the processor to perform operations for verifying user identity. The processor associates a biometric identifier of a user with: a token; and a cryptographic key, wherein the cryptographic key is associated with a set of access rights to the token. The processor obtains, from a sensor, biometric data, wherein the biometric data corresponds to the user. The processor verifies whether the biometric data matches the biometric identifier. When the biometric data matches the biometric identifier beyond a pre-determined threshold: the processor obtains access to at least part of the cryptographic key; and accesses the token. Access is performed: using the cryptographic key, and according to the set of access rights.

In a further embodiment, the token is a non-fungible token (NFT).

In a further embodiment: the NFT is associated with media content; and the NFT is stored in a digital wallet owned by the user.

In a still further embodiment, an access right of the set of access rights is selected from the group consisting of viewing the media content associated with the token, editing the media content associated with the token, copying the token, transferring the token, deleting digital assets associated with the token, assigning at least one access right to another entity, and revoking the association between the biometric identifier and the set of access rights.

In a still yet further embodiment, the sensor is a camera. The sensor is additionally configured to: detect when the user views the media content associated with the token; and identify aspects of the media content that the user focuses on.

In a further embodiment, the processor curates additional content in the digital wallet according to the aspects; and/or sends a creator of the token a royalty when the user views the media content associated with the token.

In another embodiment, the set of access rights is determined based on a policy associated with the token.

In a further embodiment, the policy is associated with a smart contract.

In another embodiment, the association between the biometric identifier and the set of access rights is at least one of: an association expressed using a certificate; an association that has a pre-determined duration based on a policy associated with the token; or an association that is revocable by a party with an access right.

In another embodiment, access to a remaining part of the cryptographic key is obtained using a digital signature.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with some embodiments of the invention.

FIG. 2 is a network architecture diagram of an NFT platform in accordance with numerous embodiments of the invention.

FIG. 3 is a conceptual diagram of a permissioned blockchain in accordance with multiple embodiments of the invention.

FIG. 4 is a conceptual diagram of a permissionless blockchain in accordance with many embodiments of the invention.

FIGS. 5A-5B are diagrams of a dual blockchain in accordance with a number of embodiments of the invention.

FIG. 6 conceptually illustrates a process followed by a Proof of Work consensus mechanism in accordance with some embodiments of the invention.

FIG. 7 conceptually illustrates a process followed by a Proof of Space consensus mechanism in accordance with a number of embodiments of the invention.

FIG. 8 illustrates a dual proof consensus mechanism configuration in accordance with certain embodiments of the invention.

FIG. 9 illustrates a process followed by a Trusted Execution Environment-based consensus mechanism in accordance with some embodiments of the invention

FIGS. 10-12 depicts various devices that may be utilized alongside an NFT platform in accordance with various embodiments of the invention.

FIGS. 13A-13B depicts media wallet applications configuration in accordance with several embodiments of the invention.

FIGS. 14A-14C depicts user interfaces of various media wallet applications in accordance with a number of embodiments of the invention.

FIG. 15 illustrates an NFT ledger entry corresponding to an NFT identifier in accordance with certain embodiments of the invention.

FIGS. 16A-16B illustrate an NFT arrangement relationship with corresponding physical content in accordance with many embodiments of the invention.

FIG. 17 illustrates a process for establishing a relationship between an NFT and corresponding physical content in accordance with some embodiments of the invention.

FIG. 18A illustrates an example usage of an access token for entering a physical safety deposit box bank vault in accordance with a few embodiments of the invention.

FIG. 18B illustrates an example of an employee purchasing lunch at a workplace cafeteria using their employee token and a payment token in accordance with some embodiments of the invention.

FIG. 19 illustrates an example of a relationship between anchored tokens and relative tokens in accordance with a number of embodiments of the invention.

FIG. 20 illustrates an example of the movement of rights from an anchored token to a relative token in accordance with multiple embodiments of the invention.

FIG. 21 illustrates a process of encrypting biometric data in accordance with some embodiments of the invention.

FIG. 22 illustrates generation of encrypted mask arrays in accordance with various embodiments of the invention.

FIG. 23 illustrates an architecture of a client device in accordance with certain embodiments of the invention.

FIG. 24 illustrates a process of generating an array using biometric input in accordance with numerous embodiments of the invention.

FIG. 25A illustrates generation of an array from a biometric input in accordance with many embodiments of the invention.

FIG. 25B illustrates masking of an array in accordance with several embodiments of the invention.

FIG. 26 illustrates a process of authentication using biometric tokens in accordance with particular embodiments of the invention.

FIG. 27 conceptually illustrates an example system for tying recognition badge achievements by an organization to a user's identity in accordance with miscellaneous embodiments of the invention.

FIG. 28 conceptually illustrates a process for combining two tokens from two organizations into one or more new tokens in accordance with certain embodiments of the invention.

FIG. 29 conceptually illustrates an example process using portable and reusable recognition badges within two or more entities in accordance with multiple embodiments of the invention.

FIG. 30 conceptually illustrates an example process for using redeemable recognition badges in the form of tokens in accordance with various embodiments of the invention.

FIG. 31 conceptually illustrates an example process for the prediction of potential future badge awards in accordance with certain embodiments of the invention.

FIG. 32 illustrates a process for the configuration of content based on an audience, performed in accordance with many embodiments of the invention.

FIG. 33 illustrates a determination of user attention, performed in accordance with certain embodiments of the invention.

FIG. 34 illustrates a process for radio identification of users, performed in accordance with several embodiments of the invention.

FIG. 35 illustrates an encrypted identity proving scheme, performed in accordance with several embodiments of the invention.

FIG. 36 illustrates a process for identity assurance, performed in accordance with multiple embodiments of the invention.

FIG. 37 illustrates a process for continuous proximity attestation, performed in accordance with various embodiments of the invention.

FIG. 38 illustrates a block diagram depicting the storage of token balances by smart contracts configured in accordance with many embodiments of the invention.

FIG. 39 illustrates a block diagram depicting the storage of signed integer token balances by smart contracts configured in accordance with various embodiments of the invention.

FIG. 40 illustrates a block diagram depicting the storage of floating point integer token balances by smart contracts configured in accordance with many embodiments of the invention.

FIG. 41 illustrates a block diagram depicting the storage of balances, corresponding to a specific game, by smart contracts configured in accordance with some embodiments of the invention.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### DETAILED DESCRIPTION

Under a rich media blockchain in accordance with many embodiments of the invention, a wide variety of identification-directed configurations, including but not limited to NFT configurations may be implemented. Specifically, systems in accordance with various embodiments of the invention may utilize anchor elements that a verifier can determine are associated directly with the particular users. Some anchor elements may take the form of tokens (e.g., NFTs), and be tied to external elements such as physical entities (including but not limited to individuals). Anchor elements configured in accordance with many embodiments of the invention may be associated with public keys, enabling the use of corresponding private keys to make publicly verifiable assertions of identity that are tied to the anchor element (including but not limited to the identification of individuals). Verification can be performed in ways including but not limited to cryptographic authentication.

NFT security platforms in accordance with many embodiments of the invention may incorporate biometric authentication into anchored NFTs with remote authentication using cryptographic keys, where cryptographic keys may be derived from data stored in biometric tokens. In several embodiments, cryptographic keys may be derived from data provided by biometric inputs. NFT security platforms in accordance with many embodiments of the invention may use cryptographic keys to minimize various security risks, including in particular, risks associated with brute-force attacks where attackers may have access to tokens among other types of attacks.

Identity tokens are another type of anchored token, that is bound to an individual. The identity token can, additionally or alternatively, be tied to a media element to assert a relationship between the media element and the user associated with the identity token. A media element may include but is not limited to a movie, a text file, a song, a voice file, a message, etc. As such, systems in accordance with some embodiments may perform likeness verifications including but not limited to the identity of the actor of a specific movie, the interviewee of a specific news broadcast, and/or the singer of a specific vocalization.

In several embodiments, non-fungible tokens (NFTs) may be minted, which represent digital recognition badges. In some embodiments, recognition badges are tied to identifiers and may be awarded based on the completion of certain tasks by the identified party. In certain embodiments, earned badges may be assigned manually and/or automatically. Further, recognition badges may be tokens that (conditionally) provide access to content.

While various techniques and systems are discussed above, identifying mechanisms that may be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators may issue NFTs to users within the NFT platform. NFTs may be created around a large range of real-world media content and intellectual property. Movie studios may mint digital collectibles for their movies, characters, notable scenes and/or notable objects. Record labels may mint digital collectibles for artists, bands, albums and/or songs. Similarly, official digital trading cards may be made from likeness of celebrities, cartoon characters and/or gaming avatars.

NFTs minted using NFT platforms in accordance with various embodiments of the invention may have multifunctional programmable use cases including rewards, private access to premium content and experiences, as discounts toward the purchase of goods, among many other value-added use cases.

In many embodiments, each NFT may have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs may be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance may allow for incremental payment and ongoing asset protection. NFT storage may be additionally self-regulated through willing participants disclosing unsatisfactory NFT management in exchange for rewards.

In many embodiments, the NFT platform may include media wallet applications that enable users to securely store NFTs and/or other tokens on their devices. Furthermore, media wallets (also referred to as “digital wallets”) may enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users may download and install media wallet applications to store NFTs on the same computing devices used to consume streamed and/or downloaded content. Media wallet applications and NFTs may disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that may be utilized within NFT platforms in accordance with various embodiments of the invention are discussed further below.

### NFT Platforms

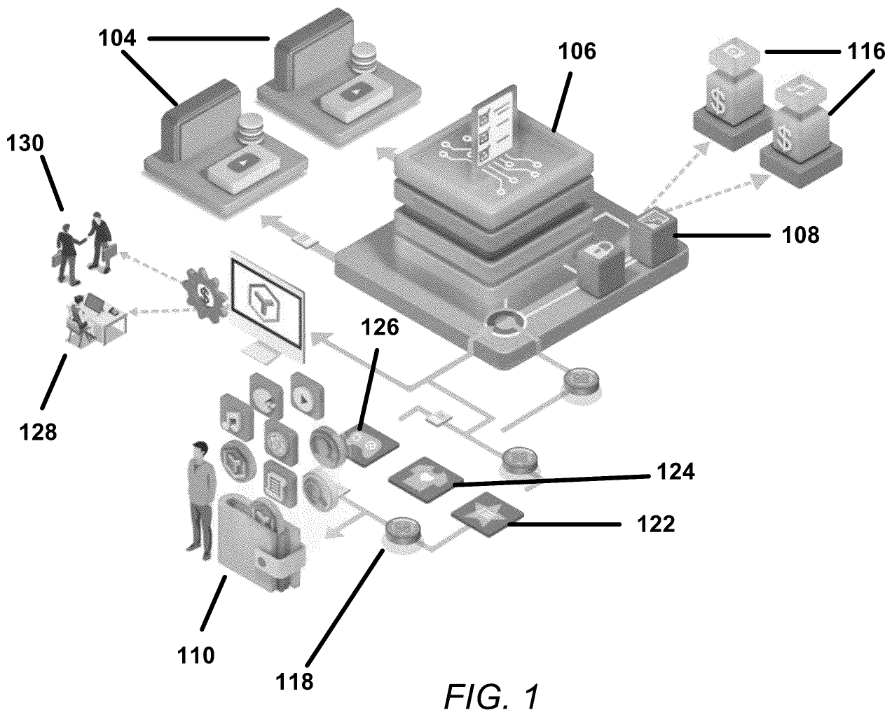

An NFT platform in accordance with an embodiments of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 may provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs may cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users may use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As may readily be appreciated, NFTs 106 that are implemented using smart contracts 108 having interfaces that comply with open standards are not limited to being stored within media wallets and may be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 may incentivize users to grant access to media consumption data using offers including (but not limited to) offers of fungible tokens 118 and/or NFTs 106. In this way, the ability of the content creators to mint NFTs enables consumers to engage directly with the content creators and may be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 may query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users may be content creators that are vetted by an administrator of networks that may be responsible for deploying and maintaining the NFT blockchain. Once the NFTs are minted, users may obtain and conduct transactions with the NFTs. In several embodiments, the NFTs may be redeemable for items or services in the real world such as (but not limited to) admission to movie screenings, concerts, and/or merchandise.

As illustrated in FIG. 1, users may install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens may be fully converted into fiat currency and/or other cryptocurrency. In several embodiments, the fungible tokens are implemented using split blockchain models in which the fungible tokens may be issued to multiple blockchains (e.g. Ethereum). As may readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application may automatically provide simplified views whereby fungible tokens and NFTs across multiple accounts and/or multiple blockchains may be rendered as single user profiles and/or wallets. In many embodiments, the single view may be achieved using deep-indexing of the relevant blockchains and API services that may rapidly provide information to media wallet applications in response to user interactions. In certain embodiments, the accounts across the multiple blockchains may be derived using BIP32 deterministic wallet key. In other embodiments, any of a variety of techniques may be utilized by the media wallet application to access one or more immutable ledgers as appropriate to the requirements of a given application.

NFTs may be purchased by way of exchanges 130 and/or from other users 128. In addition, content creators may directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and may be utilized in any NFT platform and/or with any media wallet application.

While the NFTs are shown as static in the illustrated embodiment, content creators may utilize users' ownership of NFTs to engage in additional interactions with the user. In this way, the relationship between users and particular pieces of content and/or particular content creators may evolve over time around interactions driven by NFTs. In a number of embodiments, collection of NFTs may be gamified to enable unlocking of additional NFTs. In addition, leaderboards may be established with respect to particular content and/or franchises based upon users' aggregation of NFTs. As is discussed further below, NFTs and/or fungible tokens may also be utilized by content creators to incentivize users to share data.

NFTs minted in accordance with several embodiments of the invention may incorporate a series of instances of digital content elements in order to represent the evolution of the digital content over time. Each one of these digital elements may have multiple numbered copies, just like a lithograph, and each such version may have a serial number associated with it, and/or digital signatures authenticating its validity. The digital signature may associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications may request authentication of the NFT directly based upon the public key of the content creator and/or indirectly based upon transaction records within the NFT blockchain. As discussed above, minted NFTs may be signed by content creators and administrators of the NFT blockchain. In addition, users may verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein may also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain may be in the form of distributed ledgers, while the blockchain may alternatively be centralized in a single entity.

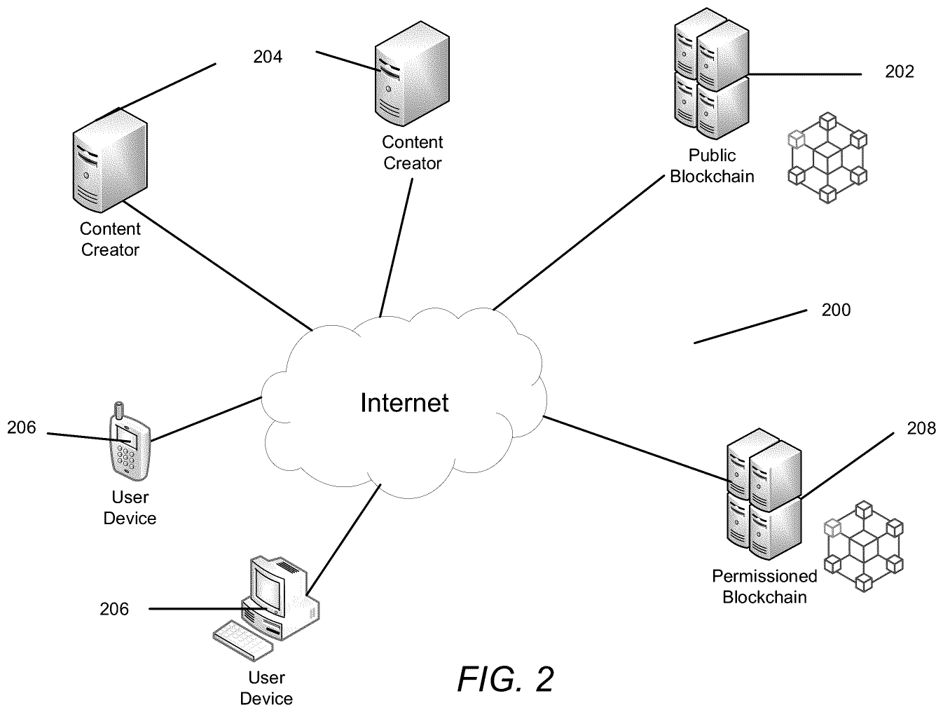

An example of network architecture that may be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 may support minting of standards based NFTs that may be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform may also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users may utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications may provide any of a variety of functionality that may be determined as appropriate to the requirements of a given application. In the illustrated embodiment, the user devices 206 are shown as mobile phones and personal computers. As may readily be appreciated user devices may be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data may be accessed by the media wallet application. In this way, users control access to entries in the permissioned blockchain 208 describing the user's NFT transaction. In several embodiments, users may authorize content creators 204 to access NFT transaction data recorded within the permissioned blockchain 208 using one of a number of appropriate mechanisms including (but not limited to) compound identities where the user is the owner of the data and the user may authorize other entities as guests that may also access the data. As may readily be appreciated, particular content creators' access to the data may be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they may make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users may utilize a media wallet application to modify permissions granted by way of the access control list. In many embodiments, the manner in which access permissions are defined enables different restrictions to be placed on particular pieces of information within a particular NFT transaction data record within the permissioned blockchain 208. As may readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists may enable users to grant permission to decrypt certain pieces of information or individual records within the permissioned blockchain. In several embodiments, the access to the data is determined by computer systems that implement permission-based data access services.

In many embodiments, the permissioned blockchain 208 may be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention may be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms may be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As may readily be appreciated, a variety of approaches may be taken to the writing of data to permissioned blockchains and the particular approach is largely determined by the requirements of particular applications. As such, computer systems in accordance with various embodiments of the invention may have the capacity to create verified NFT entries written to permissioned blockchains.

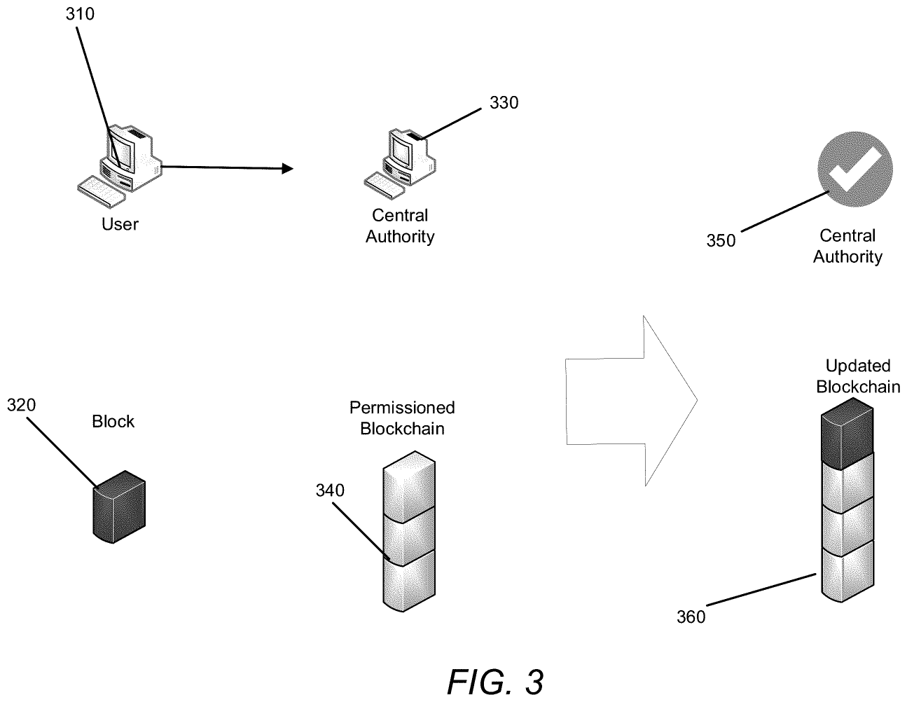

An implementation of permissioned (or private) blockchains in accordance with some embodiments of the invention is illustrated in FIG. 3. Permissioned blockchains 340 may typically function as closed computing systems in which each participant is well defined. In several embodiments, private blockchain networks may require invitations. In a number of embodiments, entries, or blocks 320, to private blockchains may be validated. In some embodiments, the validation may come from central authorities 330. Private blockchains may allow an organization or a consortium of organizations to efficiently exchange information and record transactions. Specifically, in a permissioned blockchain, a preapproved central authority 330 (which should be understood as potentially encompassing multiple distinct authorized authorities) may approve a change to the blockchain. In a number of embodiments, approval may come without the use of a consensus mechanism involving multiple authorities. As such, through a direct request from users 310 to the central authority 330, the determination of whether blocks 320 may be allowed access to the permissioned blockchain 340 may be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 may reflect the added block 320.

NFT platforms in accordance with many embodiments of the invention may also benefit from the anonymity and accessibility of a public blockchain. Therefore, NFT platforms in accordance with many embodiments of the invention may have the capacity to create verified NFT entries written to a permissioned blockchain.

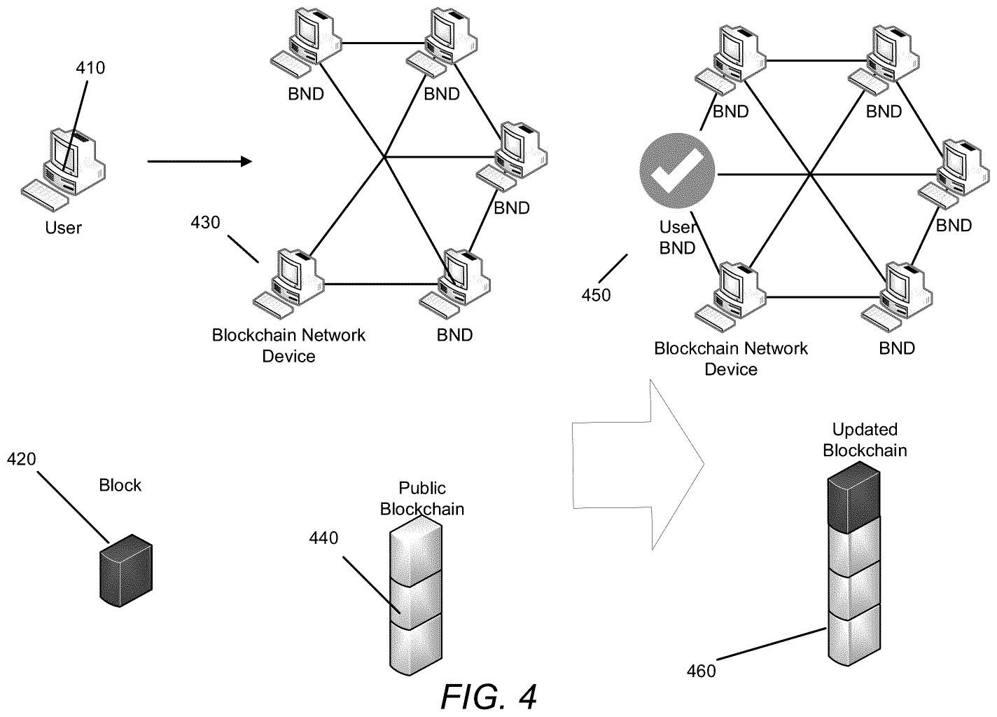

An implementation of a permissionless, decentralized, or public blockchain in accordance with an embodiments of the invention is illustrated in FIG. 4. In a permissionless blockchain, individual users 410 may directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even when anonymously made, making it immutable. In many decentralized blockchains, many blockchain network devices 430, in the decentralized system may have copies of the blockchain, allowing the ability to validate transactions. In many instances, the blockchain network device 430 may personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that may be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention may therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references may be stored by adding a ledger entry incorporating the reference enabling the entry to be timestamped. In doing so, the URL, which typically accounts for domain names, may be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

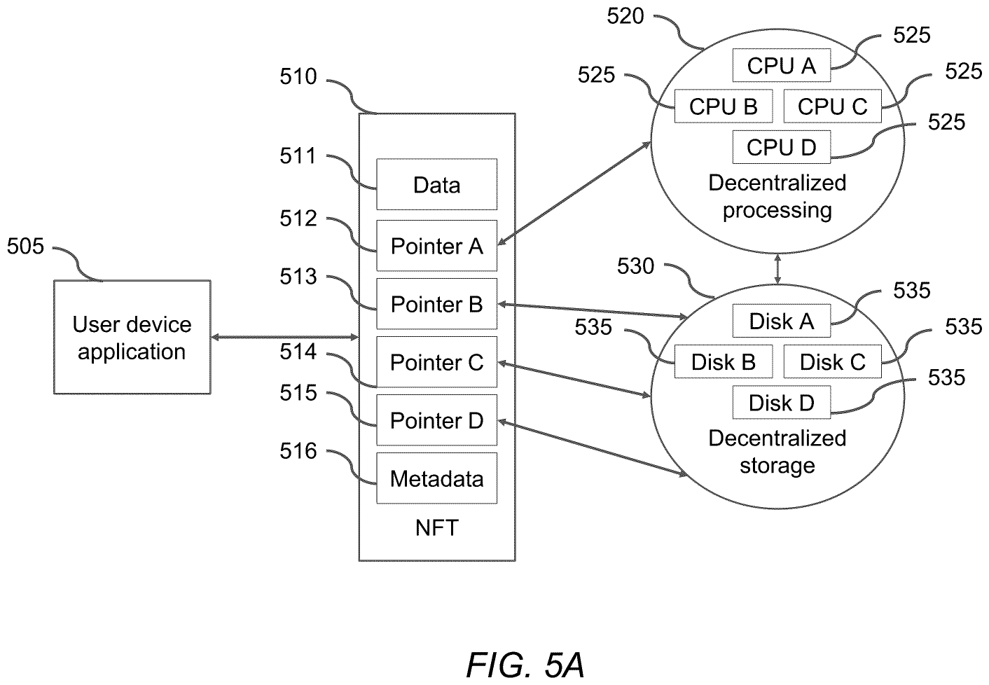

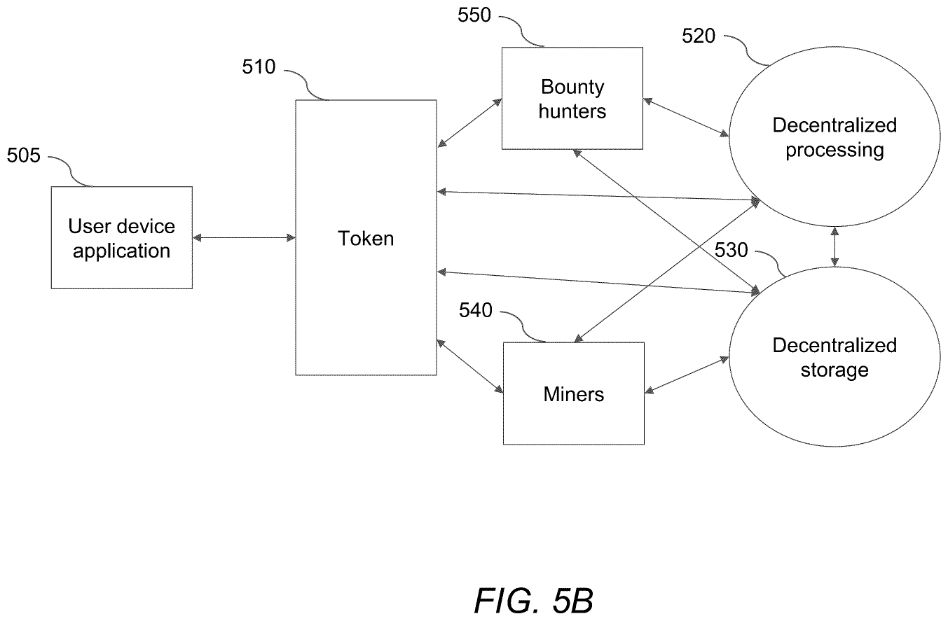

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 may direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiments of the invention. Bounty hunters 550 allow NFTs 510, which may point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 may have the capacity to perform all necessary minting processes or any process within the architecture that involves a consensus mechanism.

Bounty hunters 550 may also choose to verify each step of a computation, and when they find an error, submit evidence of this in return for some reward. This may have the effect of invalidating the incorrect ledger entry and, potentially based on policies, all subsequent ledger entries. Such evidence may be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. When the evidence in question has not been submitted before, this may automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein may also be implemented outside the context of an NFT platform network architecture unrelated to the storage of fungible tokens and/or NFTs. A variety of components, mechanisms, and blockchain configurations that may be utilized within NFT platforms are discussed further below. Moreover, any of the blockchain configurations described herein with reference to FIGS. 3-5B (including permissioned, permissionless, and/or hybrid mechanisms) may be utilized within any of the networks implemented within the NFT platforms described above.

### NFT Platform Consensus Mechanisms

NFT platforms in accordance with many embodiments of the invention may depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (POS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor may be memory rather than processing power. Specifically, Proof of Space mechanisms may perform this through network optimization challenges. In several embodiments, the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

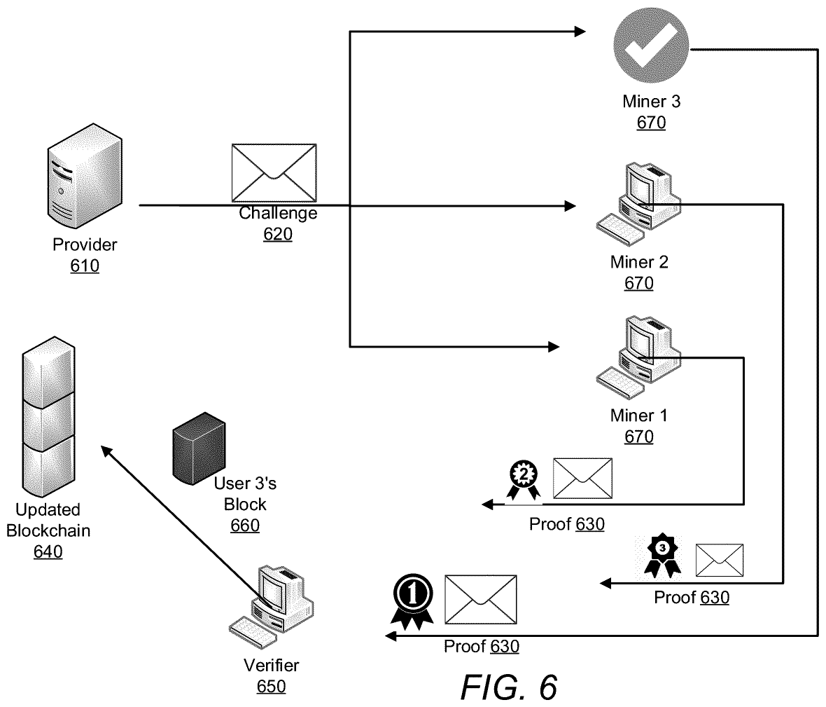

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network may verify the proof, something which typically requires much less processing power, to determine the first device that would have the right to add the winning block 650 to the blockchain 630. As such, under a Proof of Work consensus mechanism, each miner involved may have a success probability proportional to the computational effort expended.

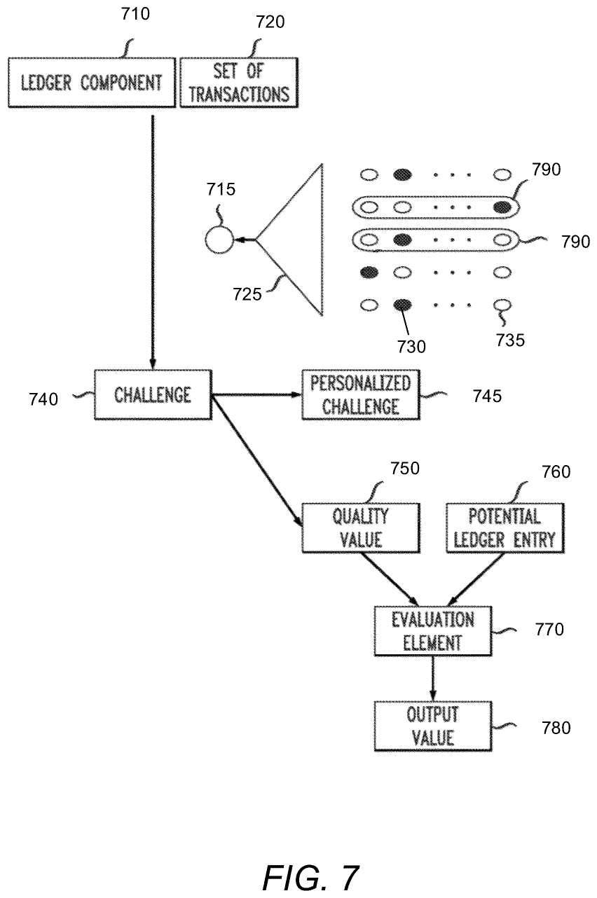

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments, the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and may be used to compute values at a setup time. This may be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 may be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 may indicate a selection of nodes 730, denoted in FIG. 7 by filled-in circles. In the FIG. 7 example specifically, the personalized challenge corresponds to one node per row. The collection of nodes selected as a result of computing the personalized challenge 745 may correspond to a valid potential ledger entry 760. However, here a quality value 750 (also referred to herein as a qualifying function value) may also be computed from the challenge 740, or from other public information that is preferably not under the control of any one miner.

A miner may perform matching evaluations 770 to determine whether the set of selected nodes 730 matches the quality value 750. This process may take into consideration what the memory constraints of the miner are, causing the evaluation 770 to succeed with a greater frequency for larger memory configurations than for smaller memory configurations. This may simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 may also correspond to public keys. The miner may submit valid ledger entries, corresponding to a challenge-response pair including one of these nodes. In that case, public key values may become associated with the obtained NFT. As such, miners may use a corresponding secret/private key to sign transaction requests, such as purchases. Additionally, any type of digital signature may be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems may also be implemented in accordance with many embodiments of the invention. In many embodiments, hybrid methods may be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures may be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments may utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

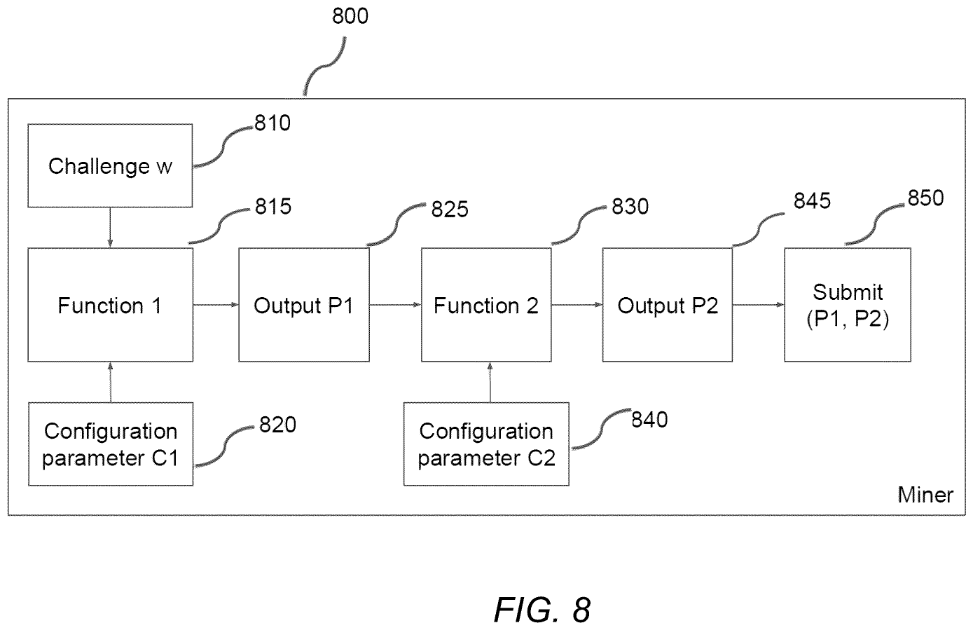

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof may be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention may constrain the search space for the mining effort. This may be done using a configuration parameter that controls the range of random or pseudo-random numbers that may be used in a proof. Upon challenge w 810 being issued to one or more miners 800, it may be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 may then submit the combination of proofs (P1, P2) 850 to a verifier, in order to validate a ledger associated with challenge w 810. In some embodiments, miner 800 may also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

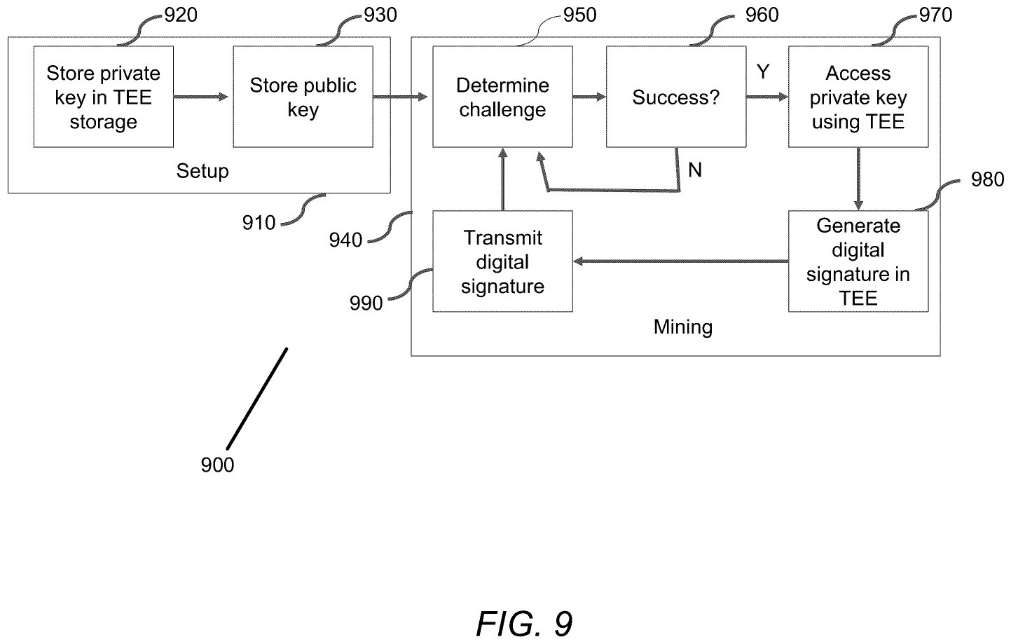

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it may be shielded from applications running outside the TEE. Additionally, processes may store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate may be stored with the public key.

In many embodiments of the invention, mining-directed steps may also be influenced by the TEE. In the illustrated embodiment, the process 900 may determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments, the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 may return to determine (950) a new challenge. In this context, process 900 may determine (950) a new challenge after the ledger contents have been updated and/or a time-based observation is performed. In several embodiments, the determination of a new challenge may come from any of a number of approaches appropriate to the requirements of specific applications, including, but not limited to, the observation of as a second elapsing since the last challenge. When the challenge corresponds to a success 960, then the processing may continue on to access (970) the private key using the TEE.

When the private key is accessed, process may generate (980) a digital signature using the TEE. The digital signature may be on a message that includes the challenge and/or which otherwise references the ledger entry being closed. Process 900 may also transmit (980) the digital signature to other participants implementing the consensus mechanism. In cases where multiple digital signatures are received and found to be valid, a tie-breaking mechanism may be used to evaluate the consensus. For example, one possible tie-breaking mechanism may be to select the winner as the party with the digital signature that represents the smallest numerical value when interpreted as a number. In several embodiments, the tie-breaking mechanism may be selected from any of a number of alternate tie-breaking mechanisms appropriate to the requirements of specific applications.

While specific consensus processes are described above, any of a variety of processes may be utilized as appropriate to the requirements of specific applications. In certain embodiments, steps may be executed and/or performed in any order or sequence not limited to the order and sequence shown and described. In a number of embodiments, some of the above steps may be executed or performed substantially simultaneously where appropriate and/or in parallel to reduce latency and processing times. In some embodiments, one or more of the above steps may be omitted.

Applications and methods in accordance with various embodiments of the invention are not limited to use within NFT platforms. Accordingly, it should be appreciated that consensus mechanisms described herein may also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) may be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that may be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As may readily be appreciated each of these computer systems may be implemented using one or more of any of a variety of classes of computing devices including (but not limited to) mobile phone handsets, tablet computers, laptop computers, personal computers, gaming consoles, televisions, set top boxes and/or other classes of computing device.

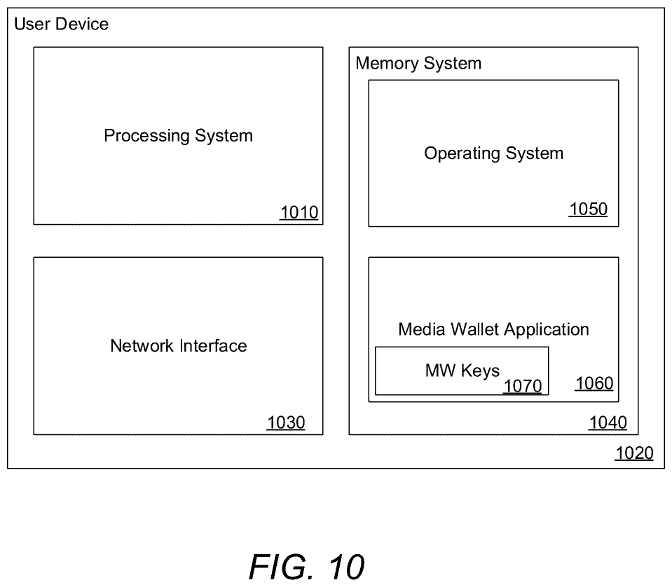

A user device capable of communicating with an NFT platform in accordance with an embodiments of the invention is illustrated in FIG. 10. The memory system 1040 of particular user devices may include an operating system 1050 and media wallet applications 1060. Media wallet applications may include sets of media wallet (MW) keys 1070 that may include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention. In accordance with many embodiments, user devices may include at least one processor, which may be configured to process input data according to instructions stored in memory. The memory may be a tangible, non-transitory, computer-readable medium configured to store instructions that are executable by the processor. For example, the memory may be data storage that can be loaded with software code that is executable by the processor to achieve certain functions.

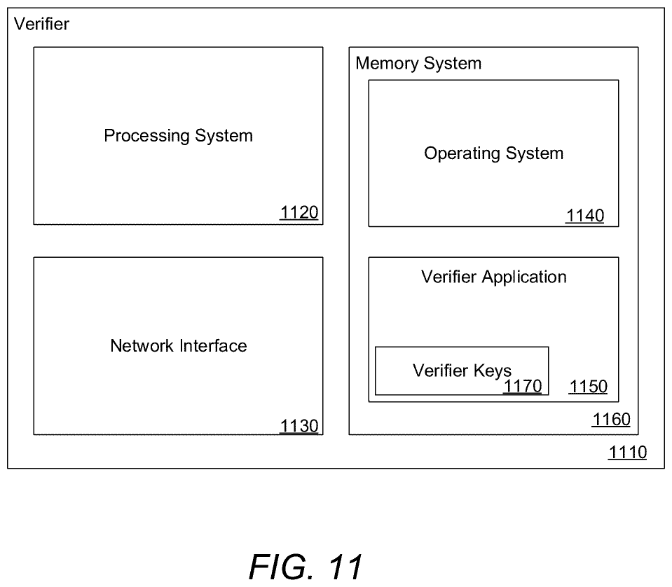

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries may be verified, the verifier application 1150 may transmit blocks to the corresponding blockchains. The verifier application 1150 may also implement some or all of the various functions described above with reference to verifiers as appropriate to the requirements of a given application in accordance with various embodiments of the invention.

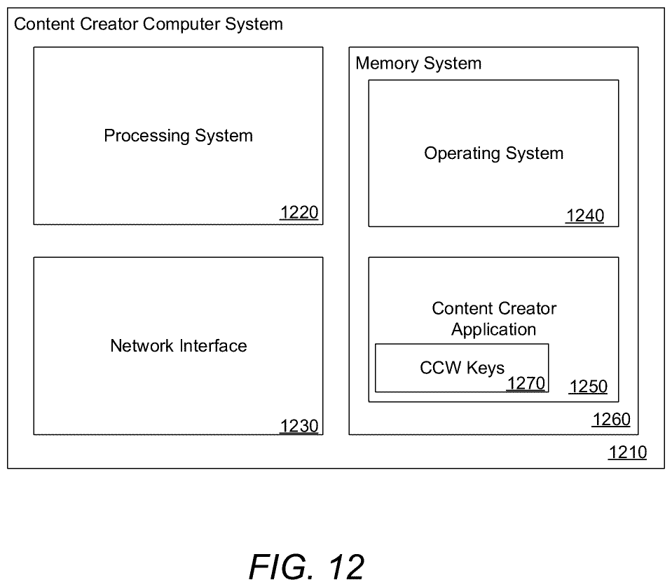

A content creator system 1210 capable of disseminating content in an NFT platform in accordance with an embodiments of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application may include sets of content creator wallet (CCW) keys 1270 that may include a public key/private key pairs. Content creator applications may use these keys to sign NFTs minted by the content creator application. The content creator application may also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions may be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party may indicate their relationship with the wallet; whether they may read summary data associated with the content; whether they have access to peruse the content; whether they may place bids to purchase the content; whether they may borrow the content, and/or whether they are biometrically authenticated.

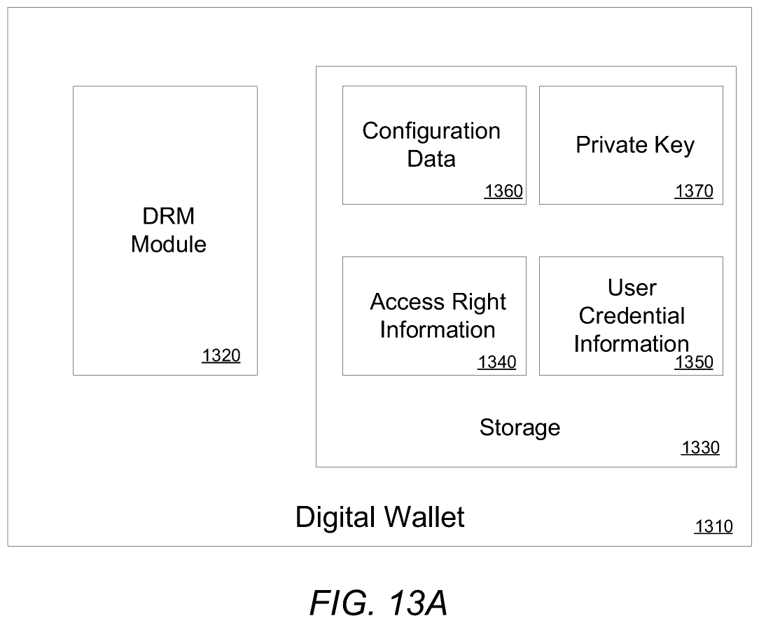

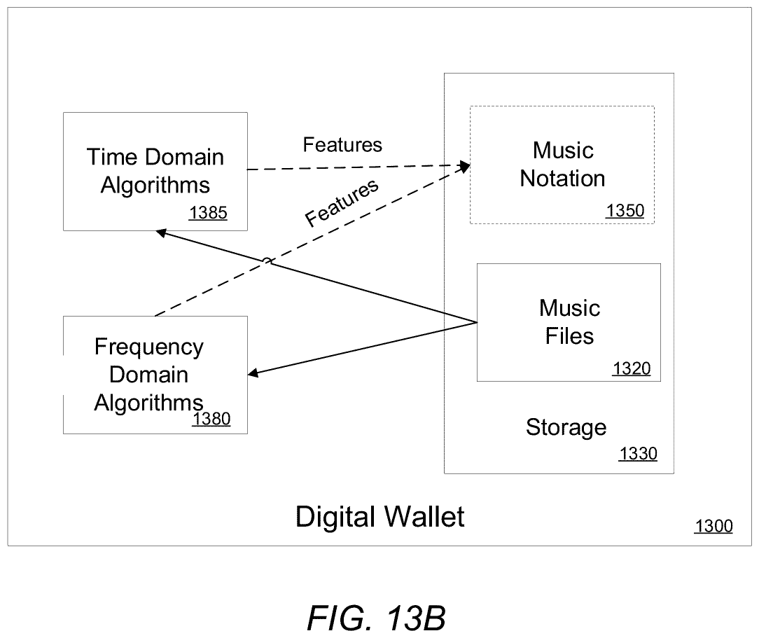

An example of a media wallet 1310 capable of storing rich media NFTs in accordance with an embodiments of the invention is illustrated in FIG. 13A. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally or alternatively, said systems may require one or more keys (typically a certificate containing a public key/private key pair) that may be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

Systems and methods in accordance with some embodiments may enable interaction between media wallets and various immersive experiences. For example, systems may be implemented by certain users and/or NFT collectors who visit theme parks and/or experience museums including but not limited to Disney™ Theme Park, and/or Meow Wolf™ experiences. The rides and/or immersive experiences may install systems to communicate with the users and/or audience wallets to personalize the UI of the immersive experience (e.g., in response to the users' acceptance, request, and/or approval). In such cases, as the users go through the experience, it may be personalized based on the experience's access to the media wallets and associated indicators, including but not limited to user gaze and attention. Potential applications of systems to immersive experiences are elaborated on below.

An additional example of a media wallets configured in accordance with multiple embodiments of the invention is illustrated in FIG. 13B. Such media wallets 1300 configurations may (in addition or alternative to the features disclosed in FIG. 13A) include but are not limited to a storage component 1330 and one or more algorithms for extracting features from stored files. The storage component 1330 may be used to store music files 1390 owned and/or licensed by users. Immersive environments (e.g., an immersive experience that has musical and/or visual elements) may connect with the media wallet(s) 1300 granting access to the stored files including but not limited to the music files 1390. This connection may be enabled using protocols authenticating and granting permission to connect (e.g., wireless protocols including but not limited to Wi-Fi and/or Bluetooth).

Media wallets 1300 configured in accordance with some embodiments may take music files 1390 and run signal processing on them using various algorithms. For example, the media wallets may utilize time domain 1385 and/or frequency domain algorithms 1380 for feature extraction. These (extracted) features may be combined to create representational sets of music notation 1395. The music notation 1395 may contain onset (time) and/or pitch data kept in the storage component 1330. In accordance with several embodiments of the invention, the music notation 1395 may be stored as Open Sound Control and/or MIDI messages inside the media wallets 1300 (e.g., until used to interact with the immersive installation).

Systems in accordance with several embodiments may utilize installations of digital and/or mechatronic musical instruments which may gain access to the digital wallets and evaluate the music files in the wallets. The installations may personalize and mimic the musical material in the wallets using various digital signal processing techniques to determine features including but not limited to onsets, instruments, and form (e.g., using modern AI music techniques). The systems may go through digital wallets, perform music extraction techniques on some or all of the music files to extract information (such as rhythm onsets and pitch) from the original audio files, and/or convert that transcribed data into elements that may interact with installations (e.g., MIDI and/or Open Sound Control-based). In accordance with some embodiments, installations may be triggered by music data and/or time-based onset triggers.

In accordance with multiple embodiments of the invention, the availability of the option to render content on external display entities, including but not limited to screens and/or loudspeakers, may be conveyed to user devices including but not limited to phones and/or wearable devices. Conveyance may include but is not limited to the use of push notifications to the devices and/or by the devices periodically identifying options for rendering and conveying content to users. Users may indicate to render content on a selected display entity for one particular use, e.g., to render a particular content element. Users may, additionally or alternatively, indicate never to show a given external display entity as an option, and/or to always indicate it as a favored option. Users may select an external display entity from a list of pre-approved entities, where such pre-approval may be provided by the users and/or agents including but not limited to an ombudsman, an employer, a guardian, etc. The users may, additionally or alternatively, select to render items on any external display entity in the list of available external display entities. This may already have been curated to remove options that are considered undesirable and/or risky using risk assessment entities that may be part of the wallets, and/or which may be external entities that provide feedback on external displays. The assessment may be based on rules and policies associated with the users and/or their wallets, and/or by security rules obtained from external sources. Additionally or alternatively, assessments may be based on the certificates associated with the available external display entities that are detected.

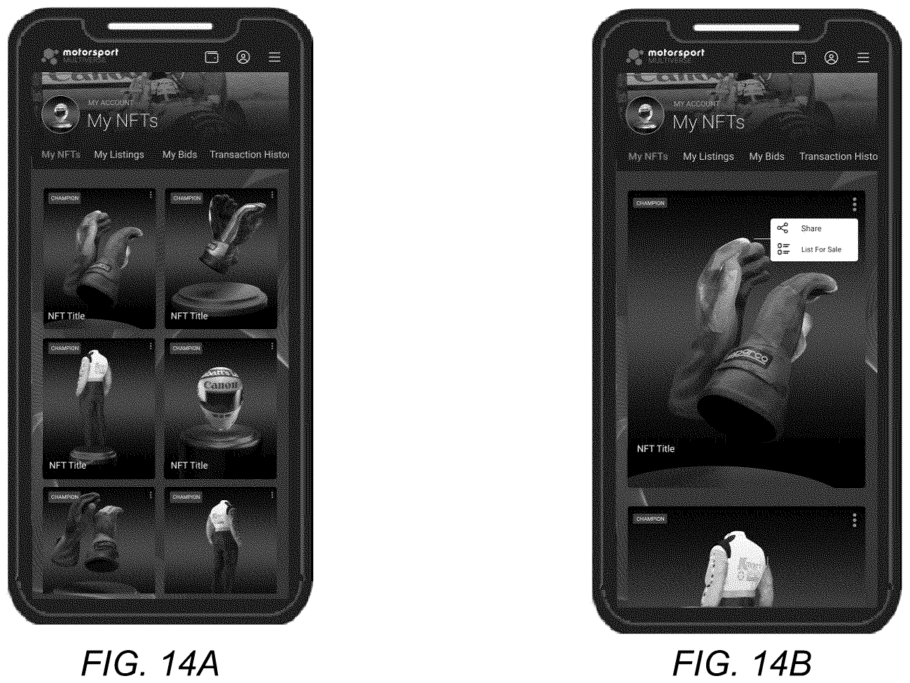

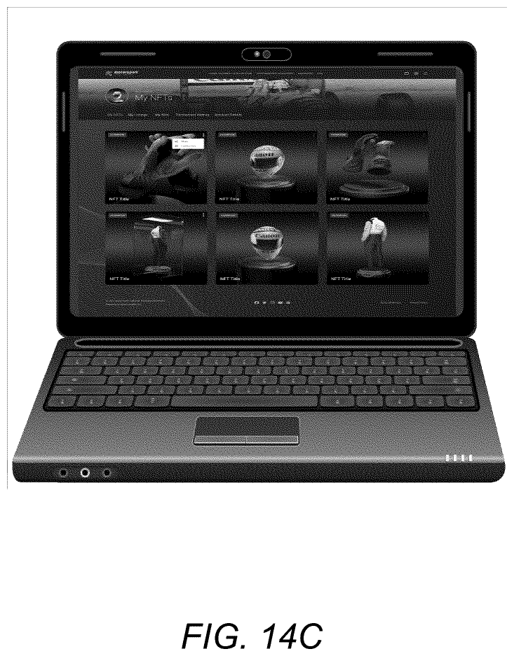

Operation of additional media wallet applications implemented in accordance with some embodiments of the invention is conceptually illustrated by way of the user interfaces shown in FIGS. 14A-14C. In many embodiments, media wallet applications may refer to applications that are installed upon user devices such as (but not limited to) mobile phones and tablet computers running the IOS, Android and/or similar operating systems. Launching media wallet applications may provide a number of user interface contexts. In many embodiments, transitions between these user interface contexts may be initiated in response to gestures including (but not limited to) swipe gestures received via a touch user interface. As may readily be appreciated, the specific manner in which user interfaces operate through media wallet applications is largely dependent upon the user input capabilities of the underlying user device. In several embodiments, a first user interface context is a dashboard (see, FIGS. 14A, 14C) that may include a gallery view of NFTs owned by the user. In several embodiments, the NFT listings may be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT may be main-staged in said display with its status and relevant information shown. Users may swipe through each collectible and interacting with the user interface may launch a collectible user interface enabling greater interaction with a particular collectible in a manner that may be determined based upon the smart contract underlying the NFT.

A participant of an NFT platform may use a digital wallet to classify wallet content, including NFTs, fungible tokens, content that is not expressed as tokens such as content that has not yet been minted but for which the wallet may initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that may be seen by anybody, the second partition corresponds to content that may be seen by members of a first group, and/or the third partition corresponds to content that may be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility may correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items may be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked when additional content that are also in-game capabilities should be automatically placed in the same partition as they are acquired and associated with the wallet. When “yes” is selected, then this placement may be automated in the future. When “yes, but confirm for each NFT” is selected, then users may be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view may correspond to the classifications described above, which indicates the actions and interactions others may perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users may search the contents of their wallet by using search terms that result in potential matches.

Alternatively, the collection of content may be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein may also be implemented outside the context of an NFT platform network architecture unrelated to the storage of fungible tokens and/or NFTs. Moreover, any of the computer systems described herein with reference to FIGS. 10-14C may be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” may be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

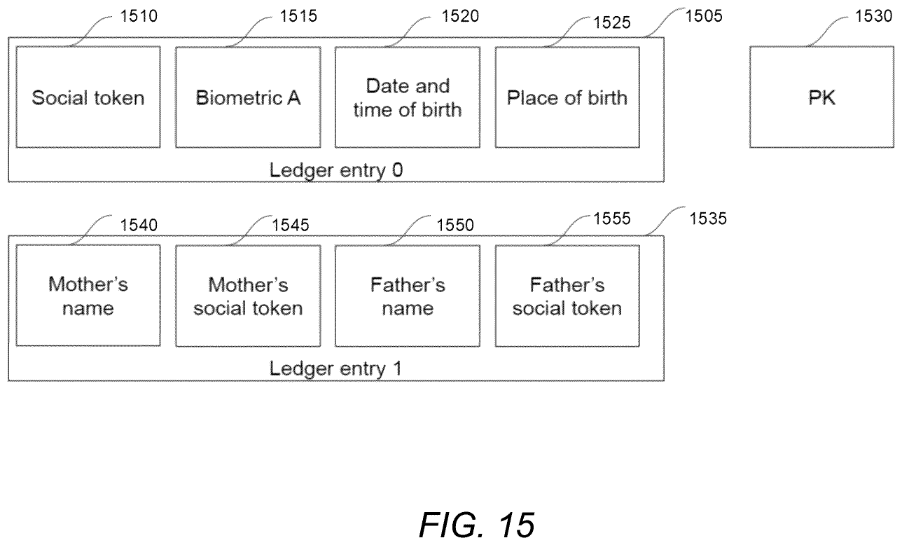

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds when abuse may be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements may be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one may be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 when a horse does not win. Payment may occur under the condition that the first promise NFT is matched with a second promise NFT that causes a transfer of funds to a public key specified with the first promise NFT when horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input may take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that when the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. When the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties may enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to Wi-Fi networks. When computers are replaced with newer models, users may want to maintain all old relationships, for the new computer. For example, users may want to retain Wi-Fi hotspots. For this to be facilitated, a new computer may be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs may be used to selectively transfer rights associated with one NFT to one or more NFTs, where such NFTs may correspond to users, devices, and/or other entities, when such assignments of rights are applicable. Inheritance NFTs may also be used to transfer property. One way to implement the transfer of property may be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, when the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers may generate parts of the content, allowing for large-scale content collaboration.

Features of other NFTs may be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements may also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers may identify how to make their content more desirable to intended target groups.

The generation of evaluations may be supported by methods including, but not limited to machine learning (ML) methods, artificial intelligence (AI) methods, and/or statistical methods. Anomaly detection methods developed to identify fraud may be repurposed to identify outliers. This may be done to flag abuse risks or to improve the evaluation effort.

Multiple competing evaluation units may make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

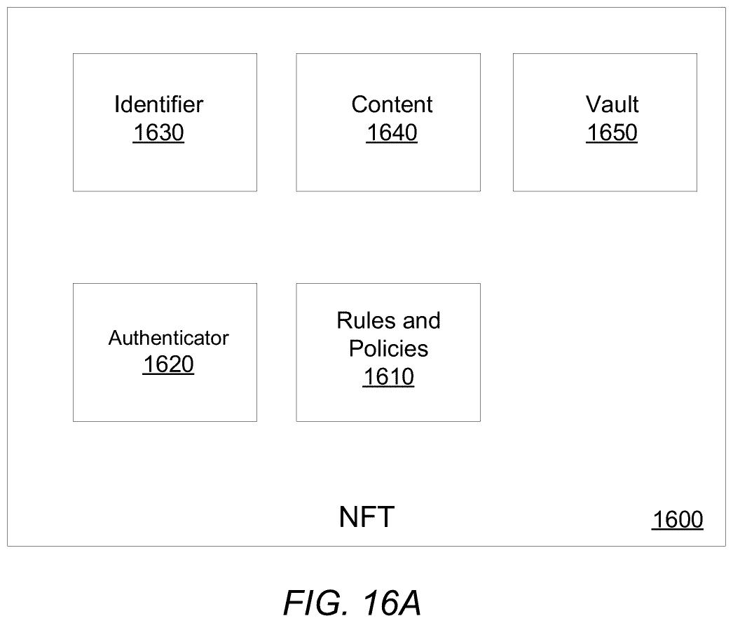

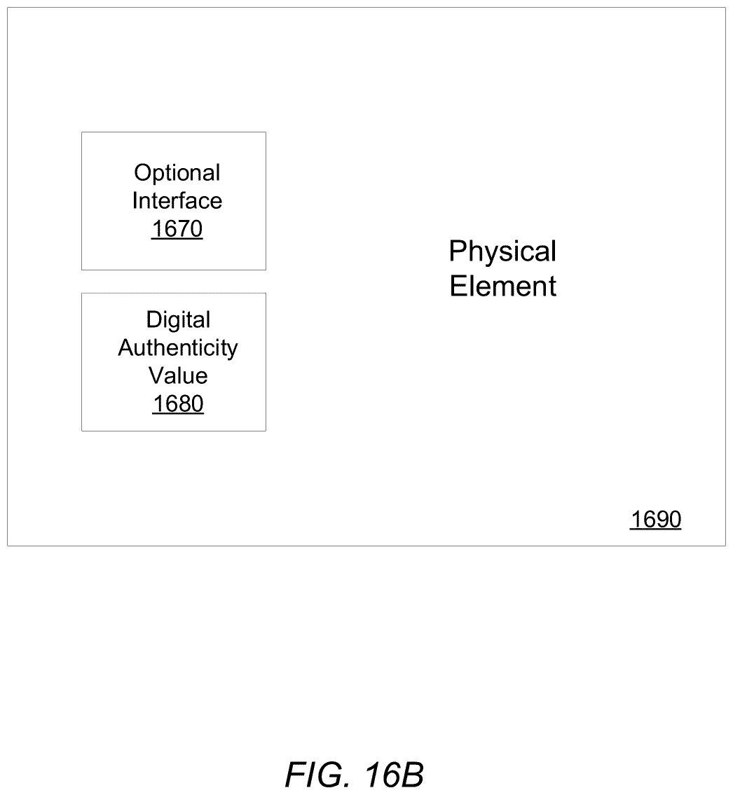

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 may incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content may correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership may be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, may be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments, the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 may be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, when a DAV 1680 is used to express authenticity of two or more physical items, the authenticity database may detect and block a new entry during the registration of the second of the two physical items. For example, when a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item may be associated with a control that prevents forgeries to be registered as legitimate, and therefore, makes them not valid. In the context of a content creator receiving a physical element from an owner, the content creator may deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

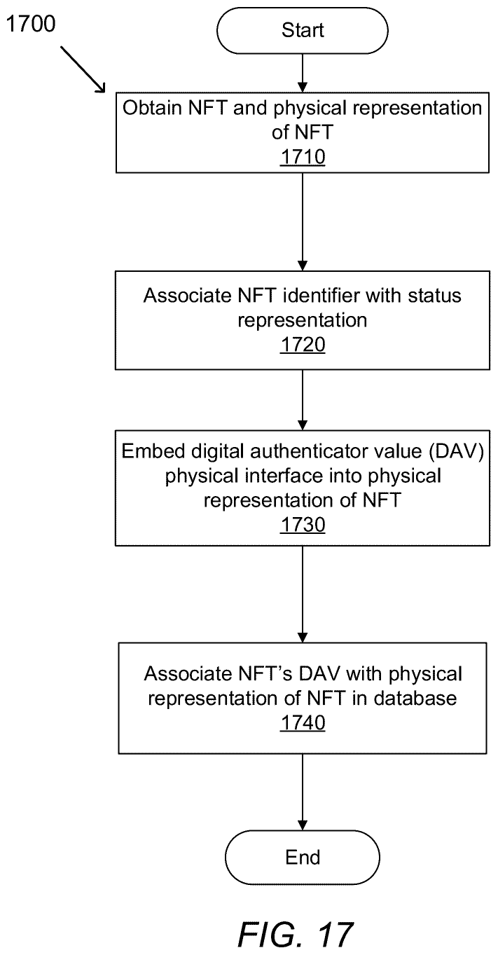

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 may associate (1740) the NFT's DAV with the physical representation of the NFT in a database. In some embodiments, the association may be performed through making note of the transaction and clarifying that it encapsulates both the mouse painting and the mouse NFT.

While specific association processes are described above, any of a variety of processes may be utilized as appropriate to the requirements of specific applications. In certain embodiments, steps may be executed and/or performed in any order or sequence not limited to the order and sequence shown and described. In some embodiments, some of the above steps may be executed or performed substantially simultaneously where appropriate and/or in parallel to reduce latency and processing times. In some embodiments, one or more of the above steps may be omitted.

While specific processes are described above with reference to FIGS. 15-17, NFTs may be implemented in any of a number of different ways to enable as appropriate to the requirements of specific applications in accordance with various embodiments of the invention. Additionally, the specific manner in which NFTs may be utilized within NFT platforms in accordance with various embodiments of the invention is largely dependent upon the requirements of a given application.

### Biometric Authentication Using Privacy-Protecting Tokens

Under a rich media blockchain in accordance with many embodiments of the invention, a wide variety of token configurations may be implemented. Anchored tokens in accordance with many embodiments of the invention may be used to refer to tokens that tie some element, such as a physical entity, to an identifier. In numerous embodiments, tokens may include various types of data, such as (but not limited to), content data, conditional data, and/or association data.

Biometric verification tokens in accordance with a number of embodiments of the invention are anchor tokens that relate a user's biometric properties (e.g., fingerprints, facial features, and/or iris prints) to an identifier that may be embodied in the biometric verification token, and/or an external element such as another token, e.g., an identity token. Another example of an anchor token is a location token, which may, for example, identify a GPS location. A location token may either be tied to a sensor, e.g., a location sensor, and/or it may simply be a descriptive token in which a user has asserted a location.

Biometrics may have an important role in authentication. However, biometric data is traditionally verified by comparing it to templates, which due to their sensitive nature are typically stored in secure storage areas. In a distributed setting, a requirement that information be stored in secure storage may at times be too limiting and problematic to adhere to. For less sensitive content, traditional content protection techniques may still be acceptable to use, such as traditional encryption and traditional access control measures, but for highly sensitive data such as biometric templates, using traditional techniques may pose serious security risks which may present user reluctance to accept these associated risks, thereby presenting a lack of technology adoption.

In many embodiments, biometric verification tokens may generate an output, such as an authentication assertion token, that may be consumed by other entities, including other tokens. Authentication assertion tokens in accordance with certain embodiments of the invention may have an expiration time and/or date (such as 25 seconds after it was first generated). In several embodiments, authentication assertion tokens may be tied to a specified token and/or application that will consume the information. Authentication assertion tokens may include indications of identity, including aliases. In some embodiments, authentication assertion tokens may be at least partially encrypted to protect sensitive data. Authentication assertion tokens may relate to a human user, but may also be an identity assertion of an organization, and/or of a group of users. To represent a group, constructions such as those described in the 2004 publication “Signature Schemes and Anonymous Credentials from Bilinear Maps”, by Camenisch and Lysyanskaya, may be used, the disclosure of which is incorporated by reference herein in its entirety.

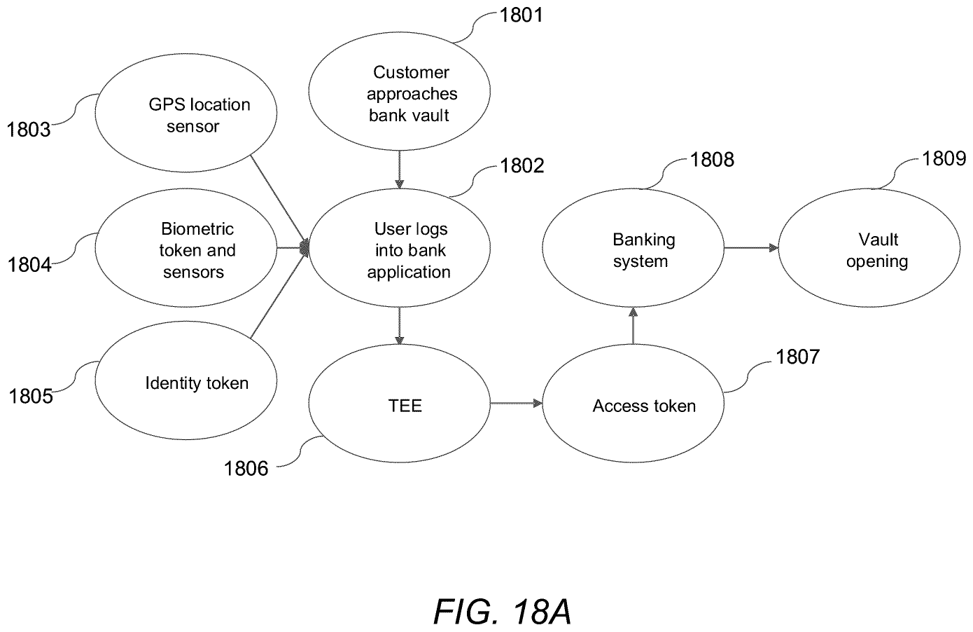

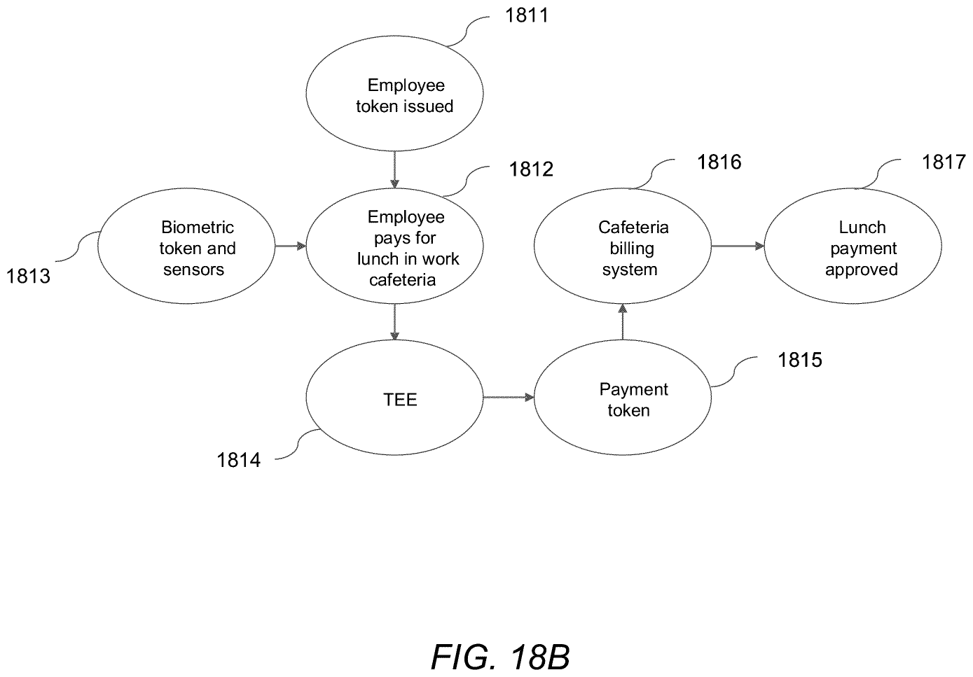

Example implementations of the use of a biometric token in accordance with multiple embodiments of the invention are illustrated in FIGS. 18A-18B. An example usage of an access token for entering a physical safety deposit box bank vault is illustrated in FIG. 18A. A customer approaches a bank vault 1801 and the user logs into their bank application 1802 with the intent of accessing their safety deposit box through the bank's application. The bank application 1802 will have a minimum security level requirement for log-in whether one or more of, a password, pin code, biometric, security questions, and two-factor authentication, for example.

The application might utilize a GPS location sensor 1803 to validate that the location of the device running the application is near the vault and likely in view of the security camera system. The same application might utilize a biometric token and sensors 1804 to validate the person using the application is the proper bank customer along with the bank customer's identity token 1805. The biometric token and sensors 1804 may include but are not limited to a liveness detection capability and liveness token. The biometric and liveness details, location, and identity information might be presented to TEEs 1806 for secure processing of the provided information prior to communicating the results in the form of an access token 1807 (and/or an authentication assertion token as described above) to the banking system 1808 and the vault opening 1809.

As an additional example, Bob's employer utilizes a secure physical vault for precious metals that are used in their manufacturing line. The vault is protected with an access system that includes a keycard reader and a fingerprint scanner. When Bob accesses the vault, he first swipes his company keycard which contains his identity token. The vault system confirms with hardware (e.g., preferably a trusted execution environment), that Bob's identity token matches an entry in its authorized user database and requests Bob scan his fingerprint to ensure that it is actually Bob in possession of the keycard. The fingerprint sensor includes protections for liveness detection such that the person entering has not taken Bob's keycard and finger for illicit entry.

Once the access system has confirmed Bob's identity and presence in the approved user access database, and the access system has confirmed Bob's fingerprint candidate scan versus Bob's fingerprint template from a biometric token, which may be available from the keycard electronic storage and/or within the access system's database, for example, and the system has determined the proper level of liveness during the fingerprint acquisition, the system provides Bob with access to the vault. The biometric token in this example, might also include additional security data, such as password data and pin codes and/or data related to knowledge questions, for use as alternative authentication methods. The token may report on what method was used, and/or the quality of the authentication, etc.

An example of an employee purchasing lunch at a workplace cafeteria using their employee token, a biometric token, and a payment token is illustrated in FIG. 18B. As shown above, the employee's biometric token may be associated with biometric token sensor 1804 devices. The employee token may be issued 1811 by the employer (for example, on the employee's first day of work). Embedded in the employee token might be numerous additional tokens, and/or references to tokens including but not limited to identity tokens and payment tokens. In this example, the employee pays for lunch in a work cafeteria 1812 with the assistance of their mobile device and/or a point-of-sale payment processing system, either of which might confirm the employee token issued 1811 matches the biometric token with the use of biometric token sensor 1804 devices with a secure TEE 1814 that issues a payment token 1815 to the cafeteria billing system 1816 so that the lunch payment is approved 1817.

As another example, Carol works as the CEO's executive assistant at a large manufacturing conglomerate and enjoys a free hot lunch every day at her office because of her status in the company. Many years after she was hired, the company implemented a new identity system that incorporates their employee keycard system and their cafeteria accounting system. During the implementation of the new identity system, Carol was issued a new keycard with an embedded identity token 1811. The identity token includes her name, current position in the company, and her employee number. The keycard also includes her biometric token and sensors 1804. The keycard consists of a computation device and/or trusted execution environment 1814, memory, electrodes configured to measure her fingerprint, and electrodes to gain power and communicate with a point-of-sale system. The keycard might also feature an NFC system whereby the devices are powered via a near-field system.

When Carol goes to the cafeteria each day, she chooses her lunch items and inserts her employee keycard into a point-of-sale terminal with her thumb placed over the fingerprint sensor. The keycard gains its power source from the point of sale terminal and communicates securely with the point of sale terminal and accounting system. The point of sale system, tasked with gaining credentials from the keycard in order to approve the lunch purchase, makes an inquiry to the keycard for a biometrically-secured employee number. The keycard, having been asked to provide both the employee number stored on the card and verification that the thumb presently on the electrodes matches the biometric template stored in the keycard's memory, uses its TEE 1814 to match the fingerprint and access the employee number for transmission to the point of sale terminal. The point of sale system communicates the lunch order information and employee number to the cafeteria billing system 1816 whereupon the cafeteria billing system 1816 responds to the point of sale terminal with a transaction approval lunch payment approved 1817. Cafeteria billing system 1816 is pre-programmed to charge Carol's meal purchases to the company rather than to her payroll deduction account, which is what most employees would be accustomed to. One skilled in the art will recognize that various portions, when not the entire computation and biometric sensor system may be implemented within the employee's keycard, personal mobile device, and/or even within the point of sale terminal.

Promotional tokens may be used to provide a promotional event. Traditional online giveaways suffer from several problems such as bots impersonation, no verification that the promoter actually provided a winner with the goods, and no verification that the winner was randomly selected. In a number of embodiments, a promotional giveaway operates as a decentralized application and is protected from bots with entrants restricted to those using an identity token that is intended to associate with a real individual and not a bot. Promotional contracts in accordance with a number of embodiments of the invention may be used with a smart contract to provide a verifiable release of the goods, such as 1.0 bitcoin, and/or a gift card token that is useful to purchase the specified goods, and/or goods of the winners' choosing. In some embodiments, a smart contract may be constructed in a manner that randomly selects the winner based on best practice random number generation. All of these aspects may also be auditable by bounty hunters, as described in U.S. patent application Ser. No. 17/806,728, entitled “Systems and Methods for Encrypting and Controlling Access to Encrypted Data Based Upon Immutable Ledgers”, filed Jun. 13, 2022, the disclosure of which is incorporated by reference herein in its entirety.

Identity (and/or social) tokens in accordance with numerous embodiments of the invention are a type of anchored token that may be used to tie users' real-world identities and/or identifiers to a system identifier. Identifiers in accordance with certain embodiments of the invention may include a public key, which may allow content encrypted and/or signed with a corresponding key, to be traced back to the identifier. In accordance with many embodiments of the invention, an individual's personally identifiable characteristics may be contained, maintained, and managed throughout their lifetime so as to connect new information and/or NFTs to the individual's identity. Identity tokens may include various personally identifiable information, such as, but not limited to, name, place, date of birth, and/or biometrics (e.g., fingerprints, iris scans, DNA prints, etc.).

In a number of embodiments, identity tokens may be contained, maintained, and managed throughout their lifetime so as to connect new tokens to their identity. For example, an identity token with an infant's biometric information could be used in the assignment process of a social security number NFT from the federal government. In some embodiments, the identity token may be associated with rights and capabilities, which may be expressed in other NFTs and/or expressed within a policy of the identity token itself. Identity tokens in accordance with certain embodiments of the invention may be used to derive privacy tokens (e.g., alias tokens, pseudonymous tokens, etc.), which may be used to associate a token and/or result with a user, without exposing their identity and/or other potentially sensitive information. Examples of connecting identity tokens with one or more other tokens are described throughout this description.

Identity tokens and/or other associated tokens in accordance with a number of embodiments of the invention may exist on a personalized branch of a centralized and/or decentralized blockchain ledger. In numerous embodiments, future tokens may be generated to create a life-long ledger record of an individual's public and/or private activities, such as (but not limited to) identification, purchases, personal records (e.g., health and medical records, etc.), access tokens, family records (e.g., future offspring, marriages, familial history, etc.), photographs, audio, videos, tax filings, and/or patent filings. In a variety of embodiments, the management and/or maintenance of an individual's biometrics throughout the individual's life may be immutably connected to the individual's first identity token (e.g., stored on a decentralized blockchain ledger). Identity tokens in accordance with some embodiments of the invention may be thought of as a provenance tool for an individual's entire life.

In various embodiments, various tokens may simultaneously be relative tokens. For example, a pseudonymous token, which we also refer to as an alias token, is a type of relative token as it is derived from another token in which there is an identity, and therefore relates to this token. Relative tokens in accordance with a number of embodiments of the invention may relate two or more tokens to each other. In numerous embodiments, relationships between tokens may be verified using digital signatures and/or public and private keys. For example, consider a relative token that includes a digital signature that is verified using a public key of an identity token, and where the digital signature is on a message including a location token; this relative token may be an assertion by a person corresponding to the identity token that they are in a location that corresponds to the location token. Conversely, a signature verified using a public key embedded in a location token is a proof, assuming the trustworthiness of the location token, that an entity sensed by the location token is present. Such a sensing mechanism may use the approach described in Chaum and Brands' “Distance Bounding Protocols,” published in 2001, the disclosure of which is incorporated by reference herein in its entirety.

The signature using the public key of the location token may sign a message including an assertion that a given physical entity, such as a phone represented by a second token including a public key unique to the phone token, is physically present. This digital signature on this message is part of a token that expresses the proximity between the phone and the location; this token is a relative token as it relates one token (the phone token) to another token (the location token). When the location token was generated using a GPS sensor, in a trusted environment such as a TEE and/or a DRM that is certified, then the relative token describing the proximity is a proof of co-location of the phone and a GPS coordinate, i.e., a proof of location of the phone. Analogously, a proof of proximity between two mobile entities is a proof of co-location, but is not necessarily identifying where either entity is located, only that they are co-located. Relative tokens in accordance with many embodiments of the invention may be derived from other tokens, namely those they relate to, and are therefore also derived tokens. An anchored token may tie to another token, which makes it both anchored and relative.

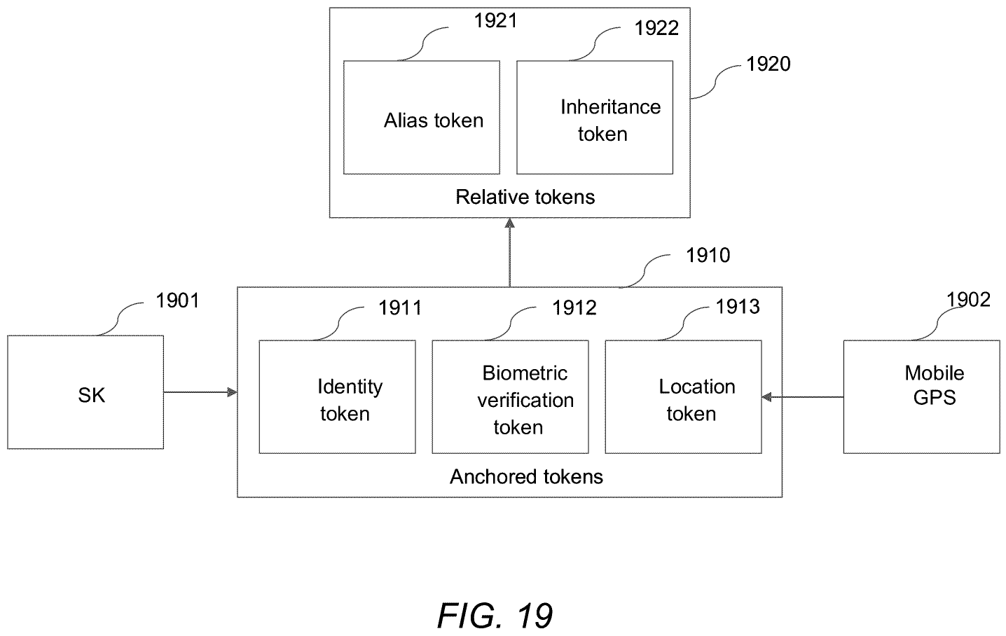

An example of a relationship between anchored tokens and relative tokens is illustrated in FIG. 19. In this example, anchored tokens 1910 are used to derive relative tokens 1920. Identity token 1911, which may be the same as identity token 2101, is associated with private key SK 1901 and biometric verification token 1912. Biometric verification token 1912, which is also an anchored token, ties an identifier such as identity token 1911 with its associated private key SK 1901 to a physical being through a biometric record.

Another example anchored token 1910 is a location token 1913 supported, for example, by a system of one or more sensors, such as a mobile device with GPS 1902 receiver, capable of determining a physical location. Relative tokens 1920 may include alias token 1921. Inheritance tokens 1922 are examples of another relative token 1920. In this example, alias token 1921 is able to access location data from location token 1913 from the anchored tokens 1910.

As an example application, alias token 1921 may be used by a social media application to express the location of a particular alias that is derived from a legitimate identity, without actually having to communicate and/or reveal the identity of the individual. In one example, user Alice is represented by identity token 1911 that specifies a unique system identifier only used for Alice; this may, for example, be a public key whose corresponding private key is used to sign identity assertions proving that Alice agrees to some fact and/or request. Such an identity assertion may be in the form of a contract token, for example.

Biometric verification token 1912 includes biometric templates for Alice, and before an identity assertion is generated, the system verifies that biometric verification token 1912 indicates that Alice's biometric template is being matched. In addition, a liveness token (not shown in this FIG.) may be used to determine that the biometric verification token is not likely to be generated from a recording of Alice, for example. The liveness token, in some instances, is generated by the same biometric sensor collection that generates the signal corresponding to the biometric verification token.

The location token 1913 asserts an approximate location of Alice. Together, the depicted anchored tokens 1910 therefore may correspond to an assertion that Alice is physically present in a specified location, as determined by the verification of her biometrics and the corresponding liveness verification, combined with the location information of the GPS sensor that is part of the mobile device with GPS 1902. The location may correspond to a position right outside Alice's home's entrance door, which may then be automatically unlocked when the door handle is touched. However, when Alice's biometrics and liveness are verified, but her location either fails to be determined and/or is determined to be substantially different from right outside her entrance door, then the door is not unlocked.

In another example application, the same technique is used to unlock the door of an enterprise building where Alice works. For purposes of compliance, the enterprise may require a log of who accesses what facilities. However, in some instances, it is not appropriate to log the identity token 1911 as this may be a privacy intrusion, whether to Alice, her employer, and/or both. Therefore, instead of logging identity token 1911, a corresponding alias token 1921 may be generated and logged. In an extension to this example, the bank makes an acquisition of a small banking enterprise in Alice's hometown with a safety deposit box vault that is much closer to her home than the original bank location. Rather than ask Alice to re-enroll in their biometric identity system at the acquired bank, an inheritance token 1922 is generated by the bank to enable biometric-secured access to the new vault location. The inheritance token consists of Alice's identity token 1911 and biometric verification token 1912 for use in the acquired bank's vault security system.

While specific implementations of token relationships have been described above with respect to FIG. 19, one skilled in the art will recognize that numerous configurations of interrelated tokens may be implemented as appropriate to the requirements of a given application.

Inheritance tokens in accordance with certain embodiments of the invention are a form of relative token that transfers rights associated with a first token to a second token. For example, a computer, represented by an anchored token that is related to a physical entity, namely the hardware of the computer, may have access rights to a Wi-Fi network. When a user replaces the computer with a newer model, it is desirable for the user to maintain all old relationships, e.g., to Wi-Fi hotspots, for the new computer. The new computer will be represented by another anchored token that the one related to the old computer. In some embodiments, inheritance tokens acquire some and/or all pre-existing rights associated with another token (the old computer), and associates those with a new token (e.g., associated with the new computer). A new user of the old computer may be granted none of the rights of the old computer, and/or some of them. Thus, the old computer may retain only some of the previous rights. More generally, multiple inheritance tokens may be used to selectively transfer rights associated with one token to one or more tokens, where such tokens may correspond to users, devices, and/or other entities, as described by any of the tokens disclosed herein, when such assignments of rights are applicable.

In several embodiments, inheritance tokens may also be used to transfer property. One way to implement the transfer of property is to create a digital signature using a private key associated with a token currently having the rights, on a message that describes the assignment of what rights, under what conditions, etc.; and to what token(s), where the assigned tokens may be represented by identifies unique to these, such as public keys. The inheritance token includes the digital signature and the message and may be verified using the public key corresponding to the private key used to sign the message, where this public key is part of the token from which rights are assigned.

In numerous embodiments, as rights are assigned, they are transferred away from the previous owner (e.g., the token) to a new owner (the token with which they will be associated using the inheritance token). Access to financial resources is one such example. However, sometimes rights may be assigned to a new party without taking the same rights away from the party (i.e., token) from which the rights come. One example of this may be the right to listen to a song, when a license to the song is sold by the artist to a consumer. However, when the seller sells exclusive rights, this causes the seller not to have the rights anymore. Ownership of an investment NFT corresponds to another such situation.

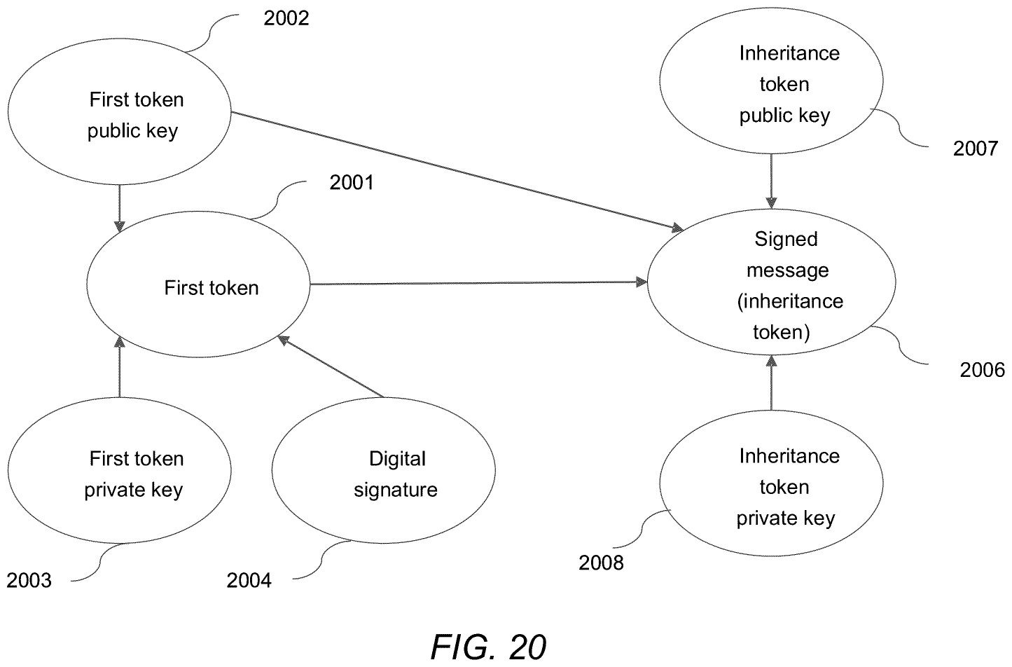

An example of the movement of rights from an anchored token to a relative token is illustrated in FIG. 20. In this example, the anchored token is first token 2001, which may correspond to the identity token 1911 and/or biometric verification token 1912 in the previous example of Alice's bank. The relative token is a signed message 2006, which we also refer to as an inheritance token and which may correspond to the inheritance token 1922 in the previous example. First token 2001, which may correspond to the identity token 1911, has a corresponding first token public key 2002 and a first token private key 2003. Inheritance token signed message 2006 has a corresponding first token public key 2007 and a first token private key 2008. Signed message 2006 contains the secure passing and/or transfer of rights information from the first token 2001. The inheritance token acquires some and/or all pre-existing rights associated with the first token 2001. For example, the inheritance token 1922 in the FIG. 19 example may include Alice's identity token 1911 but exclude her biometric verification token 1912 because the acquired bank utilizes a palm-print biometric system rather than a facial identification. The acquired banking system would be authorized to access Alice's identity token in full, but the acquiring bank would not have rights to access Alice's biometric details as stored in the biometric verification token 1912. The transfer of property may occur using a digital signature 2004 using a first token private key 2003 associated with the first token 2001 currently having the rights, on a signed message 2006 that described the assignment of what rights, under what conditions, etc.; and to what token(s), where the assigned tokens may be represented by identities unique to these tokens (e.g., public keys).

While specific implementations of moving rights between tokens have been described above with respect to FIG. 20, one skilled in the art will recognize that numerous configurations of rights transfers may be implemented as appropriate to the requirements of a given application.

NFT security platforms in accordance with many embodiments of the invention may include biometric authentication with remote authentication using cryptographic keys, where cryptographic keys may be derived from data stored in biometric tokens. In several embodiments, cryptographic keys may be derived from data provided by biometric inputs. NFT security platforms in accordance with many embodiments of the invention may use of cryptographic keys to minimize various security risks, including in particular, risks associated with brute-force attacks where attackers may have access to tokens, among other types of attacks.

NFT security platforms in accordance with many embodiments of the invention may utilize throttling which may be useful in situations that use low-entropy biometrics. Many embodiments provide biometric authentication that is robust against potential fuzziness associated with measured biometric data, including modifications, losses and/or distortions to biometric data. In many embodiments, an array (e.g., array B) of biometric measurements may be generated that may be derived from a biometric input, where elements of the array may be derived using techniques that may minimize fuzziness.

NFT security platforms in accordance with many embodiments of the invention may use masks for selection, including to address fuzziness for dimensions where there may be a weak signal, as certain techniques may not address fuzziness for dimensions where there may be a weak signal. Many embodiments of the NFT platforms may generate secure masks (e.g., encrypt masks among other security measures) to avoid exposure of a mask using encrypted masking processes. In particular, efficient processing of encrypted content may be difficult. Accordingly, the use of encrypted masks may provide protection of data that would otherwise, when exposed, help attackers perform illegal activities (e.g., brute-force attacks), which may be a risk associated with distributed settings. Accordingly, NFT security platforms in accordance with many embodiments of the invention may use biometric authentication in distributed settings providing many benefits for token-based applications and corresponding distributed settings.

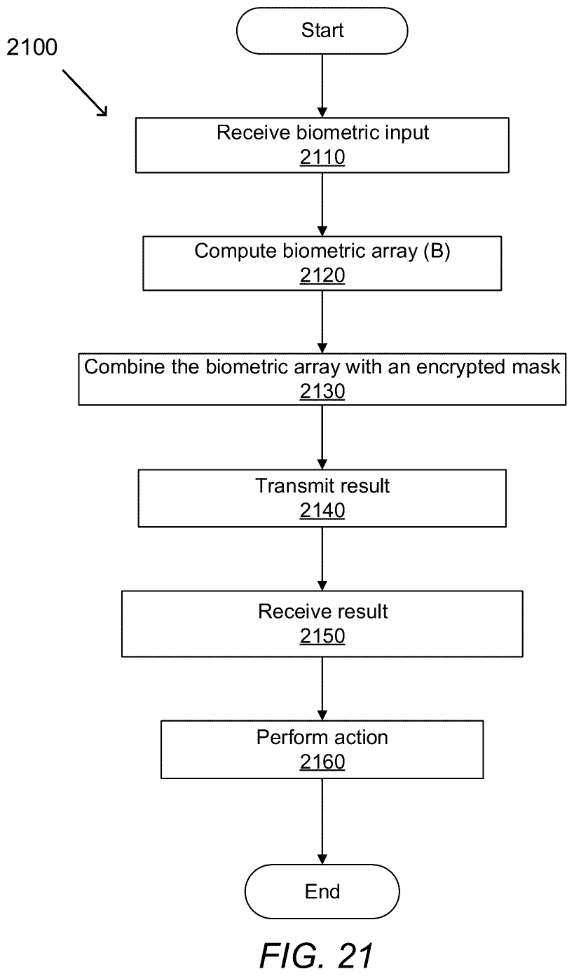

A process for encrypting biometric data in accordance with some embodiments of the invention is illustrated in FIG. 21. The process 2100 receives (2110) biometric data (e.g., from one or more sensors). The process 2100 computes (2120) a biometric array (B) of values, where each value may be a function of the biometric input. Some of the values may be robust, e.g., unlikely to depend on environmental conditions, whereas others may not be robust, e.g., have no signal and/or depend to a large extent on environmental conditions. A mask may be used to select robust values. Instead of disclosing a mask, an encrypted mask may be used. Process 2100 combines (2130) the biometric array with an encrypted mask (C), which may be done without the need and/or capability to decrypt C. The result may be an encrypted function of the biometric input, which may depend on thresholds associated with a biometric token that may be used to store the encrypted mask C. Process 2100 transmits (2140) the encrypted result to a party, including but not limited to a distributed party, a trusted party, and/or a distributed trusted party that processes the encrypted result and returns a response. Process 2100 receives (2150) a response. Based on the received response, the process 2100 performs (2160) an action. Example actions may include but are not limited to: generate a key from the received response, perform a login based on the generated key and/or the received response, decrypt a ciphertext stored in and/or with the biometric token, among others. In many embodiments, an action may not be available when a wrong biometric input is received (2150). Although FIG. 21 illustrates specific processes for processing biometric data, any of a variety of processes may be utilized for processing biometric data as appropriate to the requirements of specific applications in accordance with embodiments of the invention.

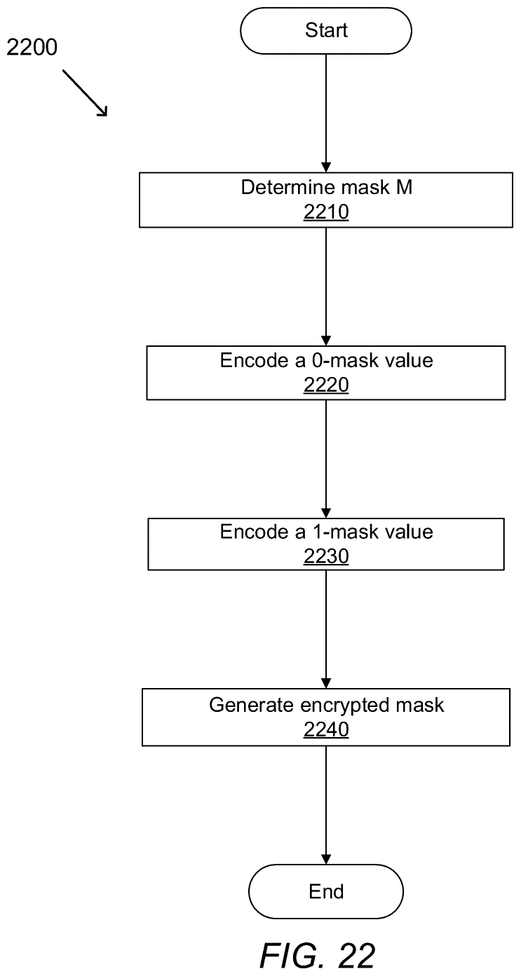

Processes for generation of encrypted mask arrays in accordance with numerous embodiments of the invention is illustrated in FIG. 22. In particular, FIG. 22 illustrates a process 2200 for the generation of an encrypted mask array C. Based on at least one biometric input, the process 2200 determines (2210) a mask M. The mask may be determined to select robust entries of the array B by selecting a 1-mask value, and to suppress the non-robust entries of the array B by selecting a 0-mask value. The process 2200 encodes (2220) a 0-mask value as a ciphertext of the value 1. The process 2200 encodes (2230), a 1-mask value as a ciphertext of a generator, such as hi, which may be a generator of a Zq* used for the entry number i of the encrypted mask array C. hi may be publicly known. The process 2200 generates (2240) an encrypted mask C by using (preferably distinct) representations of the encoded 0-mask and 1-mask values, corresponding to different such ciphertexts. In many embodiments, ElGamal encryption may be used, which may be performed using traditional integer groups and/or elliptic curves. Although FIG. 22 illustrates specific processes for generating encrypted masks, any of a variety of processes may be utilized for generating encrypted masks as appropriate to the requirements of specific applications in accordance with embodiments of the invention.

NFT security platforms in accordance with many embodiments of the invention may generate cryptographic key material in distributed settings based on biometric verification of encoded biometric templates, where an encoding may include encryption. Many embodiments may provide security features including access control based on biometric verification in token-based distributed settings.

NFT security platforms in accordance with many embodiments of the invention may store verification data in publicly available and/or private “biometric” tokens, where the verification data stored in a biometric token may facilitate verification of biometric inputs and which may not expose private and/or sensitive biometric data to unauthorized users (e.g., a bad actor) in possession of the biometric token. In many embodiments, verification data used to verify biometric inputs may include biometric templates and/or masks that provide indications on how to process biometric inputs.

NFT security platforms in accordance with many embodiments of the invention may protect biometric data in distributed settings which may be important to help prevent disclosure and/or leaks of personally identifiable information (PII), (e.g., data that may facilitate the impersonation of a user). Accordingly, NFT security platforms in accordance with many embodiments of the invention may provide security and protection of biometric data against leakage, impersonation and other abuses, which is important for user privacy.

NFT security platforms in accordance with many embodiments of the invention may include robust processes that may compute a validator value based on a biometric token and/or a biometric input (e.g., a fingerprint, an iris scan, a face scan, among various other types of biometric input data) where the validator value may secure the biometric data to avoid exposure to a bad actor that comes in possession of the validator. In several embodiments of the NFT security platforms, it may not be feasible for a bad actor to determine, based on a biometric token, a prospective biometric input, and a validator value computed from these, whether there is a match between the biometric token and the biometric input. Being unable to determine whether or not there is a match between biometric tokens and biometric inputs may be beneficial to prevent security attacks (e.g., brute-force attacks, among others) on tokens.

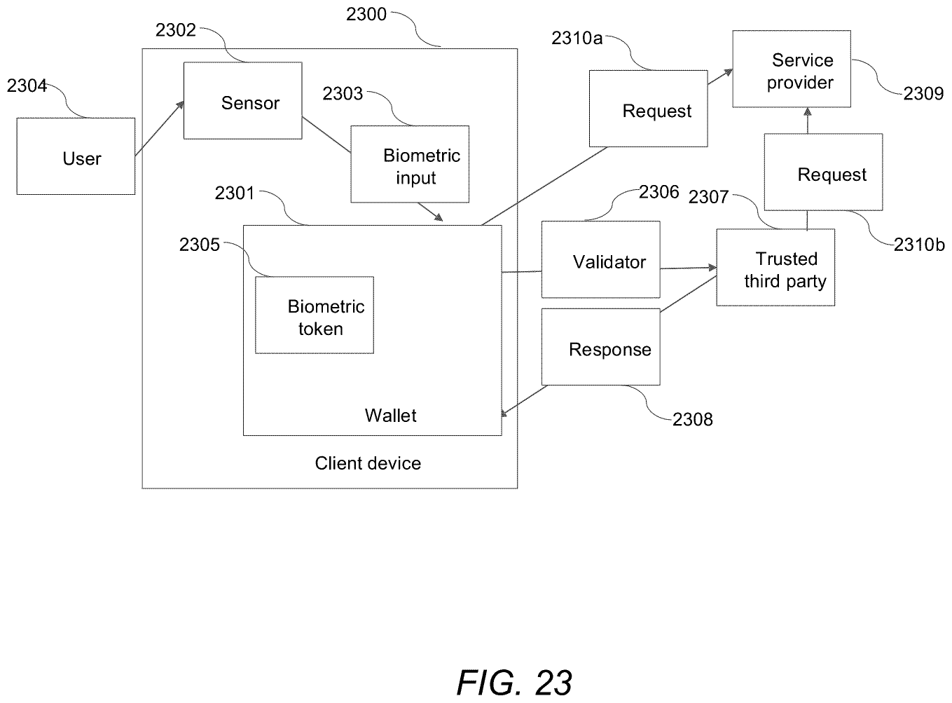

An architecture of a client device in accordance with particular embodiments of the invention is illustrated in FIG. 23. In particular, FIG. 23 illustrates an architecture involving a client device 2300, a trusted third party 2307 and an optional service provider 2309. A user 2304 may interact with sensor 2302 to generate a biometric input 2303 that is provided to wallet 2301, which may be run in a DRM and/or TEE (not shown). The wallet 2301 of client device 2300 may generate a validator 2306 message based on biometric input 2303 and data associated with biometric token 2305. Validator may be transmitted to trusted third party 2307, which may be a distributed entity. Third party 2307 may process validator 2306, e.g., decrypts at least a portion of it, and may transmit a response 2308 to wallet 2301 of client device 2300, said response 2308 may include the decrypted portion of validator 2306. Wallet 2301 may perform an action, which may include generating a key (not shown) and/or sending a request 2310a to service provider 2309. In certain embodiments, trusted third party 2307 may transmit a request 2310b to service provider 2309. In certain embodiments, this may be in addition to sending response 2308 to wallet 2301. In several embodiments, this may be instead of doing so. Service provider 2309 may include but is not limited to: a social media website, an online banking site, a cloud wallet manager, and/or a subscription-based service such as an online newspaper among other service providers. Trusted third party 2307 may not need to know the mask used, nor need it have access to any PII of the user. It may store a portion of a secret key used for quorum-based decryption. As such, it may not decrypt anything on its own. The functionality of trusted third party 2307 may be to perform decryption. This may also be performed by a trusted device in the possession of the user, e.g., a phone, a secure server, and/or a wearable computing device. Thus, a trusted third party may not need to be distributed, although it is still possible for it to be. In many embodiments, standard threshold sharing may be used for the distribution, among various other techniques that may be used as appropriate to the requirements of specific applications. A wallet may be hosted on a secure hardware device and include a decryption oracle that may perform the tasks of a trusted third party 2307. Thus, when the secure hardware device becomes corrupted with malware, an oracle may be reached using a secure API, and cannot be infected by the malware. Although FIG. 23 illustrates a particular hardware architecture of a client device, any architectures may be utilized as appropriate to the requirements of specific applications in accordance with embodiments of the invention.

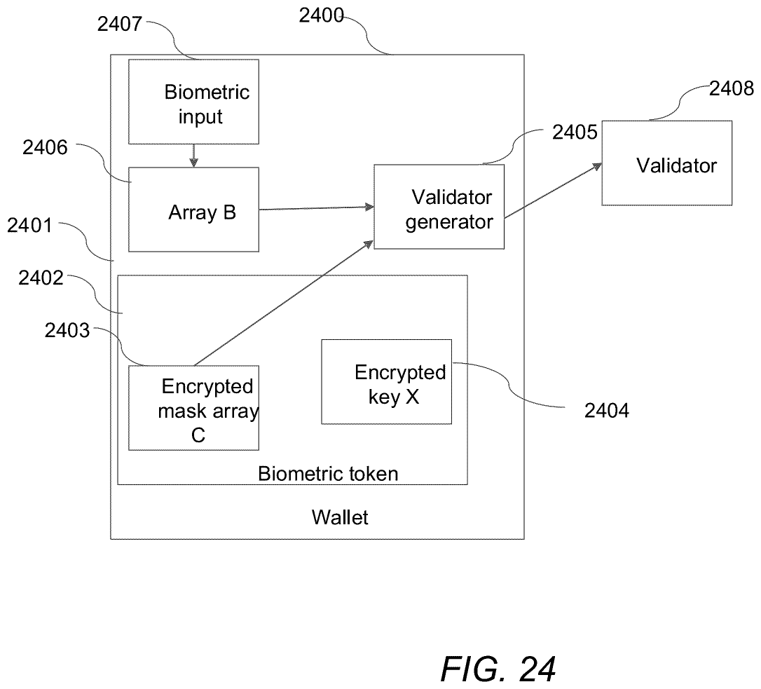

A process of generating an array using biometric input in accordance with various embodiments of the invention is illustrated in FIG. 24. In particular, FIG. 24 illustrates a detail of the operation wherein a biometric input 2407 may be used to derive array B 2401 using one or more extractions. A validator generator 2405 may combine Array B 2406 with encrypted mask array C 2403, stored in biometric token 2402, to generate validator 2408. In many embodiments, the combination may be performed by an item-wise modification of the elements of encrypted mask array C 2403 using the items of Array B 2406, resulting in an encryption of a masked version of array B from which validator 2408 may be derived. As response may be received, it may be used to decrypt encrypted key X 2404, resulting in a key X. Key X may be used to generate requests, and/or may be used to decrypt other elements contained in and/or associated with biometric token. Although FIG. 24 illustrates a process of generating an array using biometric input, any of a variety of processes may be utilized as appropriate to the requirements of specific applications in accordance with embodiments of the invention.

NFT security platforms in accordance with many embodiments of the invention may provide secure pipelines to process validator values, using at least one verifier, to determine whether a biometric input from which a validator value is computed corresponds to an identity of a user associated with a biometric token. In many embodiments, a verifier may be a set of distributed entities, e.g., include several collaborating entities. A verifier may perform processing and make a determination based on a consensus mechanism. A verifier may perform processing, from which a prospective unlock value may be generated, but the verifier may be unable to determine whether this prospective unlock value is a valid unlock value. When there is a match between a biometric token and a biometric input, then a prospective unlock value may be useful to perform an unlock action by the holder of the biometric token, but when there is not a match, then the unlock action may fail. Because a verifier may not be able to determine whether an unlock action will succeed or fail, a verifier may not be corrupted and used to successfully perform brute-force attacks on tokens that are not in the possession of the attacker.

NFT security platforms in accordance with many embodiments of the invention may use a validator value to determine an identity of a user in the context of a given computation, which may be distributed and lacking access to a locally-stored biometric template, where performance of the computation may require an access right and/or an unlock value be satisfied, and where the access right and/or unlock value may be provided by a verifier in response to a successful verification.

NFT security platforms in accordance with many embodiments of the invention may receive and process biometric data that may generate an array of N different aspects of a biometric data input. Different aspects of the array of N aspects may include voice-based biometrics that may include quantifiers that may correspond to an amount of signal in an input in a particular frequency range (e.g., between 25 Hz and 50 Hz) whether for a known spoken word and/or based on a provided voice input signal, among various other biometric properties for the particular types of biometric inputs.

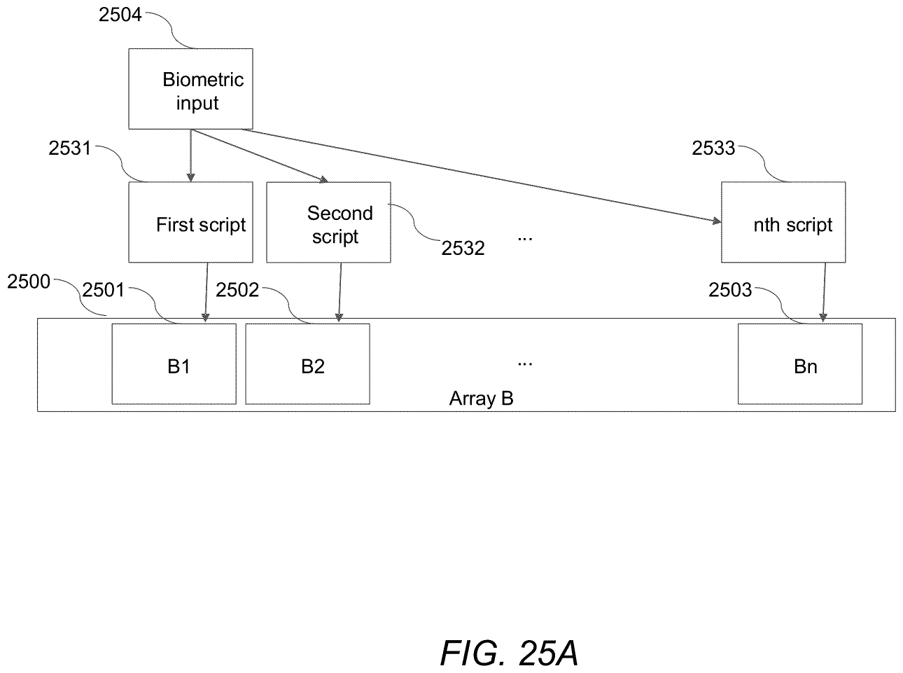

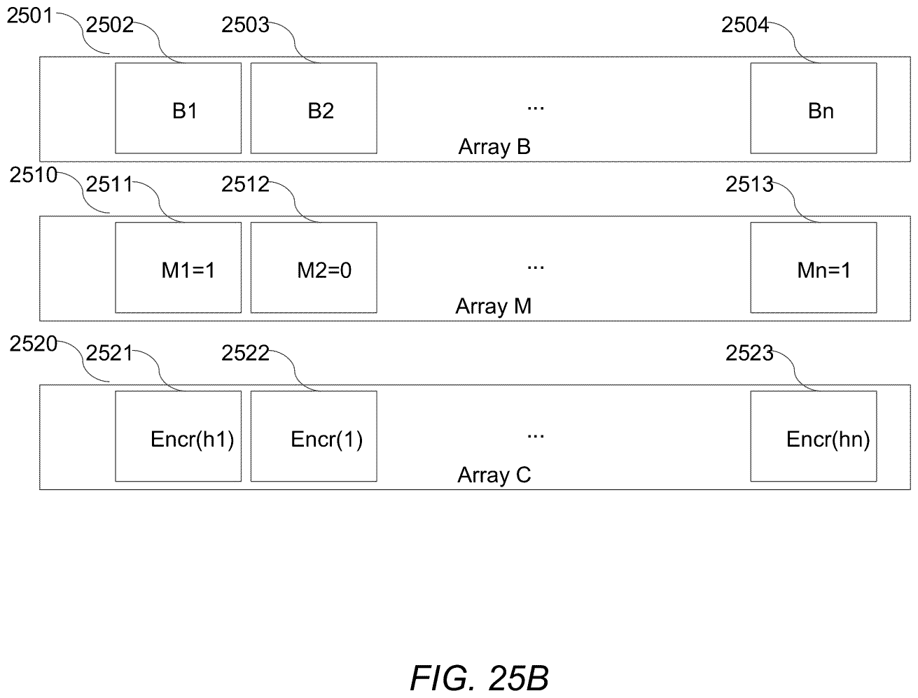

The generation of an array from a biometric input in accordance with certain embodiments of the invention is illustrated in FIG. 25A. In particular, FIG. 25A illustrates a generation of Array B 2501 from biometric input 2504, as performed on client device and/or associated computational entities. Biometric input 2504 may be provided to first script 2531, second script 2532, up to nth script 2533. Here, n may be values such as 50 or 200, for example. First script 2531 may perform a first determination related to biometric input 2504, e.g., determines whether one aspect is present or not. First script may output a value B1 2501 that represents the result of the computation performed by first script 2531. For example, it may compare the computed result to one or more thresholds and determine, based on these comparisons, a cluster to which biometric input 303 belongs to. This may represented by B1 2501, which may be a first element of Array B 2500. Similarly, second script 2532 may perform a different computation from first script 2531 and outputs a second classification B2 2502 of biometric input 2504, e.g., based on the comparison with one or more thresholds. An nth script, likewise, computes an output Bn based on biometric input 2504. Some of the elements of array B 2500, for example B1 2501 may be robust such that they are at a low risk of being corrupted in the presence of a typical amount of sensory noise and/or environmental background disturbance. This makes B1 2501 valuable to use for purposes of authentication. In certain embodiments, other elements of array B, such as for example B2 2502 may not be robust, (e.g., at a high risk of being corrupted in the presence of a typical amount of sensory noise and/or environmental background disturbance). In certain embodiments, B2 2502 may be a measurement of a feature that the user does not express. This may make B2 2502 not valuable to use for purposes of authentication. Although FIG. 25A illustrates a process for generation of an array from a biometric input, any of a variety of processes may be utilized to generate an array from a biometric input as appropriate to the requirements of specific applications in accordance with embodiments of the invention.

The masking of an array in accordance with multiple embodiments of the invention is illustrated in FIG. 25B. In particular, FIG. 25B illustrates the masking of an array B 2501, B1 2502 may valuable for authentication, as is Bn 2504, but B2 2503 may not be valuable for authentication. This may be reflected by the mask expressed by Array M 2510, where element M1 2511 may be set to 1 to indicate an inclusion of B1 2502, element M2 2512 may be set to 0 to indicate an exclusion of B2 2503, and element Mn 2513 may be set to 1 to indicate an inclusion of Bn 2504. The array M 2510 may be represented by the Array C 2520. Element 2521 may be an encryption of the generator h1, e.g., of h1\hat{ }M1. Element 2522 may be an encryption of 1, e.g., of h2\hat{ }M2. Element 2523 may be an encryption of the generator hn, e.g., of hn\hat{ }Mn. The array C 2520 may correspond to an encrypted mask array C. Although FIG. 25B illustrates a process for masking an array, any of a variety of processes may be utilized to mask an array as appropriate to the requirements of specific applications in accordance with embodiments of the invention.

Different aspects may include different properties for different types of biometric inputs. For example, an aspect in an array of N aspects may include a quantifier corresponding to an amount of signal in a different frequency range (e.g., between 50 Hz and 100 Hz). For example, an aspect in an array of N aspects of a fingerprint-based biometric technique may be the presence of a particular type of fingerprint feature, (e.g., a whirl), and when present, a quantification of its radius (e.g., in millimeters). An aspect may be the presence of another type of fingerprint feature (e.g., a crossover). An aspect may be a closest distance between a center of a detected whirl and a detected crossover, when applicable.

NFT security platforms in accordance with many embodiments of the invention may include biometric processes that may generate an array of N aspects for users, where different aspects in the array of N aspects may be computed using different techniques as appropriate for the particular type of biometric input data, including for example, using a rule-based system, a system based on quantification of amounts and/or distances, a machine learning system, artificial intelligence system that may generate a collection of functions based on a biometric input, among other processes as appropriate to the requirements of specific applications in accordance with embodiments of the invention. Aspects may be specific to a type of biometric input being processed, e.g., describing different features present in a voice-based sample and/or a fingerprint-based sample, among other types of inputs (e.g., facial, iris scan, among others). Different types of biometrics, e.g., iris-based and/or face-image-based among others, may be used as appropriate to the requirements of specific applications in accordance with various embodiments of the invention.

NFT security platforms in accordance with many embodiments of the invention may generate arrays for biometric inputs for different users, where some users may not have entries in certain positions of an array, as some of the entries may correspond to features and/or combinations of features that a given user fingerprint does not have. Similarly, some users may have some features that are weak and/or located in the perimeter of the fingerprint, and therefore occasionally registering as present and other times not registering as present. The generated aspects may be represented as identifiers associated with one or more classes associated with a given aspect. For example, an aspect that corresponds to a distance may be represented as an identifier corresponding to a range from a collection of relevant ranges, such as (range1, range2, range3, range4, range5)=(less than 1 mm, between 1 mm and 1.8 mm, between 1.8 mm and 2.4 mm, between 2.4 mm and 3.8 mm, more than 3.8 mm). Thus, when the detected distance is 1.4 mm, the range2 would be selected, as this indicates a distance between 1 mm and 1.8 mm. A collection of relevant ranges may be universal, whereby they may apply to a given aspect of the users. In certain embodiments, a collection may be specific to a given user.

NFT security platforms in accordance with many embodiments of the invention may generate and use masks that may be used to identify entries in arrays that are relevant for particular users. Many embodiments may involve obtaining a biometric input for a user, applying a mask to determine the relevant entries, and for the relevant entries, performing a quantification of the input in which for each mask-selected value may select a category.

NFT security platforms in accordance with many embodiments of the invention may use a masked and quantized array to determine access and/or to generate a key. For example, one way to generate a key is to let each non-selected entry, using the mask, be set to 0 using a set number of binary bits, such as 10, and to represent each mask-selected entry as a 10-bit non-zero value representing the selected range. The resulting bit value may be hashed using a cryptographic hash function (e.g., SHA256, among others), and used as a cryptographic key. In many embodiments, a cryptographic key may be used as a symmetric key that may be stored on a third party server (e.g., a service provider server). In several embodiments of the NFT security platforms, a cryptographic key may be used as a symmetric key to decrypt a private key stored in a biometric token. A private key may correspond to a traditional public key, e.g., of the user. A private key may correspond to a public key that is not made public in order to prevent brute-force attacks on a platform. To keep a key private, many embodiments of the NFT platforms may distribute a public key and store pieces of it with different servers.

NFT security platforms in accordance with many embodiments of the invention may process a biometric input by mapping it to a set of selections, corresponding to ranges, and store the resulting arrays of values. For example, an i^{th} position of an array may be a value Bi and the j^{th} position of the array a value Bj. The array B=(B1, B2, . . . Bn) may be an array to which a mask has not yet been applied. A mask may be represented as an array M=(M1, M2, . . . . Mn) where Mi is 0 or 1, may also be represented by another array, each element of which is a ciphertext of the associated mask value. Elements of the mask array may be C=(C1, C2, . . . Cn) where Ci is an ElGamal ciphertext of hi\hat{ }Mi mod p, where hi is a generator used in position i of the array, and \hat{ } represents exponentiation modulo p. Here, a ciphertext Ci of a plaintext value mi=hi\hat{ }Mi may be represented as a pair, (Di,Ei) where Di=y\hat{ }r mod p and E=mi g\hat{ }r mod p, and y=g\hat{ }x mod p is a public key and x is a secret key. Here, r may be a random number in Zq, for p=2\hat{ }k*q+1, and both p and q prime numbers, and k a positive non-zero integer such as k=2. A mask, while in its encrypted state, e.g., in a format of the array C, may be applied to a biometric input vector B. This may be done by computing Fi=(Di′, Ei′) for each value 1<=j<=n, where Di′=Di\hat{ }Bi mod p, and Ei′=Ei\hat{ }Bi mod p. This may correspond to Fi=(y\hat{ }(r*Bi) mod p, mi\hat{ }Bi*g\hat{ }(r*Bi) mod p)=(y\hat{ }(r*Bi) mod p, hi\hat{ }(Mi*Bi)*g\hat{ }(r*Bi) mod p). When a mask is Mi=0, then this corresponds to Fi=(y\hat{ }(r*Bi) mod p, g\hat{ }(r*Bi) mod p), which may be an encryption of 1, using the public key y; when the mask is Mi=1, this corresponds to Fi=(y\hat{ }(r*Bi) mod p, hi\hat{ }Bi*g\hat{ }(r*Bi) mod p), and/or an encryption of hi\hat{ }Bi using the public key y. Multiplying all the elements of the array F together, the result may be an encryption of a product of the hi\hat{ }Bi values for which the mask is set to 1. Each value hi may be set to the same generator, referred to as h. In certain embodiments, the values hi, 1<=i<=n may be distinct generators. A generator may refer to a value that generates Zq*. Thus, C may be a representation of a mask that may not disclose the mask to the party with access to C, since C may include ciphertexts. A party performing processing of a biometric input (e.g., generating an array B from at least one biometric sensor output), may perform computations on the encrypted mask C and the array B, without having to access the plaintext mask values. This may protect the mask from discovery by an attacker with access to the biometric token. Since a mask may include data about the particular array elements of B that may be relevant for generation of a key X, keeping the mask secret may protect key X from being brute-forced, in part because keeping the mask secret may significantly increase a search space for an attacker.

NFT security platforms in accordance with many embodiments of the invention may include a client-side device that may store a token that includes an encrypted mask array C. A bad actor with access to mask array C may not be able to determine the mask as it does not have a decryption key X. A client device may be able to receive and/or generate a biometric array B and combine this with C to form F, where F is an array that describes a biometric array, with the encrypted mask applied. This party may send F to a third party and/or may compute a value that is the pairwise product of all elements Fi, which may be an encryption of the product of all values hi\hat{ }(Bi*Mi) mod p, e.g., all the values hi\hat{ }Bi that the mask M array selected. A mask array may be different for different users, which may be undetectable since users may only have access to their encrypted mask. An encrypted product value, ProdF, may be transmitted to a third party entity. Client-side processing may include an evaluation of a biometric token, a processing of a biometric input, and a generation of at least one validator. NFT security platforms in accordance with many embodiments of the invention may include processing that may be performed by a digital rights management (DRM) module to limit risks associated with malware and/or undesirable code on a client device. NFT security platforms in accordance with many embodiments of the invention may perform processing in a trusted execution environment (TEE). However, even when processing is performed in a standard computational environment, such as by an application running on a phone and/or a laptop, NFT security platforms in accordance with many embodiments of the invention may limit risks for abuse. In particular, an abuse may have to take place, e.g., by malware, on a device associated with a person performing a biometric authentication attempt, and the risks may be limited to the leakage of sensitive data related to this person's PII. This may align incentives in a way that avoids risks of the type that typically are associated with brute-force attacks on other user's sensitive data, e.g., following a breach.

NFT security platforms in accordance with some embodiments of the invention may use third parties, where a third party may be a distributed party, e.g., a collection of devices trusted by an owner of a biometric token. Each such third party entity may have received a share of a secret key. A biometric token may include several shares, where the j^{th} share of a secret key X may be denoted by xj. NFT security platforms in accordance with many embodiments of the invention may share using different threshold schemes (e.g., a (6,9) threshold scheme), where it may be sufficient to have M (e.g., 6) out of the N (e.g. 9) shares reconstruct x and/or perform decryption. A share xj may correspond to a public version yj=g\hat{ }xj mod p. Third party entities may receive F and/or ProdF and generate a partially decrypted value, e.g., for ProdF=(ProdF1, ProdF2) this would be ProdF1\hat{ }xj/ProdF2 mod p. This partially decrypted value may be sent to a client holding the biometric token, e.g., over a secure channel. The communication may also include a proof of correct exponentiation with respect to yj, e.g., a zero-knowledge proof of exponentiation of ProdF to xj, followed by the division of ProdF2. A Schnorr signature and/or a DSA signature may be used to create a non-interactive proof of correct exponentiation. A validator may be ProdF, F, and/or may include signatures and/or zero-knowledge proofs related to the processing of arrays C and B.

NFT security platforms in accordance with various embodiments of the invention may include a client device that may receive B and compute F and may transmit a blinded array F and/or a blinded encrypted value ProdF; which may be computed by raising each element to a random power R, where the corresponding value 1/R may be applied by exponentiation as the responses may be received from third parties. In many embodiments of the NFT security platforms, a secure channel may be utilized. A client device can, upon receiving responses from third party entities, generate a product of all values hi\hat{ }(Bi*Mi) mod p, denoted as X. X may be mapped to a symmetric key by applying a cryptographic hash function H (e.g., cryptographic hash function SHA512, among many others), resulting in a bit key X (e.g., 512 bit key X) that may be stable, as insatiable elements from the biometric vector B may have been masked out and only the stable elements may be kept. A stable element may be robustly generated time after time. A key X may be used to decrypt and/or offset a stored value of the biometric key, resulting in an asymmetric private key, e.g., associated with a public key used to generate digital signatures. X and x as described may be different parameters with different uses.

In numerous embodiments of the NFT security platforms, individual elements Fi may be used to interpolate a key. This may be combined with the techniques described to generate a key from a biometric input where some biometric input aspects may be absent and/or otherwise fail.

NFT security platforms in accordance with some embodiments of the invention may use a client device to send an array F to a distributed trusted party which, after verifying optional proofs transmitted by the client device, may perform decryption for each element of the array F, and may send back a corresponding decrypted array. In many embodiments of the NFT security platforms, a client device may communicate over a secure channel set up by the client device prior to the transmission of F. A client device may receive multiple arrays, including different arrays from different entities, including at least one array from each of the distributed entities that include trusted third party. A client device may generate a decrypted array from individual arrays and, based on resulting values, perform an interpolation. NFT security platforms in accordance with many embodiments of the invention may execute different subsets of shares and determine whether two subsets result in a same outcome, in which case this may be accepted as a result of an interpolation.

NFT security platforms in accordance with multiple embodiments of the invention may be used with various different applications, including but not limited to: password authentication; 2FA; verification that a request is associated with a real human user, as opposed to a computerized bot; unlocking secret keys used to generate digital signatures; accessing a device and/or a wallet, among numerous other applications.

NFT security platforms in accordance with many embodiments of the invention may generate a key X with a device different than a client device, including at least one entity associated with a third-party service provider. Service providers may receive, in lieu of a key X, proof that demonstrates that a client and/or distributed third parties collectively have access to values from which key X may be generated (e.g., a product of all values hi\hat{ }(Bi*Mi) mod P. Accordingly, rather than a single user device being used to determine a key X, a distributed set of devices may collectively verify having access to key X providing proof to a service provider. NFT security platforms in accordance with many embodiments of the invention may provide client devices with the ability to provide data that may prove knowledge of a valid key, including providing data based on exponents Bi*Mi with respect to generators hi, and the distributed parties may not need data regarding Bi and/or Mi, where this may correspond to a public representation of a same key, the public representation may be of a format X\hat{ }d, where d may be a secret value stored in a biometric token. Biometric tokens in accordance with many embodiments of the NFT security platforms may store a key X in a location different than within a particular token, and may generate key X as needed, providing enhanced security, since key X may not be stored in the token, and may be generated on an as-needed basis.

NFT security platforms in accordance with many embodiments of the invention may provide security against attacks in which a bad actor of a token holder transmits a ciphertext to a distributed third party with the aim of using this distributed third party as a decryption oracle, the bad actor may need to provide data that satisfies a criteria that establishes knowledge of exponents Bi associated with a vector F and/or the associated product ProdF. Many embodiments may use different types of signatures, including a Schnorr signature, Digital Signature Standard (DSS) signature, among others. A timer may be used to throttle a number of requests and to minimize excessive requests. For example, a distributed third party may only be willing to perform a decryption action after having verified a signature (e.g., Schnorr and/or DSS signature), and only a certain number of times per time period, (e.g., once an hour).

NFT security platforms in accordance with many embodiments of the invention may use several encrypted masks to provide robustness, where a first encrypted mask may correspond to a first mask, and a second encrypted mask may correspond to a second mask. A first mask may result in a higher-entropy measurement and carry a higher risk of failure (e.g., due to poor environmental conditions when a biometric input is received).

Poor environmental conditions may include as examples: a bright setting in which a face-biometric is collected using a camera; a very noisy background in which a voice-based biometric measurement is taken using a microphone; among various others. Accordingly, a second mask may discard a larger number of entries of the biometric array B than a first mask may. A selection of the elements to discard may be based on problems associated with common poor environmental conditions (e.g., noise in a common spectrum, such as from a barking dog and/or engine sounds, among many other examples). A selection may depend on the set of biometric features of associated users that are most robust, e.g., the least likely to be “blurred” by poor environmental conditions. The several encrypted masks may be processed using similar techniques that may be utilized for a single mask. The several encrypted masks may result in a same key X when computed correctly and/or may result, under ideal conditions, in different keys, including a key X1 for the first mask and a key X2 for the second mask.

NFT security platforms in accordance with multiple embodiments of the invention may provide different keys with different security levels, and different services may require keys with particular security levels. For example, a high-security service may only allow access using a key X1, whose mask may be more restrictive than a mask associated with a key X2; whereas a lower-security service may provide access based on either key X1 and/or key X2, and may log which key is used that may be used for auditing and to accurately compute risks associated with requests from users. Thus, for a particular service provider requiring a particular level of security, when key X1 providing higher security is used as a key, a request may be accepted, whereas when a key X2 with a lower security level is used, then the request may be accepted after additional verification is performed, including, for example determining whether the requested transaction is between entities that have previously been involved in transactions with the user whose biometrics was verified. Accordingly, NFT security platforms in accordance with many embodiments of the invention may implement policy-based decisions that may use a strictness of a mask as an indicator of security associated with a biometric verification. The more or less stringent match associated with different masks may coincide with a level of risk of a given transaction. Different types of transactions may require different security levels, where a more stringent match mask may be required for high-cost transactions and a less stringent match mask for everyday low-risk and/or low-cost transactions.

NFT security platforms in accordance with various embodiments of the invention may generate and store a mask array M which may be encrypted using a symmetric key X, referred to as EncM. The mask array M may be stored in a token and/or with a trusted entity. An EncM may be in addition to an array C which may be encrypted using a public key Y as described. EncM may be accessed by a client device once the client device has successfully generated a key X. EncM may include an asymmetric secret key Z that may be used to decrypt log entries of log L, where log entries of L may be computed using a public key Z corresponding to a secret key Z. The log L may be stored in a same wallet in which a biometric wallet is stored. Encrypted entries of L may include previously received biometric inputs, a classification of whether a login and/or key derivation is successful. A client device can, having generated key X, access M and Z. Using Z, a client device may decrypt L and determine whether the biometrics of a user appear to be changing over time. This may be used to trigger a generation of a new mask M2, that may be used instead of M. A new encrypted mask may be generated from new mask M2. A switching of the mask may require the replacement of the key X with another key X2, which may be generated and used to encrypt the mask array M and the value Z. Whether a key X or a key X2 is used may not need to affect other parties to whom the client device authenticated after a successful generation of X (or X2). This may be achieved by using a third key, referred to as KEY, where an encrypted version, EKEY, of KEY may be stored in the token. At first EKEY may be generated using X, and later EKEY may be replaced by a new instance in which KEY is encrypted using key X2. Accordingly, KEY may be a symmetric key and/or a secret key of an asymmetric key-pair.

NFT security platforms in accordance with many embodiments of the invention may be used to protect laptops, desktops, phones, tablets, wearable devices among many other types of device. Locking may provide a mechanism to protect a device, which may include disabling access to resources until a biometric authentication is performed and found valid. It also includes being able to decrypt state information about a device, where the state information may include software, software parameters, and/or data generated by users.

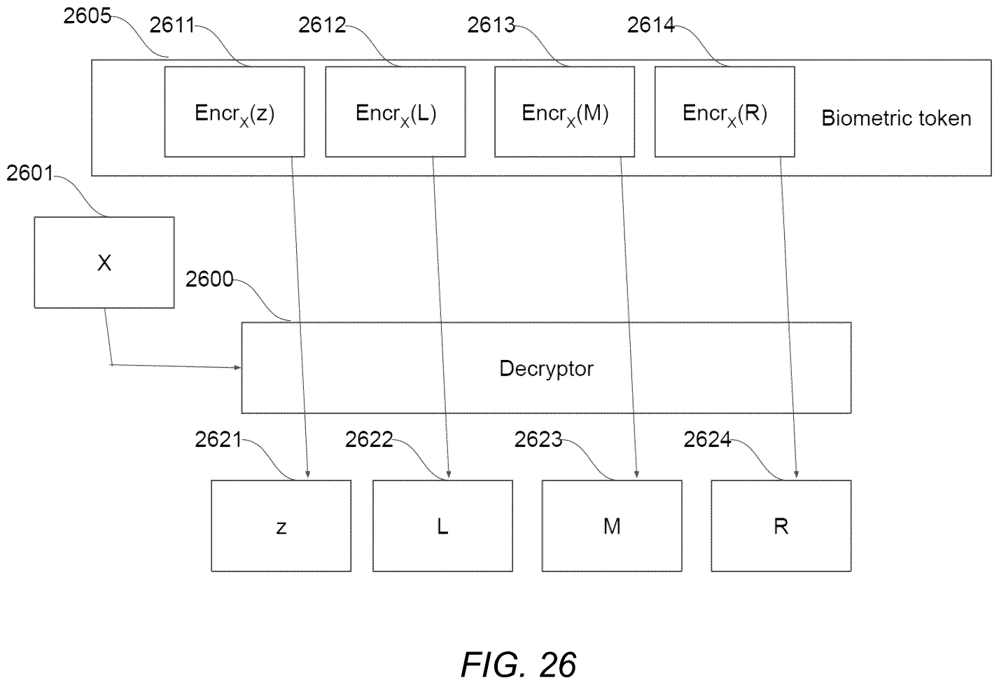

A process for authentication using biometric tokens in accordance with a plurality of embodiments of the invention is illustrated in FIG. 26. In particular, FIG. 26 illustrates actions that may be performed by wallet 2605 after receiving a response corresponding to a valid authentication using biometric input. Biometric tokens may include ciphertexts of sensitive data, such as EncrX(z) 2611, which may be an encryption of key z using symmetric key X 2601, EncrX(L) 2612, which may be an encryption of log L using symmetric key X 2601, EncrX(M) 2613, which may be an encryption of a mask array M using symmetric key X 2601, and EncrX® 2614, which may be an encryption of resource R using symmetric key X 2601. These quantities, as well as other such quantities not shown, may be decrypted using a decryptor 2600, whether all of them and/or selectively, which may result in plaintext values for private asymmetric key z 2621, log L 2622, mask array M 2623 corresponding to an array M, and resource R 2624. In many embodiments, Resource R 2624 may be software and/or data that the user associated with a given biometric token has the right to use. Elements 2611, 2612, 2613 and 2614 may be part of other tokens and/or a biometric token, and/or be part of both biometric token and one or more other tokens. Although FIG. 26 illustrates a process authentication using biometric tokens, any of a variety of processes may be utilized to authenticate tokens as appropriate to the requirements of specific applications in accordance with embodiments of the invention.

NFT security platforms in accordance with some embodiments of the invention may be used to prove access rights to external resources (e.g., service providers), which may be beneficial. NFT security platforms may be used to protect wallet contents (e.g., cryptocurrencies, NFTs, among others) against bad actors and action (e.g., against theft), by storing contents of a wallet in an in an encrypted form that may be decrypted based on a user performing a successful biometric authentication.

NFT security platforms in accordance with many embodiments of the invention may, additionally or alternatively, be used to decrypt content which may be stored in an encrypted format.

NFT security platforms in accordance with numerous embodiments of the invention may include at least one validator that may include an identifier of a user and/or a biometric token, where an identifier may be used to determine, by an outside entity such as a trusted third party entity, a claimed identity of a user whose biometric verification is performed. An identifier may be part of requests being sent to an outside third party entity and/or to service providers. A type of service provider may be one where a user needs to login and/or otherwise authenticate in order to gain access to a resource.

NFT security platforms in accordance with many embodiments of the invention may provide functionality of a trusted outside third party that may be part of an external service provider. An external service provider may receive a validator and apply decryption among various other transformations to the validator in order to determine validity of a biometric input and to perform a security action based on this determination. Security actions may include permitting access to resources, blocking access to resources, allowing access to a set of resources while blocking access to a different set of resources, requesting additional authentication, submitting a request that a user retries an authentication process, logging access attempts, and/or performing time-based lockouts for users associated with biometric tokens, among various other security actions.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

Characteristic Assignment to Identities with Tokens

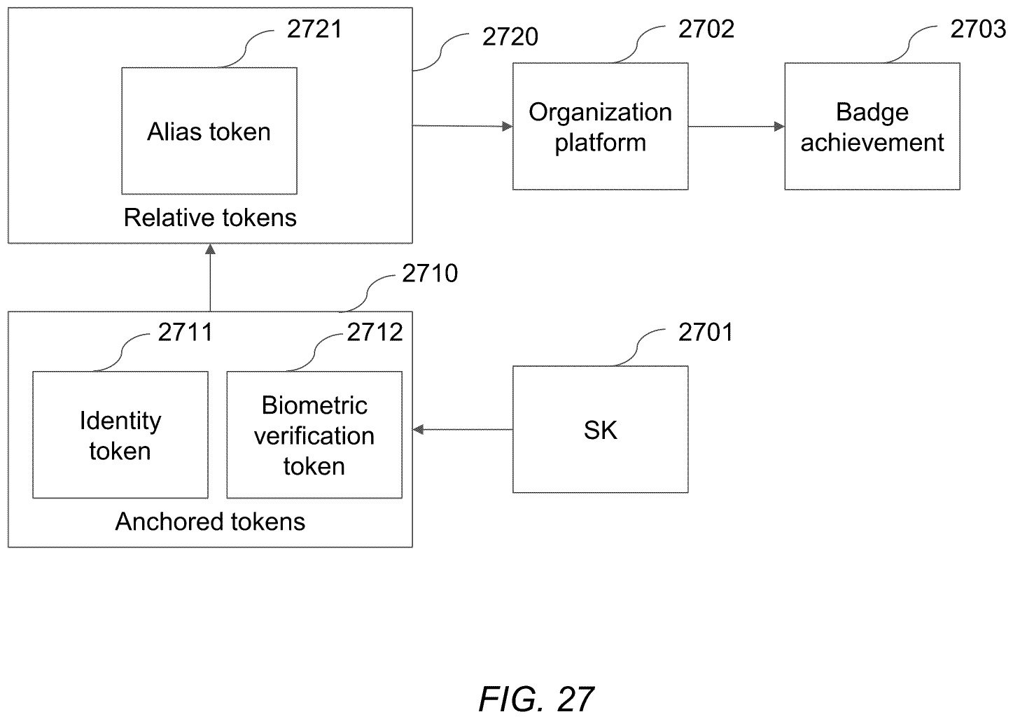

In several embodiments, achievements may be linked to users' identities. In some embodiments, recognition badges, or simply badges, may be tokens (e.g., NFTs). An example system for tying recognition badge achievements by an organization to a user's identity, in accordance with several embodiments, is conceptually illustrated in FIG. 27. A user's identity token 2711 and biometric verification token 2712 are anchored tokens 2710. The anchor tokens 2710 may be tied to a user's secret key 2701. An optional pseudonymous alias token 2721 may exist as a relative token 2720 to the anchored tokens 2710. The user, having registered their alias token 2721 and/or identity token 2711 with a 3rd-party organization platform 2702 may earn an achievement badge 2703. The achievement badge 2703 may be issued by the 3rd-party organization platform 2702 and/or other entities. The tokens described may be stored in the users' wallets.

In several embodiments, non-fungible tokens (NFT) may be minted which represent digital recognition badges. Recognition badges are also referred to as badges. NFTs may be referred to as tokens throughout this document. Tokens may include NFTs, and/or other types of tokens (e.g., fungible tokens). In certain embodiments, earned badges may be assigned manually and/or automatically. In various embodiments, processes for minting tokens may be executed on cryptographically secure decentralized public networks (e.g., Bitcoin and/or Ethereum blockchain networks, and/or on private blockchains). A private blockchain may include a private blockchain such as what an entity (e.g., a social media platform) might create in a controlled, centralized system. In many embodiments, cryptographically secure decentralized public networks may be immutable, or semi-immutable. Examples of cryptographically secure decentralized public networks are disclosed in co-pending applications U.S. Provisional Patent Application No. 63/216,662 filed Jun. 30, 2021 titled “Pseudo-Immutable Blockchain Method” and U.S. patent application Ser. No. 17/810,085 filed Jun. 30, 2022 titled “Distributed Ledgers with Ledger Entries Containing Redactable Payloads,” which are hereby incorporated by reference. In a number of embodiments, badges may be minted as tokens. In accordance with embodiments of the invention, badges minted as tokens (e.g., on decentralized public blockchains), may be portable, combinable, redeemable, and/or tied to an individual's true identity. Tokens (e.g., badges) may be tied to an individual's true identity with the use of identity tokens and alias tokens. Examples of identity tokens and alias tokens as disclosed in co-pending application co-pending U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. In some embodiments, badges awarded as tokens through a public blockchain may be considered licensed for use publicly by the awardee. In several embodiments, terms of use policies associated with a token may be controlled by a token's contract.

In some embodiments, recognition badges are tied to identifiers. In several embodiments, identifiers may be related to identities, and/or to pseudonyms. In certain embodiments, identities may include a person's name, social security number, email address and/or certified public key. In various embodiments, pseudonyms may be quantities that may be associated with identities, in a manner that is not publicly mappable. In some embodiments, pseudonyms may include limited-use public keys that are associated with identifiers. In some embodiments, associations between limited-use public keys and identifiers may be encrypted. In several embodiments, associations between limited-use public keys and identifiers cannot be determined (e.g., decrypted) without knowledge of a secret key, and/or without access to a proprietary database. In many embodiments, functionalities of recognition badges may depend on the types of identifiers tied to it. In a number of embodiments, a token may perform a first action, when the token is tied to a pseudonym the token may perform a second action, and/or when the token is tied to a biometric-secured public key then the token may perform a third action. In accordance with embodiments of the invention, token functionalities may depend on the security of the identifier it is tied to. In some embodiments, a hand-shape biometric may be considered lower security than a fingerprint biometric, which may in turn may be considered lower security than an iris-based biometric. In several embodiments, security associated with identifiers may be pre-determined. In several embodiments, different functionality may be provided based on a security level of tied biometrics. In various embodiments, functionalities may depend on sources of certification of public keys (e.g., the rating of the certificate authority (CA), whether it is a root CA, whether the certificate was provided after a physical verification of identifiers, whether there is an assurance associated with the certificate, etc.) In some embodiments, functionalities may also depend on platform-based data (e.g., whether the badge is associated with a platform running on a trusted execution environment (TEE), on a platform with software-based attestation, and/or other platform-based data.

In several embodiments, recognition badges may be issued in response to users performing countable tasks (e.g., users performing their 100th purchase on a given platform); another badge may be issued in response to a person advancing past a threshold (e.g., to a particular level, such as 1, 2, 3, or another number, of a specified game). In several embodiments, recognition badges may be associated with quality values that indicate how rare the achievement is. For example, a badge that is offered to the 1% highest scorers is, by definition, only offered to 1 out of 100 users. A badge that is offered to any users having performed 100 purchases can, for example, have a quality value equivalent to a badge that is offered to between 10 and 15 out of 100 users. In certain embodiments, badges may correspond to maximum numbers of grants per 100 users, as per a policy associated with the badge. In accordance with various embodiments of the invention, badge quality values may be associated with ranges (e.g., between 10 and 20 per 100 users). In some embodiments, quality value ranges may be used to group different badges in a manner that organizes and/or ranks them in terms of exclusivity. In various embodiments, the arbitrary nature of many recognition systems may be avoided through automatization of the token minting and distribution process following software-coded policies (e.g., of an organization).

In some embodiments, processes may be able to use the wallet associated with a user and/or multiple users, and analyze the smart contracts collected in the entirety of the wallets in order to award the badges. For example, an NFT marketplace platform announces that creators will get a “Top 10 November Creator” for the top artists that sell the most artwork on the system in the month of November. In some embodiments, the awarding of a badge may be accomplished by a process by analyzing all the smart contracts created on the platform during the month of November. In several embodiments, a badge called the “1 Million Dollar Buyer”, which awards buyers on the platform who purchase a total of 1 million dollars on the platform during their lifetime on the platform. This would be accomplished by analyzing the total amounts that are stored in the smart contracts in each user's wallet. Another example is a “Sports 100000 Collection” which is a badge awarded to users whose value of tokens in a particular collection are collectively worth 100000 dollars. Awarding of badges may be evaluated at the time of purchase when a user buys a new NFT and/or awarding of badges may be evaluated as the value of the tokens in the user's wallet goes up thereby automatically awarding the user when values of the tokens evolve over time.

In various embodiments, badges may be capable of expiring and/or being revoked from a user. In several embodiments, badges may be revoked based on a user's failure to perform an action required to maintain ownership of a badge. Disabling, revoking, and partial disablement of NFT capabilities is disclosed in co-pending U.S. Provisional Patent Application No. 63/255,032 filed Oct. 13, 2021 titled “Non-Fungible Token Peeling” and U.S. patent application Ser. No. 17/929,894 filed Sep. 6, 2022 titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” which are hereby incorporated by reference. For example, a “Win Streak” badge may be awarded to a player in a video game for winning multiple consecutive matches. When the player loses a match, the “Win Streak” badge may be removed from the player's digital identity. In another example, a “One Month Subscriber” badge is awarded to a user for enrolling in a subscription service. This badge is automatically upgraded to a “Two Month Subscriber” and “Three Month Subscriber” badge upon consecutive months of maintaining their enrollment. In some embodiments, badges may be automatically revoked when users end their enrollment to a service.

In several embodiments, badges may be awarded and/or augmented based on real-world achievements. Real-world achievements may include physical attendance of events held in real-world locations. For example, a musician holds a live concert and offers an exclusive “Biggest Fan” NFT badge reward to those who physically attend the event in person. In various embodiments, users' attendance may be verified, when users scan one or more NFC and/or RFID tags physically located at event venues with their mobile devices.

In several embodiments, tokens (e.g., badge tokens) may be tied to the user to whom it is assigned by associating the token to a user and/or organization identity. In some embodiments, assignments to users may include references to public keys in tokens as they are minted. In certain embodiments, identities of users may be required to be verified prior to use of token content. Use of token content may include rendering of the content. Identity verifications may be required by policies included in tokens. In various embodiments, verifications may be performed by requiring evidence of identity. Evidence of identity may be obtained and/or facilitated by wallets associated with public keys embedded in tokens for purposes of linking badges to user identities. Public keys may be pseudonyms. In accordance with some embodiments of the invention, public keys may be pseudonyms in that the public keys do not specify users' identities. In accordance with various embodiments of the invention, public keys are only used for the purposes of tying (e.g., identifying as related) tokens to wallets. In various embodiments, one or more public keys may be associated with a wallet, and/or distributed by the wallet to token issuers when the token issuer wish to tie the badge to the wallet. In many embodiments, badges may be tied to biometric identifiers of users. In a number of embodiments, biometric identifiers may be expressed using biometric tokens. Identity tokens and biometric tokens are disclosed in co-pending U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. Tokens that are tied to identifiers such as public keys of wallets and/or to a user may be termed non-transferable. In some embodiments, the non-transferable features are with respect to the wallet identifiers (e.g., the wallets' public keys and/or the users associated with the wallets by means of their biometrics). In several embodiments, tokens may be transferred to new instances of the same wallet on another device (e.g., in the case a user replaces their device used to run the wallet application with another device, such as a newer phone). In several embodiments, tokens tied to biometrics may be tied to a new expression of the same biometric (e.g., updated facial scans of one and the same user). Tying tokens to updatable biometrics is useful to perform every once in a while, as users age and their features change.

In many embodiments, users who have associated their wallets' contents with a set of fingerprints may wish to re-associate the wallets' contents to a face-print. In accordance with numerous embodiments of the invention, a second biometric (e.g., a face scan) may be verified to correspond to a first user. The first user may correspond to a first biometric (e.g., fingerprint scan). The first biometric may be to link a token to the first user. Based on the verification of the second biometric, the second biometric may be registered as linking the token to the first user.

In a number of embodiments, when face biometrics may be verified to correspond to the same user as the fingerprints do, this does not change who the user is, and accordingly, the link between the token and the user remains. In several embodiments, tokens may be tied to public keys and/or sets of biometrics, and to any of its successors, where a proof and/or evidence of identity has to be provided to update the association. The tying of property to wallets and/or biometric features may also be non-permanent and done for security purposes (e.g., as an anti-theft measure). In several embodiments, users may tie the contents of the users' wallets to wallet public keys until a reassignment of individual wallet contents (e.g., tokens) is performed. In several embodiments, performance of reassignments may require evidence of identity. Evidence of identity may be in the form of a match with a biometric token. In various embodiments, users may be protected against theft of NFTs as long as their biometric features cannot be forged to the wallet. In several embodiments, users may be able to sell individual NFTs when desired (e.g., by authenticating to the wallet using biometrics and reassigning the selected tokens to indicate that they no longer are tied to the public key of the wallet). In various embodiments, processes may obtain unlock keys using biometric tokens, where such unlock keys may be used to circumvent the requirement that the token be tied to the public key of the wallet. In several embodiments, policies (e.g., policies associated with tokens) may be included in NFTs. Policies may specify that an NFT is tied to the public key of the wallet and/or the key may be obtained from successful biometric authentication (e.g., of the user to the biometric token and facilitated by the wallet).

While specific systems for tying recognition badge achievements by an organization to a user's identity are described above, any of a variety of systems may be utilized to tie recognition badge achievements by an organization to a user's identity as appropriate to the requirements of specific applications. In certain embodiments, components may be included in any arrangement and/or sequence not limited to the arrangement and sequence shown and described. Although the above embodiments of the invention are described in reference to tying recognition badge achievements by an organization to a user's identity, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

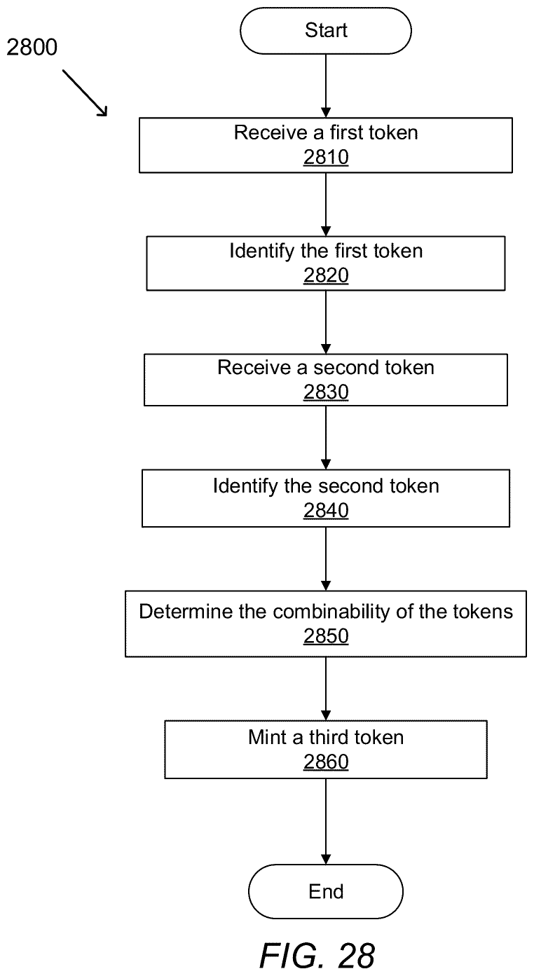

In some embodiments, two tokens from two organizations may be combined into one or more new tokens. A process for combining two tokens from two organizations into one or more new tokens, performed in accordance with numerous embodiments of the invention, is conceptually illustrated in FIG. 28. The process 2800 receives (2810) a first token. In accordance with some embodiments of the invention, the first token is minted by a first entity (e.g., first group). The process 2800 identifies (2820) the first token. In several embodiments, the first token may be identified as having been minted by the first entity. The process 2800 receives (2830) a second token. In some embodiments, the second token is minted by a second entity (e.g., second group). The process 2800 identifies (2840) the second token. In various embodiments, the second token may be identified as having been minted by the second entity. The process 2800 determines (2850) a combinability of the first token and second token. The process 2800 mints (2860) a third token. The minting of the third token may be based on the determined combinability of the first token and second token. The third token may be a derived token. In some embodiments, the first token may be associated with first characteristics, and second token with second characteristics, and/or a third with third characteristics. In some embodiments, each of the first, second, and third characteristics may enable access to different content. In accordance with various embodiments of the invention, the first entity and/or the second entity may be unaware of the existence of the first token and/or the second token. In accordance with numerous embodiments of the invention, processes (e.g., wallets) identifying the compatibility of token may trigger the minting of additional tokens to supplement and/or replace one or more other tokens (e.g., the first and/or second token). In some embodiments, minted tokens (e.g., the third token) may be populated in the same user's wallet. In several embodiments, tokens may be required to access content. In various embodiments, the third token may be required to access third content; the second token may be required to access second content; and/or the first token may be required to access first content. Minting the third token therefore may provide access to previously inaccessible content.

In accordance with some embodiments of the invention, recognition badge tokens are combinable. Combination may be performed for badges issued by more than one organization. For example, a student and/or graduate of a particular university may possess a token from their university representing their status as an alumni, and a token from a prestigious science journal for having published 25 peer-reviewed papers. A combination of the two tokens, a derived token either replacing both, or supplementing both, may exist to further a partnership between the university and the publication. Derived tokens are described in in co-pending U.S. Provisional Patent Application No. 63/213,251 filed Jun. 22, 2021 titled “Token Creation and Management Structure” and U.S. patent application Ser. No. 17/808,264 filed Jun. 22, 2022 titled “Systems and Methods for Token Creation and Management,” which are hereby incorporated by reference. In several embodiments, recognition of the available combination of the two tokens may be performed by a user wallet and/or similar trusted execution environment (TEE). In certain embodiments, combined tokens may bestow additional rights (e.g., access rights) to the licensee whereby a new set of policies may exist with the combined token. Tokens generated by combining tokens may be referred to as derived tokens and/or derived badges. In certain embodiments, combinations may depend on the quality levels of the associated badges, or whether they have an associated quality level or not. Badges (e.g., derived badges) may anonymize data of the badges from which the derived badge was generated.

In several embodiments, a first badge token may correspond to a first user state (e.g., a first user's graduation diploma, and may include the full name of the person). In various embodiments, a second badge that is derived (e.g., a derived badge) from the first may correspond to data obtained from the first user state (e.g., the second badge may simply state that the holder has a specified degree from a qualifying university). In many embodiments, derived badges may additionally include encrypted data that enables the verification of such a claim (e.g., encrypted references to one or more tokens that the derived token, i.e., badge, is based on).

While specific processes for combining two tokens from two organizations into one or more new tokens are described above, any of a variety of processes may be utilized to combine two tokens from two organizations into one or more new tokens as appropriate to the requirements of specific applications. In certain embodiments, steps may be executed and/or performed in any order or sequence not limited to the order and sequence shown and described. In a number of embodiments, some of the above steps may be executed and/or performed substantially simultaneously where appropriate or in parallel to reduce latency and processing times. In some embodiments, one or more of the above steps may be omitted. Although the above embodiments of the invention are described in reference to combining two tokens from two organizations into one or more new tokens, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

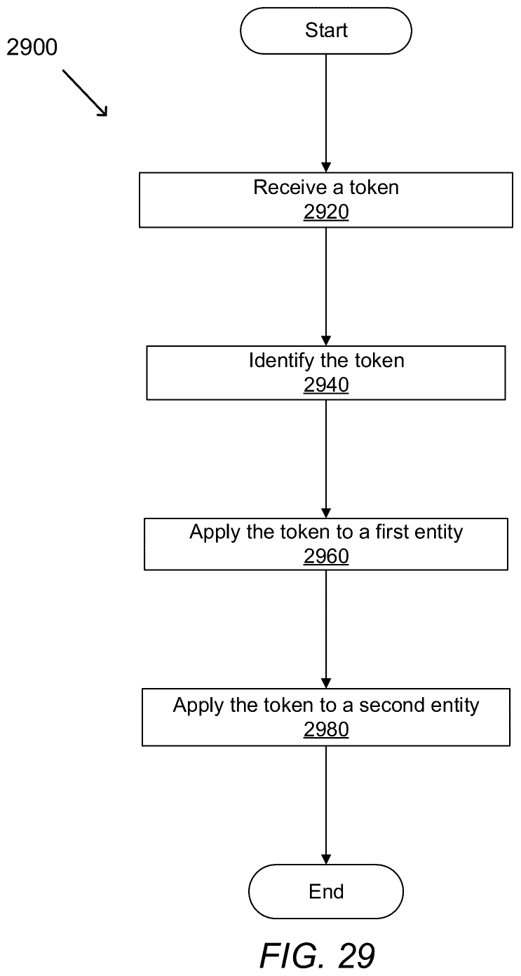

In some embodiments, recognition badges may be portable and reusable recognition badges. In several embodiments, recognition badges may be portable within two or more entities (e.g., organizations). Recognition badges may be tokens that provide access to content. An example process using portable and reusable recognition badges within two or more entities is conceptually illustrated in FIG. 29. The process 2900 may receive (2920) a token. In some embodiments, the token is minted by a first entity. The process 2900 may identify (2940) the token. In various embodiments, the token may be identified as a token minted by the first entity. In several embodiments, the token, also placed in the user wallet may represent an event associated with the user (e.g., a graduation event of the user, signifying their alumni status and enabling an alumni recognition badge on the university's various digital platforms). The process 2900 may apply (2960) the token to processes associated with the first entity (e.g., a website associated with the first entity). In accordance with some embodiments of the invention, applying the token may include displaying the token in a computer environment and/or accessing content based on the token. The process 2900 may apply (2980) the token to a second process associated with a second entity (e.g., a website associated with the second entity). In various embodiments, tokens (e.g., recognition badges) may be generated by a first entity and compatible with one or more second entities. In several embodiments, users may be able to apply tokens (e.g., an alumni recognition badge) to 3rd-party platforms (e.g., social media platforms, and/or other platforms).

In some embodiments, recognition badges are reusable, and/or portable, as defined by policies associated with tokens. In several embodiments, recognition badges earned in gaming environments may be used, according to policies, in social media platforms. The policies enabling such portability may be accommodated by policies contained in token contracts. In certain embodiments, inter-platform use of tokens may be standardized. Standardized inter-platform tokens may include but are not limited to specific types of achievement tokens, portable through the use of commonly used industry standards. In accordance with various embodiments of the invention, tokens achieved in social media platforms may enable reusability, and/or redemption, within a gaming environment. In a number of embodiments, achievements in first (e.g., gaming) platforms, expressed as tokens, may be redeemable on second (e.g., social media) platforms for a particular status badge and/or cryptocurrency. In some embodiments, tokens (e.g., badges) may be redeemable as coupons at marketplaces. In some embodiments, original tokens may still exist after the redemption, however, the coupon portion of the token may become disabled upon use (e.g., as determined per policy). In several embodiments, a first badge may be used in the context of a second application (e.g., platform). The second application may be independent of a first application (e.g., platform). The first application may be an application that issued the first badge. In certain embodiments, the use in the context of the second application does not require the collaboration of the first application. In accordance with some embodiments of the invention, a badge earned in a first application (e.g., social media) context, (e.g., specifying that a user is among the 1% of users with the largest number of likes in a given week), may be used in a second application (e.g., a game) context. In the second context the badge may trigger an effect (e.g., the badge causes trolls in the game to be less aggressive against the user with the badge than they would have). In some embodiments, the triggered effect may reduce over time (e.g., the troll repellent functionality may wear off gradually as the badge of many social media likes ages when time passes since its issuance) and/or in response to other conditions being met. In accordance with numerous embodiments of the invention, interpretations of meanings of badges, by the second application, may be performed based on the second application accessing the token, and/or badge, and/or reading a portion that encodes a meaning associated with the badge. In some embodiments, the meaning may be expressed by a machine-readable formulation that identifies at least one qualifying criterion for being awarded the badge. In several embodiments, both meaning and quality values may be expressed in tokens to enable interpretation by second applications (e.g., the game with potentially pacifiable trolls). In various embodiments, second applications may base an applied effect on meaning and/or quality values associated with a token.

In some embodiments, users may collect badges of certain types, complementing types, and/or increasing quality values, based on a game associated with the grouping of the badges. In several embodiments, an entity (e.g., badge issuer, process, application) may create a badge bingo wherein a bingo card is associated with badges of a specified range of quality values, and each position is associated with a number and/or other identifier. In several embodiments, A position is occupied by a badge when the badge is associated with the appropriate number and/or other identifier. In several embodiments, each badge issuer may be associated with a number (e.g., based on the issuer-associated public key and/or other identifier. In many embodiments, associated badges issued by such organizations may be assigned to locations with a number of other identifiers matching the required value. In many embodiments, users may solve puzzles in order to determine what badges would be possible to place in what locations. In certain embodiments, badges may experience a sequence of upgrades to new levels. Upgrades may be in response to the user performing additional related tasks (e.g., such as buying their 10th and 20th items on a platform).

We refer to tokens, such as NFTs, that include badges, such as achievement-based badges and/or recognition-based badges, as badge tokens and vice-versa. Badge tokens may be peelable, as disclosed in co-pending U.S. Provisional Patent Application No. 63/255,032 filed Oct. 13, 2021 titled “Non-Fungible Token Peeling” and U.S. patent application Ser. No. 17/929,894 filed Sep. 6, 2022 titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” which are hereby incorporated by reference.

In some embodiments, recognition badges are exchangeable, tradeable, and/or redeemable, as allowed by policy. In several embodiments, achievements made by a member of a group (e.g., a youth scout organization) may receive a recognition badge in the form of a digital token. In certain embodiments, the token may be exchangeable for another badge, perhaps upon reaching a more elevated achievement. In many embodiments, badges may be exchangeable for goods and/or services based upon policy. In various embodiments, the token may continue existing or may cease to exist after exchange. In various embodiments, a member (e.g., scout) may exchange a badge for a reward (e.g., 2 tickets to a local movie theater). The member (e.g., scout) may see the token transfer to the theater and the theater may be able to return the token to the group (e.g., the scouting organization) in exchange for a business recognition of supporting the group (e.g., the scouting organization). In certain embodiments, recognition badges from one social media platform may be exchangeable for similar recognition badges from other platforms. In certain embodiments, a badge from an airline may be minted to award a frequent flyer. Badges may enable, per policy, access to frequent flyer tokens from other entities (e.g., partners or competing entities). One skilled in the art will recognize that recognition badges are but one type of token, and that the embodiments described throughout this disclosure may apply to other types of tokens, such as loyalty tokens. Badge tokens may be used as discount coupons and/or as frequent flier miles are used.

In various embodiments, processes may enable the semi-permanent and permanent storage of tokens on public decentralized networks. In several embodiments, publicly stored tokens may be perceived as more useful and valuable than those controlled solely by the issuer. In several embodiments, tokens from two or more issuers may interact within a user's wallet and/or within 3rd-party trusted execution environments. In accordance with various embodiments of the invention, badges may be publicly audited since the badges' existence may be determined based on accessing a database (e.g., a blockchain). In several embodiments, auditing may be important to safeguard against badge-based inflation and/or abuse based on reckless minting of badges. In several embodiments, public verifiability may be implemented in a variety of manners. Public verifiability may be implemented by only permitting badges with serial and/or edition numbers within pre-specified ranges. In certain embodiments, systems may be configured to not permit duplication of the same serial numbers. In several embodiments, automated audit capabilities, whether performed by the issuer and/or a 3rd-party may help to validate the issuer's actions versus stated policy. In various embodiments, public verifiability may extend to validation of the issuance of badges per stated company policies. In accordance with some embodiments of the invention, public verifiability may be used to verify that a stated quality measure is correct, and/or at least plausibly correct based on probabilistic verification methods.

In several embodiments, badges controlled and contained within publicly available decentralized networks may be used; in user gaming profiles; within emails and/or other communications; to demonstrate achievement; and/or status. In certain embodiments, badges express loyalty, recommendations, and/or reviews.

While specific processes for using portable and reusable recognition badges within two or more entities are described above, any of a variety of processes may be utilized to use portable and reusable recognition badges within two or more entities as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to using portable and reusable recognition badges within two or more entities, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

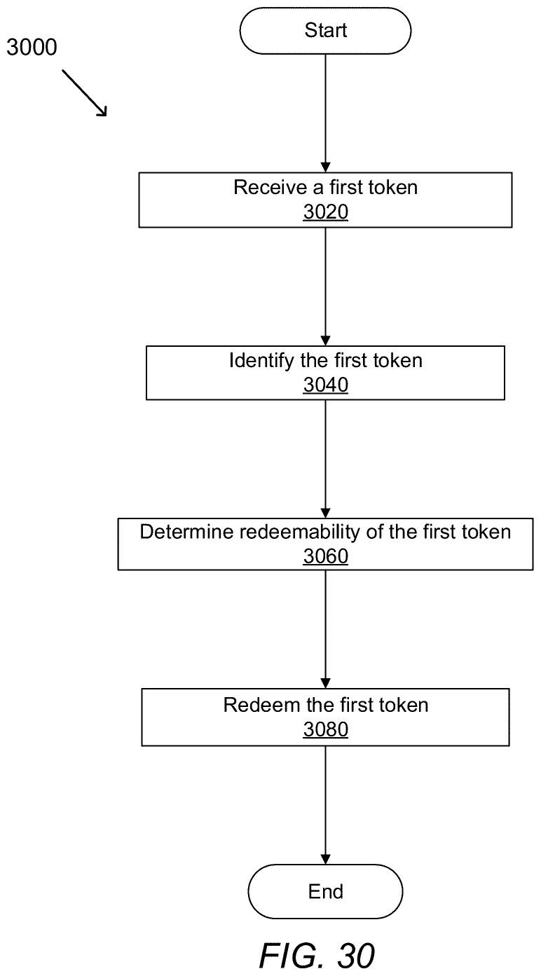

In a number of embodiments, tokens may be redeemable recognition badges. An example process for using redeemable recognition badges in the form of tokens is conceptually illustrated in FIG. 30. Process 3000 receives (3020) a first token. In some embodiments, the first token may be a token minted by a first entity (e.g., organization and/or group). Process 3000 identifies (3040) the first token. In several embodiments, the first token may be identified as having been minted by the first entity. Process 3000 determines (3060) the redeemability of the first token. In several embodiments, the redeemability of the first token may be based on a condition being satisfied. In many embodiments, the condition may be the passage of time, the condition may be based on blockchain events, and/or the condition may be defined by a policy. Process 3000 redeems (3080) the first token. In certain embodiments, tokens, which have redeemable characteristics may be redeemed by users, wallets, and/or 3rd-party systems. In accordance with numerous embodiments of the invention, redeemability characteristics may be dependent upon policies. Process 3000 may redeem (3080) of the first token through actions including but not limited to destroying the first token; by minting a second token; and/or by minting a third token. In some examples, two new tokens may be created, however, there are a variety of possible outcomes, such as destruction of token A, the deprecation of token A, the creation of one or more new tokens, and/or the extraction of a redeemed item from token A (e.g., such as redeeming a recognition badge token for a cinema ticket, as described elsewhere herein). In accordance with embodiments of the invention, different tokens may enable access to different content.

While specific processes for using redeemable recognition badges in the form of tokens are described above, any of a variety of processes may be utilized to use redeemable recognition badges in the form of tokens as appropriate to the requirements of specific applications. In certain embodiments, steps may be executed and/or performed in any order and/or sequence not limited to the order and sequence shown and described. In a number of embodiments, some of the above steps may be executed and/or performed substantially simultaneously where appropriate or in parallel to reduce latency and processing times. In some embodiments, one or more of the above steps may be omitted. Although the above embodiments of the invention are described in reference to using redeemable recognition badges in the form of tokens, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

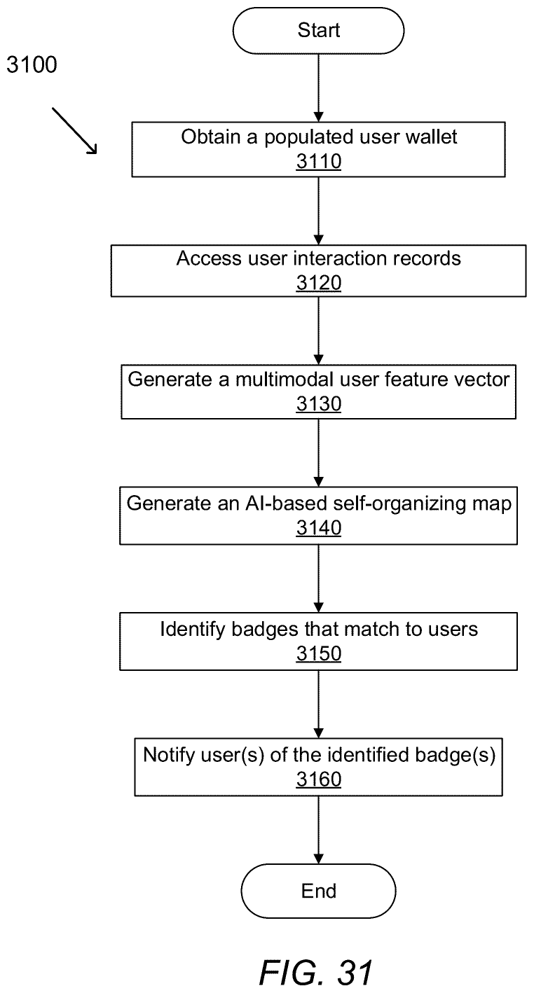

In some embodiments, processes may predict potential future badge awards. An example process for the prediction of potential future badge awards is conceptually illustrated in FIG. 31. Process 3100 obtains (3110) a populated user wallet through means including but not limited to directly populating a user wallet and/or receiving a populated user wallet. In accordance with some embodiments of the invention, user wallets may be monitored.

Additionally or alternatively, process 3100 accesses (3120) user interaction records. In several embodiments, processes may record user interactions with the applicable platform. In certain embodiments, monitoring may include collecting user data. User data may be collected from the user wallet and/or the user collection of smart contracts. In various embodiments, the data gathered may be an aggregate amount of time on the site, monthly levels of activity on the site, the number of comments a user creates, and/or other information.

Process 3100 generates (3130) a multimodal user feature vector based on one or more data elements (e.g., N dimensions). Data elements may include but are not limited to data associated with wallets (e.g., a user's wallet), smart contracts (e.g., smart contracts associated with the wallet and/or the user) and user activities (e.g., as described elsewhere herein). In several embodiments, feature vectors may use averages, changes in positions, and/or other mathematical summarizations to simplify the signals of each data element. While some processes discussed describe generating a multimodal feature vector for a user, related processes may similarly generate multimodal feature vectors for tokens (e.g., badges).

Process 3100 generates (3140) an AI-based self-organizing map. In many embodiments, AI-based self-organizing maps may describe tokens (e.g., badges) which each have pre-set feature vectors that are organized in N dimensions. The self-organizing maps may be constantly evolving as new badges are created and constantly recalculated using an AI self-organizing methodology.

Process 3100 identifies (3150), through the AI-based self-organizing map, badges that match to users based on the multimodal feature vectors of the users and/or the badges. In accordance with embodiments of the invention, user feature vectors (e.g., as created in step 3130) may be inserted into the AI-based self-organizing map and using a k-nearest neighbor methodology, the closest badge achievable may be found in N-dimensional space. Process 3100 notifies (3160) user(s) of the identified badge(s). In some embodiments, processes may use the selected predicted badge and/or the feature vectors from the user and/or the badge to find the difference in what was required to earn the badge. In certain embodiments, the user may be notified what they may do to earn a badge.

In some embodiments, processes may predict future potential badges a user is eligible and/or likely to achieve and display them to the user. In several embodiments, processes may store interactions of users as elements in smart contracts. In various embodiments, processes may use a K nearest neighbor AI technique on the calculated confidence intervals to determine which badges are attainable in the near future as described elsewhere herein. In certain embodiments, processes may probabilistically determine which potential badges to display. In certain embodiments, a system may calculate a 40% likelihood that a user with a given history may achieve the goal by spending $20,000 after only spending $10,000 and a user that is $5,000 from a goal of $100,000 may be 90% likely to achieve the goal. In accordance with embodiments of the invention, processes (e.g., wallets) may document what is required to achieve these badges and automatically document the badges in a notification to the user via email, text and/or an in-app notification. In some embodiments, a process could notify the top 100 creators in November that they are in contention to win the “Top 10 November Creator” token. In various embodiments, users who spend $900,000 dollars on the platform overtime may be notified that they only have to spend $100,000 more to earn the “1 Million Dollar Buyer” Badge.

In many embodiments, predictions, like whether a user is likely to spend a certain amount within the month, are relative to the user alone, and may be based on historical purchases, recent purchases, recent browsing activities, and/or remaining amounts to be spent. In accordance with various embodiments of the invention, predictions are relative to other users as well as to the user for which the prediction is offered. In various embodiments, predictions of whether a given user will end up having made purchases that end up being among the 25% fastest appreciating purchases during the month is based on the user's actions, and/or predicted actions, as well as actions of other users, and/or their predicted actions, and/or on a general prediction of appreciation of NFTs that have appreciated well during the portion of the month that has already elapsed. Predictions may be performed using systems that may include but are not limited to statistical engines, machine learning algorithms, and/or artificial intelligence systems.

While specific processes for the prediction of potential future badge awards are described above, any of a variety of processes may be utilized to predict potential future badge awards as appropriate to the requirements of specific applications. In certain embodiments, steps may be executed and/or performed in any order and/or sequence not limited to the order and sequence shown and described. In a number of embodiments, some of the above steps may be executed and/or performed substantially simultaneously where appropriate or in parallel to reduce latency and processing times. In some embodiments, one or more of the above steps may be omitted. Although the above embodiments of the invention are described in reference to the prediction of potential future badge awards, the techniques disclosed herein may be used in any type of cryptographic systems. The techniques disclosed herein may be used within any of the rich media systems, permissioned blockchains, distributed ledgers, processes for cryptographically enabling characteristic assignment to identities with tokens, token validity assessments and/or state capture processes as described herein.

### Immersive Personalized NFT Wallet Interactions

Systems and methods in accordance with numerous embodiments of the invention may be used for displaying, streaming, and/or rebroadcasting art in public places. Systems may be implemented on media-chains created for content creators. Additionally or alternatively, systems may be embedded with customized hardware in output devices including but not limited to visual displays, projectors and speakers; wherein such devices may direct access to user wallets revealing users' ownership and licenses for particular artwork.

Systems and methods in accordance with multiple embodiments may be directed to methodologies of networking and sharing personal wallet information using modes including but not limited to Bluetooth, Zigbee, Wi-Fi, etc. Additionally or alternatively, wallet information may be shared from users' smart devices to (e.g., specialized) NFT-enabled hardware including but not limited to TVs, large format displays, projectors, smart home hubs, cars, elevators, augmented reality systems, virtual reality systems, etc. In accordance with some embodiments, users may set privacy preferences of their wallets for sharing in public and/or private settings. Privacy and security concerns, in addition to NFT licensing policies may be controlled by one or more crypto-wallets in the scenarios described below.

Systems in accordance with many embodiments may be compatible with rendering in public as well as in private. An example of private rendering is in contexts including but not limited to augmented reality (AR), virtual reality (VR), mixed reality (MR), enhanced audio-based reality (EAR), and combinations of these. Examples of such technologies and their use were disclosed in co-pending U.S. patent application Ser. No. 17/811,831, titled “Systems and Methods for Token Management in Augmented and Virtual Environments,” filed Jul. 11, 2022, incorporated by reference in its entirety.

Several examples of the disclosed technology framework may be directed to users in enclosed settings (e.g., elevators, vehicles, waiting rooms). In an elevator example, the elevator may be equipped with a hardware device to automatically get access to the rider's wallet via their smartphone, tablet and/or smartwatch. Additionally or alternatively, any auditory devices (e.g., the elevator sound system) may be configured to automatically stream personalized audio (for example, music that a user owns or has license to in their wallets). In an example based in a vehicle, systems in accordance with various embodiments may be used to listen to the driver's musical selections; additionally or alternatively, media-chain wallet-enabled users may be able to automatically hear/watch songs, podcasts, and/or audio-visual content. In one example, a user may be able to see personal information, such as their social media feed, selected from their own personal wallet, on a rear-seat passenger screen while riding to their destination.

Systems may facilitate the above methods through modes including but not limited to embedded technology in enclosed settings using Bluetooth and/or Wi-Fi based technology. Such technology may be to access users' wallets on their smart devices, phones, watches, glasses, etc., and retrieve relevant content (e.g., music files) stored in their wallets. As user locations change (e.g., a user in a taxi arrives at their destination), different media devices (such as the elevator mentioned above), may be used to continue content streams. Further, cases where content streams continue from the same point may be enabled by automated handoffs facilitated by the disclosed technology, including but not limited to the users' wallets.

Systems and methods in accordance with some embodiments may enable user enjoyment of content while: (1) the user is not required to wear headphones and/or look down at their device (which is especially helpful in scenarios where the device may have tiny displays, such as smartwatches), (2) the device isn't required to store the media, and (3) internet connection isn't required (as could be the case in the elevator). Wallet and/or devices configured in accordance with many embodiments may thereby connect to the nearest display system(s) without the need for hardware other than the personal wallet devices. Another example may involve a user in a hotel lobby with specialized large screen displays that are enabled with the proposed NFT sharing technology.

In accordance with multiple embodiments, devices may be able to connect to the users' wallet and obtain visual imagery the user owns and/or has licenses to and display them in the public space. The connection may be initiated either by these devices and/or by a portable user device such as a cellular phone. The connection may be used for purposes including but not limited to granting permissions, making selections, and configuring how rendering is done. Systems in accordance with some embodiments may connect to multiple users in the same space with the systems rotating through a different work every minute, based on the settings of the systems. Observers of such artwork may vote with their eyes and ears, for example, as measured by their interaction (e.g., duration, intensity) and observation of the artwork. Additionally or alternatively, observers may receive the details of one or more particular assets. Assets themselves may be advertisements in this context with observations recorded for the benefit of the promoter and e.g., potential royalty, commission, etc. payments.

In accordance with some embodiments, multiple users may enter an immersive environment (elevator, hotel lobby, zoo, theme park, museum, etc.) and have their digital wallets connect via Wi-Fi and/or Bluetooth to the public space digital wallet hub. Once authenticated and approved for participation by each user, the hub may create a collage of different assets using elements from users' digital wallets. Hubs configured in accordance with some embodiments may do so by using uses Learning (ML) techniques to find similar items that match together, including but not limited to visual material, and/or audio material that is combined into multi-user interactions. The collages may then be displayed on large format displays and/or immersive experiences as described above (e.g., using music displayed through public speaker arrays).

Specialized displays may be used for settings including but not limited to conventions, festivals, and events. In doing so, the displays may utilize formats where characteristics (e.g., context and scale) may be exploited. Additionally or alternatively, displays may utilize combinations of sound, audio, and haptic interfaces that have more immersive experience mechanisms (using techniques including but not limited to projection mapping, whereby objects are turned into display surfaces).

Users may thereby convene to share content en masse (e.g., using over-sized screens). Systems configured in accordance with some embodiments may work with multi-users with wallets. Additionally or alternatively, assets from multiple wallets may be collaged together to form new community-based displays.

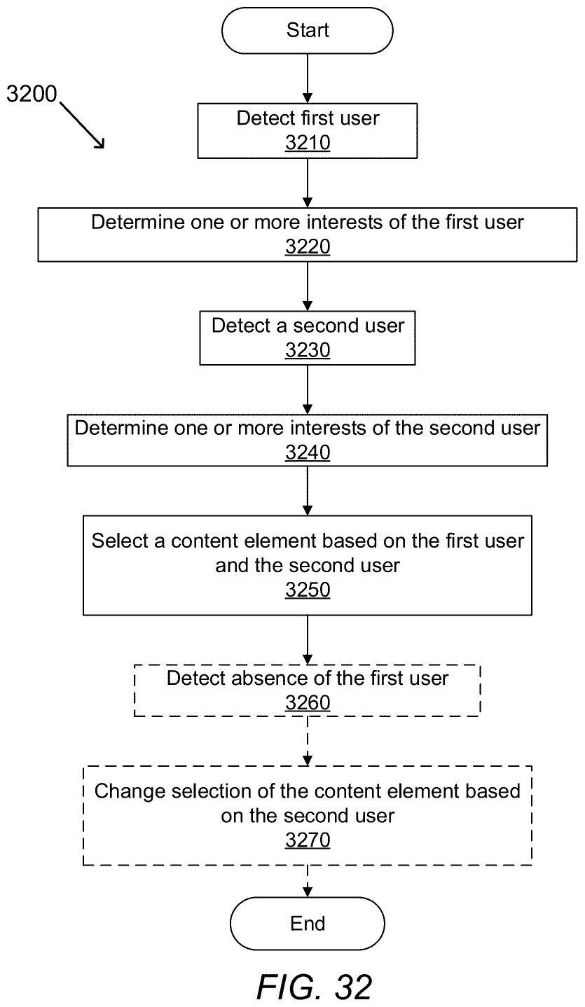

A process for the configuration of content based on an audience, performed in accordance with many embodiments, is illustrated in FIG. 32. Process 3200 detects (3210) a first user and associated information. In detecting (3210) the first user, process 3200 may generate a profile record (as described above). Process 3200 determines (3220) one or more interests of the first user. Determining (3220) the interests of the first user may be based on but is not limited to determining the foci of attention of the first user, as described below. Process 3200 detects (3230) a second user and associated information. Process 3200 determines (3240) one or more interests of the second user. Process 3200 selects (3250) (and/or configures) a content element based on the first user and the second user, and their associated recorded interests. In accordance with multiple embodiments of the invention, the content element may be displayed and/or played. Process 3200 optionally detects (3260) absence (that may be physical and/or attention-based) of the first user. This may correspond to the first user leaving the area. Process 3200 optionally changes (3270) selection of the content element based on the second user (i.e., exclusively) and/or the recorded interests associated with the second user.

While a specific process for curating content to multiple users is described above, any of a variety of processes may be utilized to configure content to audiences as appropriate to the requirements of specific applications. In multiple embodiments, steps may be executed and/or performed in any order and/or sequence not limited to the order and sequence shown and described. In some embodiments, some of the above steps may be executed and/or performed substantially simultaneously where appropriate or in parallel to reduce latency and processing times. In numerous embodiments, one or more of the above steps may be omitted.

In accordance with some embodiments of the invention, a subset of the incorporated media may be created at a very high resolution. A vetting mechanism for large-scale submissions may be used, wherein an automated, semi-automated and/or manual review of a submission is performed, e.g., based on size. A multiplicity of verifications may be performed, some of which are fully automated. Scale itself may distinguish a “manifestation” from phones and/or computer screens.

Aggregations of screens, domes, panoramas, and other experiential arrays may be created in areas set up as settings including but not limited to theaters, galleries, holodecks, headset arrays, screening rooms, sound baths, auditory spaces, interactive spaces, immersive spaces, lounges, etc. In such cases, the settings may be sized to host different scales and temporal signatures of NFT works. In several embodiments, printer rooms where dimensional works may be manifested as built objects may be used to create real-world representations of digital NFT objects.

Spaces like this, temporary or otherwise, may be gamified for different groups through coded designations of unique areas and AR. One example of a traditional gamification is Pokemon Go™. Multiple paths of play may accommodate multiple affinity groups in one space using AI and tracking to distribute players. An affinity group may be determined using clustering of user preferences and/or observed actions associated with users, where user preference data may be stored in wallets, and may include personal profile records, disclosed in co-pending U.S. patent application Ser. No. 18/067,579, titled “Systems and Methods for Robust Personalization with Applications to NFT Evolution and Generation of Art Remixes with Personalization,” filed Dec. 16, 2022, incorporated herein by reference in its entirety. Displays of content such as this are well suited for fairs and festivals, but may also be used in circumstances including but not limited to retail, dining, and affinity-based social spaces.

Such setups, temporary or otherwise, may serve as foundations for user interface interaction described herein and/or test beds for future technologies. For example, holography is an active technology that continues to emerge, and these NFT experiences described may serve as a test bed for product development.

A rendering of content performed in accordance with certain embodiments of the invention may be tied to work created over a specific period of time, e.g. a year. For example, an organization could create a competition and awards with voting by attendees and/or cumulative points accrued across that year, wherein attendants are detected by determining the presence of their cellular phones and/or other mobile devices equipped with radio transmitters, and facilitate the voting. In such cases, voting may be enabled by the user of that device and their wallets. In the example, voting may be done on one or more entries in the competition, e.g., enabling users to be shown one or more artworks visible from the physical location the user is in, and able to select one and indicate feedback including but not limited to a preference, a score, a vote and/or convey a text, an emoji, etc.

These votes and/or markups may be indicated to be private or public. When private they may therefore only be available to the organization(s) collecting the markups. When public, the markups may be indicated as publicly visible, allowing other users to point their phones to artwork and receive ranked lists of user markups, where the ranking may be generated in terms of factors including but not limited to the time of the markup generation, and/or the significance of the user leaving the markup comment as assessed by scoring mechanisms that may take historical markups and profile data into consideration. In many embodiments, sets of displays may be set up in environments including but not limited to a convention, festival, event, mall, entertainment park, museum, etc. The displays may include but are not limited to visual displays (such as monitors, strobes and colored lights, personal handheld devices, augmented reality glasses); audio displays (such as public speakers, personal headsets, mechatronic devices); and haptic displays (including fans and vibration engines).

The displays may be communicatively coupled with one or more sets of sensors, which may include microphones, motion sensors, touch-sensitive surfaces, circuit breakers, cameras, radio receivers/transmitters, etc. The displays and the sensors are further connected with one or more processors receiving signals from sensors and configuring outputs for displays; the processors may receive signals from mobile devices, e.g., via radio and/or infrared signals; these signals may convey identity, user preferences, previous locations of the user, etc. Using such data, the system generates profiles and renders information, such as NFT content, on one or more of the displays, based at least in part on the presence of users and/or their associated mobile devices.

Systems in accordance with miscellaneous embodiments may be automatically customized based on the presence of one or more users and/or profiles associated with the users. In one example situation, the estimated number of users present, as determined using one or more sensors, may be used to customize output, including but not limited audio output, light arrangement, the speed of an action such as the playing of a video clip, etc. For example, when there are only up to ten users in a given geographic area, the system may play peaceful music. When there are between 10 and 25 users, a soft drum is automatically added to the music. When there are more than 25 users, vocals are automatically added. The number of users present may be determined, e.g., by one or more motion sensors associated with an art installation; one or more radio receivers detecting distinct Bluetooth identities, a microcell used to convey cell phone traffic, where the microcell is configured to determine the number of connected devices at any time, etc. Optionally, GPS location sharing from users' devices may be sufficient in many cases to determine the number of users within close proximity.

In accordance with a number of embodiments of the invention, one or more profiles associated with users detected to be present may be used to configure the relevant systems. For example, the moment the headbanger gang of 25 people enters a given area, there may be an electric guitar solo added and/or emphasized; when a group of users with preferences for jazz music leaves, the trumpet solo dies out. The profiles may be determined in a multiplicity of ways, including but not limited to asking users to register their preferences and associate these with a device, e.g., a Bluetooth device identifier and/or an identifier associated with a SIM card; associating crypto wallets with devices and determining their contents; associating actions and presences of users over a period of time and associate events the users were present for with likely preferences of the users; identifying associations between two or more users, where a profile is established and/or known for at least one of the users, and associating the known profile with the users associated with the user of the known profile.

Systems in accordance with a few embodiments may configure parameters based on actions of users. For example, systems may determine whether users are likely to be dancing, given accelerometer data provided by an app of the users' mobile device, including but not limited to a phone, wearable computer, and/or radio-enabled wristband. Another action that may be detected may be the target of a device's sensors (e.g., what a phone camera is pointed to), provided access to such information from an app on the users' devices. This may be a determination of factors like whether the user is filming a person on the stage, taking a selfie photo and/or video, enabling the flashlight functionality of their phone, etc. User data can, additionally or alternatively, be determined with/without the interaction with mobile devices, e.g., by determining the movement data of one or more users, using camera footage to determine features including but not limited to emotions, the color of outfits, etc. User action data may be used to select and/or automatically configure the rendering of content, where example content may include but is not limited to audio content, visual content, and/or content related to the operation of actuators, e.g., for the operation of fans to create air circulation and the perception of wind.

Methods in accordance with some embodiments of the invention may be used to determine that one or more users view a publicly displayed artwork, which may correspond to an NFT, and/or to determine royalties to the content creator based on observed content. This may operate similarly to how other artists, e.g., video producers, are paid royalties for content that is being publicly accessible and played. One illustrative setting may include a mural and/or billboard in a subway station, and a number of sensors, such as cameras, to determine access. Here, access may correspond to users viewing the artwork. However, systems in accordance with some embodiments may consider it insufficient for passerby to gaze in the direction of the artwork at any one point in time with the brief gaze considered a countable access for which a royalty payment is made.

One way to determine that an artwork is viewed may be by determining consistent focus on a limited area over a period of time, such as for at least five seconds. This may require a stateful determination that identifies that a given user is watching an area no larger than a predefined size for a period of time that exceeds a threshold time. Additionally or alternatively, the determination may be based on determining the probability that a given area is being viewed based on directional detection of gaze, and/or on determining that a first viewer in a first location at a first time corresponds to a second viewer in a second location, that may be the same as the first location, at a second time. This determination may be based on an estimate of where a given user is looking, as a function of time, based on the location of one or more sensors, which may include but are not limited to cameras, and the images captured by these one or more sensors.

Another way to determine that the artwork is viewed may involve determining that a moving user appears to focus their view on an area of limited size as they move relative to the artwork. Thus, when there is user movement involved, the movement may contribute to determining likely foci of attention. Studies suggest that artists have different saccadic scanning behavior when viewing art than the baseline population. Systems in accordance with some embodiments may operate on the premise that it may be possible to detect differences in eye behavior and infer from this information what levels of connoisseurship the viewer possesses. This system may, additionally or alternatively, be used to determine whether a user is aware of warnings, allowing more visible signals to be conveyed to users who seem to be unaware of warnings.

The detection of attention may, additionally or alternatively, be used to determine conversions of advertisements, which may correspond to movies or images. Another way to determine that the artwork and/or advertisements have been viewed is by tracking the devices that pass near the artwork and monitoring those devices for subsequent web searches and similar device interaction (that suggests the artwork and/or advertisements had impact and/or produced a “conversion”). In accordance with multiple embodiments, conversions may result in (but are not limited to) royalty events for artists; payment from advertisers; and/or classifications of users.

In accordance with certain embodiments, the determination of focus may enable the measurement of the effectiveness of a given asset—such as a billboard that rotates through various images depending upon the destination of the train presently in the station. The billboard may, additionally or alternatively, be triggered based on the users' travel destination metadata (stored as GPS data) stored in the relevant wallets.

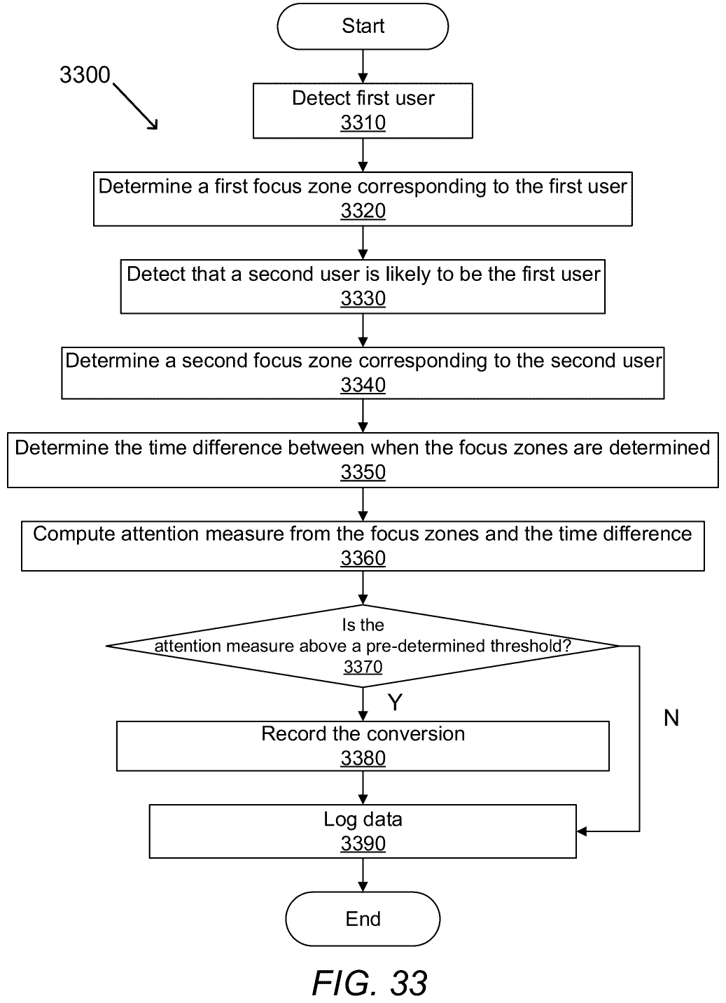

A process for the determination of user attention, performed in accordance with certain embodiments of the invention, is illustrated in FIG. 33. Process 3300 detects (3310) a first user and associated information. The information associated with users may be saved to user profiles, including but not limited to temporary information. Additionally or alternatively, process 3300 may generate a profile record that may correspond to a specific “session” of the user. Process 3300 determines (3320), a first focus zone corresponding to the first user. In accordance with multiple embodiments of the invention, focus zones may correspond to approximations of the area(s) of displays (and/or other surfaces) that the first user is looking at. These area(s) may be recorded in the profile corresponding to the first user. Process 3300 detects (3330) that a second user is likely to be the first user. In accordance with numerous embodiments of the invention, this assessment of likelihood may be established relative to a probability threshold. Process 3300 determines (3340) a second focus zone. In accordance with some embodiments, the second focus zone may be determined (3340) to be the same, substantially similar, and/or substantially different to the first focus zone. Additionally or alternatively, the second focus area may recorded in the profile associated with the first user (and/or second user for the sake of certainty). Process 3300 determines (3350) the time difference between the determination (3320) of the first focus zone and the determination (3340) of the second focus zone. Process 3300 may, additionally or alternatively, add the time difference to the user profile(s).

Process 3300 computes (3360) an attention measure from the focus zones and the time difference (and/or any other recorded information). For example, when the first focus zone overlaps with the second focus zone and the time difference is at least one second, then the system may determine that the user is paying attention to a visual element in the area associated with the first focus zone and the second focus zone. Additionally or alternatively, when the first focus zone corresponds to a first thematic element, the second focus zone corresponds to a second (associated) thematic element, and the first thematic element and the second thematic element are associated, systems configured in accordance with many embodiments may determine that the relevant user pays attention to a class of thematic elements that includes the first thematic element and the second thematic element (e.g., a class of butterflies). In such cases, systems may save a tag (representing the shared class) to the user profile(s) (e.g., on the assumption that the user is likely interested in butterflies).

Process 3300 compares (3370) the determined attention measure to at least one threshold. When the determined attention measure exceeds a threshold, process 3300 may, as suggested above, conclude that the user paid attention to the focus zone(s). In that case, process 3300 records (3380) a conversion. In accordance with several embodiments, conversions may result in (but are not limited to) royalty events for artists; payment from advertisers; and/or classifications of users (e.g., that the user is a butterfly enthusiast). Regardless of whether a conversion is recorded (3380), process 3300 generates (3390) a log entry logging the users' behavior during the “session.” Periodically, log entries may be generated (3390) and/or the profile records associated with users may be erased. For example, systems configured in accordance with a few embodiments may erase profile records as soon as the corresponding users are no longer detectable (e.g., by the sensor) and/or a predetermined period (e.g., half an hour) after the users are no longer detectable.

While a specific process for determining user attention is described above, any of a variety of processes may be utilized to monitor the attention of potential users as appropriate to the requirements of specific applications. In some embodiments, steps may be executed and/or performed in any order or sequence not limited to the order and sequence shown and described. In many embodiments, some of the above steps may be executed and/or performed substantially simultaneously where appropriate or in parallel to reduce latency and processing times. In various embodiments, one or more of the above steps may be omitted.

Artwork implemented in accordance with certain embodiments may have interactive quick-response codes and/or similar optical, audio, and/or wireless communication embedded. This may be done such that the artwork enables potential viewers, buyers, etc. to interact with whatever purpose the creators/promoters had in mind. One way in which to monitor subsequent events may be to trigger the execution of a process that determines such events, e.g., for a specified amount of time, and thereby generate profile data that in turn is used to convey selections of content.

For example, media wallets may exist within immersive art installations. Such art installations may possess default collections of “stock” media including but not limited to images, videos, sounds, and music. Detecting wallet-possessing users, installations configured in accordance with some embodiments of the invention may connect with the media wallet(s) using means disclosed below. Based on the media content of the media wallet(s), the installation may be configured to extract components of the corresponding media, and systems configured in accordance with numerous embodiments may use that media to create personalized displays. Images, video clips, sound(s), and/or music from the media wallets collection(s) may be used to replace and/or augment the default installation presentation. In the case of multiple media wallet-possessing users within the installation, various techniques disclosed and described in this document (such as those shown below) may be used to merge and arbitrate the final presentation, drawing media elements from the multiple media wallets present.

For example, in accordance with some embodiments, users might visit and pass through an installation in an enclosed environment (e.g., a cave) with projected images displayed in the background scenery. The users might possess a set of images of gemstones in their digital wallets. Using systems in accordance with multiple embodiments of the invention, the installation may retrieve information and data from the digital wallets, and the gemstone images contained therein may be showcased in the background of the cave installation. When the installation determines (e.g., via machine learning and/or other algorithms) that the users do not have appropriate content (e.g., under given policies) in their wallets, systems may project standard non-personalized stock versions of the experience.

In another example, users may take a ride with several preset projections. For instance, a Star Wars™-type ride where each journey is to a specific planet that is displayed in the movies. In accordance with some embodiment, once gaining access to the digital wallets, the ride system may be able to discern when there was any Star Wars™ material and further what episodes and/or specific collectibles the users own in their collections, thereby being able to determine which experience to send them on in the ride.

Another example may enable systems to airdrop NFTs to users who purchase tickets to a theme park. The NFTs may correspond to a particular ride representing (e.g., Star Wars prequel) content for the immersive experience as an attraction. Additionally or alternatively, NFTs may serve as tickets and/or timing spots to help organize traffic to certain attractions. Additionally or alternatively, NFTs may serve as keys to a game associated with the attraction (e.g., that users play while waiting in line to go to the attraction). Additionally or alternatively, NFTs may be sent to the users after they experienced the attraction as a sequel to the experience. They may be personalized and/or include elements of the story that the users may continue to engage with in a gamified method using the air-dropped NFTs.

In accordance with some embodiments, users may be gifted one or more NFTs. This may be done, e.g., as disclosed in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022, incorporated by reference in its entirety. In such cases, the gifting event may be associated with evolution, spawning and/or peeling. The gifted NFT may, additionally or alternatively, be in the form of a badge, as described below and disclosed in U.S. patent application Ser. No. 17/934,146, titled “Cryptographically Enabling Characteristic Assignment to Identities with Tokens, Token Validity Assessments and State Capture Processes,” filed Sep. 21, 2022, incorporated by reference in its entirety.

In accordance with numerous embodiments, badges may be provided to identify events and/or achievements including but not limited to visits to immersive experiences, as described above. The selection of the NFT content may be performed based on the registered experiences associated with users, including but not limited to what ride(s) the user(s) took. Additionally or alternatively, the selection of NFTs may be much more granular, and depend on what focus areas the users were associated with, as disclosed below. Thus, users found to be fond of butterflies may be gifted NFTs that relate to butterflies. The users may automatically be given the NFTs, by associating their devices and/or wallets with the observations, e.g., of an interest in butterflies.

Systems in accordance with various embodiments of the invention may supplement galleries and/or museums, where visitors may be given the ability to rent and/or borrow items (e.g., content placed in their media-chain wallets) for temporary periods. Additionally or alternatively, visitors with media-chain-enabled wallets may purchase mementos of their visit(s), that are tied to and derived from artwork that they found particularly moving. Multiple NFTs may be purchased during single museum/gallery visits. In such a museum and/or gallery, there would be no need to “exit through the gift shop,” and even no need for a gift shop, because the entire gallery could become the gift shop. Certain items might be offered only to users possessing a particular status, such as a museum subscriber and/or donor. This may be determined, e.g., based on identifiers associated with the users' mobile devices. Such identifiers may include but are not limited to hardware identifiers, wallet identifiers, public keys associated with users and their devices, and more.

Additionally or alternatively, media wallets may exist within media chain-enabled museum and/or gallery art exhibits. Detecting wallet-possessing users, the exhibits may connect with the media wallet(s) using means disclosed previously in this document. When users find pieces of art particularly moving, media-chain transactions may take place, wherein the user(s) may borrow, rent, and/or purchase the artwork (and/or any derivative work(s) based on that particular piece of art). In accordance with a number of embodiments, the media may then be transferred to the media wallets' media storage for a length of time. In the case of a purchase, that length of time may even be set to be indefinite. Certain items may be offered only to users possessing a particular status, including but not limited to museum subscribers and/or donors.

Additionally or alternatively, systems may incorporate display devices, including but not limited to museum-quality fine-art displays. Such displays may be configured to include wireless communications technology and/or sensors to detect the eye gaze direction of potential artwork viewers. The displays may involve sensors including but not limited to camera technology, time of flight infrared semiconductor sensors, and/or near-infrared semiconductor sensors, to make determinations including but not limited to where a variety of onlookers are looking (such as at a specific sword in a piece of artwork), how many are looking, for how long they look, etc. The systems may be able to communicate with the mobile wallets of users (when permitted by privacy settings), blockchain networks, centralized data handling facilities (e.g., decentralized network oracles), and/or royalty accounting systems. Such systems may, additionally or alternatively, display items from an onlooker's wallet, when permitted.

Other examples of public media hardware devices used in accordance with various embodiments may include digital billboards and other advertising displays. Systems in accordance with some embodiments may present from standard sets of advertisements until media wallets are detected in close proximity. Once at least one wallet is detected, the displayed content could be tailored to the particular wallet owner(s), with content coming from their own collection. In accordance with multiple embodiments, the paid advertising may still be in included (e.g., in a “Picture in Picture” style). Such systems may carry the ability to avoid advertisements by paying a fee (e.g., a premium membership).

Existing technology is limited by the lack of ability to identify/distinguish two or more. The determination of identity and/or pseudonym in some contexts may be necessary to create a consistent experience, wherein logically consecutive content portions are presented in a manner that takes into consideration what a user has previously been exposed to. One approach to address this need may involve equipping a space with cameras, where the cameras are not identifying users but only determining that two observations of users correspond to the same person. Such determinations may be based on but are not limited to facial features, outfits, body sizes, belongings, configurations of users, etc.

In accordance with some embodiments, systems may use matrices of Bluetooth Low Energy (BLE) radios that detect a radio associated with at least one user device and/or convey at least one location to the radio and its associated mobile device(s). The mobile devices may further convey the information to a backend, e.g., of the system(s) wishing to locate the user(s). Using backscatter techniques, unpowered BLE transmitters incorporated in accordance with many embodiments may convey signals including user identities to nearby devices, and/or receive signals from a nearby device and/or convey them to backends by propagating them over mesh networks made up of the matrices of nearby BLE enabled devices. Mobile devices may communicate with the backend using modes including but not limited to Wi-Fi, cellular connections such as 5G, and/or on-demand routing using the mesh of mobile nodes of which the user cellular phone is one node; the latter may be done as disclosed in Secure COMM 2006 publication: “Discount Anonymous On Demand Routing for Mobile Ad hoc Networks” by Liu Yang, Markus Jakobsson, and Susanne Wetzel, incorporated by reference in its entirety, and/or using related overlay communication structures.

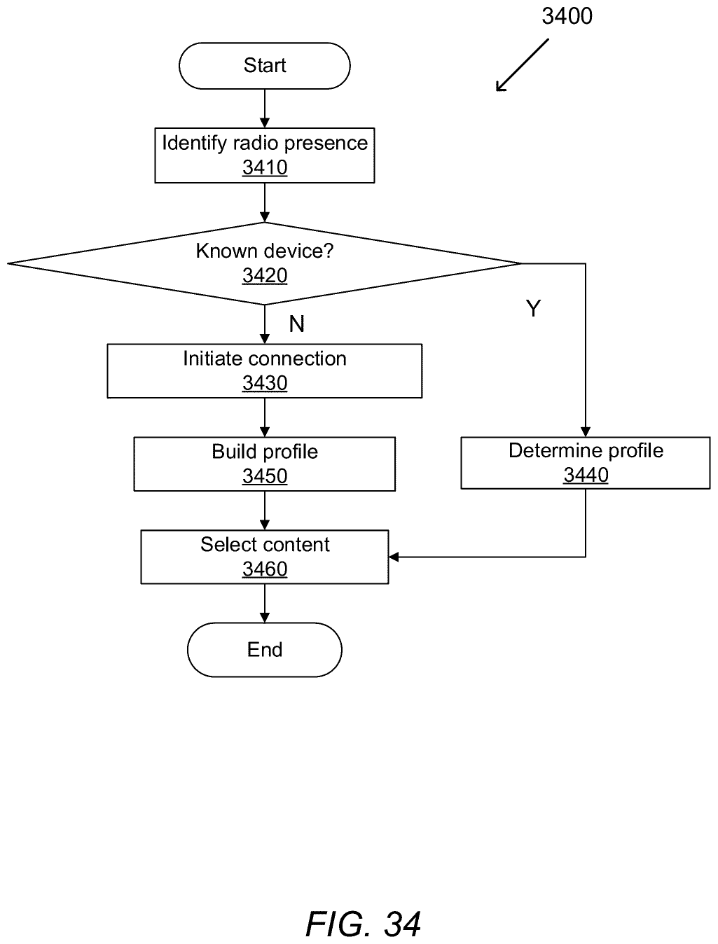

A process for radio identification of users, performed in accordance with several embodiments of the invention, is illustrated in FIG. 34. Process 3400 identifies (3410) a radio presence of a device. This may be based on detecting signals including but not limited to Wi-Fi signals, Bluetooth signals, Bluetooth Low Energy (BLE) signals, etc. (Non-limiting) example techniques associated with the identification of devices are disclosed in U.S. Pat. No. 10,993,082, titled “Methods and apparatus for device location services,” issued Apr. 27, 2021. Process 3400 determines (3420) whether the detected device is a known device. When the detected device is a known device, process 3400 determines (3440) the profile based on the known device.

When the detected device is not a known device, process 3400 initiates (3430) a connection and, optionally, may request a user to share data. Process 3400 builds (3450) a profile that may include but is not limited to information related to the (known) detected device and/or associated user. In accordance with some embodiments of the invention, some user profile information may be determined by characterizing the detected device (e.g., type and model). Additionally or alternatively, certain user profile information may be determined using camera(s) that identify the users and/or associated features.

Process 3400 selects (3460) content based on the profile of the detected device and associated user. In accordance with multiple embodiments of the invention, the content may be displayed and/or played.

While a specific process for identifying users is described above, any of a variety of processes may be utilized to perform radio identification as appropriate to the requirements of specific applications. In some embodiments, steps may be executed and/or performed in any order or sequence not limited to the order and sequence shown and described. In numerous embodiments, some of the above steps may be executed and/or performed substantially simultaneously where appropriate or in parallel to reduce latency and processing times. In several embodiments, one or more of the above steps may be omitted.

In accordance with a number of embodiments of the invention, one or more determinations of focus areas may be determined for one or more users. Additionally or alternatively focus areas may be used for associated actions taken based on these determinations. For example, an artist may condition the rendering of content on what an observer may be believed to have seen already, to tell a personalized story based on estimated impressions. This relates to the idea of artworks that are created with temporal progression in factors including but not limited to mind, sequence, plot, linear composition, etc. For example, viewers may want to know that they are viewing chapter 3, not chapter 1 of a book, and/or that the displayed work is a visual prequel not a sequel to another artwork. Such information may be conveyed to the users in the media relative to the particular viewer. One way of conveying this data to the users may be badging systems and/or text overlays that transparently appear on the relevant media assets and/or disappear once enough time has passed for the users to read.

When the work presented is evolutionary, and/or part of a sequence, the viewers may want to know that other units exist in the sequence and/or where this particular work sits within its evolution and/or sequence. Such information may be conveyed to the users, e.g., as metadata, as captions, in response to a request from a user device for more information, along with a rendered copy on a mobile device. Additionally or alternatively, users may be given the option to create markups of art pieces, where one example markup may be a comment and another may be a vote for the markup (as described above). By making information available regarding potential the other stages of evolution, and/or regarding sequence information that may be made available for viewing, then this presents richer opportunities to interact with content.

One example may be for viewers to learn more about related art pieces, the provenance of art pieces, and/or for the users to be able to purchase content. The availability to the users enables such a system to convey progressions of content to users, determine based on user wallet content whether given users may be prone to collecting and/or viewing sequential work, and determine, using automated methods, whether users are likely to be (presently and/or in the future) interested in seeing other works and/or stages within this sequence. Such determinations may, additionally or alternatively, be performed using machine learning (ML) methods.

In one example use, a series of frames may be rendered, where these constitute an animated sequence. Each one of these frames may be a work on its own. Users may wish to know whether they are looking at frame 75 or frame 4.

In another example use, a progressive work may be shown, like a tree that keeps growing whenever observed. The viewing users may want to know how long it had been growing and possibly view earlier stages, which might be cached in the wallets of other users having viewed the art piece. Some users may wish to message other users having viewed the art piece, and/or a subset of these, e.g., based on the time of viewing, whether the users may be still physically present, and whether the users left any comment, e.g., in the form of a markup.

Users may identify art pieces to generate markups by taking photos of the location of the rendered art piece, of a representative of the art piece, of a QR code associated with the art piece, etc. Users may, additionally or alternatively, indicate, when viewing an Augmented Reality (AR) and/or Mixed Reality (MR) art piece that they wish to add a markup. This markup may be added, for example, by providing an input to the AR/MR rendering headset, where this input may be a voice command and/or an input on a mobile device paired with the AR/MR rendering headset.

In accordance with some embodiments, word stories may be used to indicate linear, plot-based structure. A work of art including multiple associated elements may be associated with a story; however, not all works of art with multiple elements need be associated with a story. Stories may be associated with a concentric relationship to a common binding theme. Such themes could be based on subject, style, and/or an underlying intellectual idea. Stories may be told, e.g., using evolution. Users who like a story may be more interested in one element of the story than another (e.g., the climax, a twist). The determination of what part of a story users may be interested in may be performed through means including but not limited to automated analysis of markups, determining how much time users spend observing various elements of the story, etc.

In one example usage scenario, systems in accordance with some embodiments may be used to generate a display venue, like a panorama and/or multi-screen theater. The display venue may recognize the specific participants who have entered, and/or create performances out of a blend of their personally owned works of art, as determined by the contents of their wallets, the profiles associated with the users, the experiences the system has determined to be associated with the users (e.g., location), etc. This may result in works that may be singled out by the users for public display before this moment, so that when the users enter the space (randomly, as a pre-planned group, etc.) they may see montages that represent both their personal and group identity.

In some embodiments, the presentation/manifestation may not be pre-planned by the users. Additionally or alternatively, users may predetermine only the content which they have permitted to be made public. In this way, the actual manifestation may depend on the participants, who are detected (e.g., using the associated identifiers of their mobile devices, and/or using face recognition technology). The performance may therefore be a complete surprise to the group. They may self-select themselves as an affinity group to enter the theater, without knowing what they're going to see, hear, and/or experience, beyond that it may be a reflection of their community identity. The sense of story in this case may be not a linear unfolding of a plot about a third person, but rather the implicit story of this group of people (e.g., the revelation of the binding themes that make them who they are revealed through the artwork they have chosen to submit into this structured collaged presentation).

In accordance with several embodiments, users of such groups may be offered the opportunity to purchase NFTs based on the presentation, e.g., as a derived work based on the profiles and wallet contents of the users. The NFTs may include information related to the contexts from which it was developed, including but not limited to when it was created, on what users and their associated information it was based, etc. The various public and private displays of NFTs and/or their corresponding assets described in the various embodiments of this disclosure may enable the opportunity to resell, spawn, evolve, advertise, transfer, etc., a given NFT.

Systems and methods in accordance with multiple embodiments of the invention, may not be limited in terms of applications to publicly viewable content. They may additionally or alternatively, be used to improve the functionality of viewing content in private spaces, such as the viewing, by one or more people, of a movie and/or a game on a TV in a home. In such cases, it may be determined what different users appear interested in, based on focus areas; and/or the extent to which the different users are engaged, as expressed by their focus shifting in a manner consistent with the developments of the content being viewed.

Such systems may be used to determine the preferences, including but not limited to commercial interests, of the viewers. Based on determinations of preferences, the system may select and/or customize content for one or more users to maximize their likely appreciation. Other quantifiable actions may be maximized, like the probability of conversion for advertisements. Additionally or alternatively, the payments of the advertisers may be calculated based on the estimated interests (and/or attention) of the one or more viewers, and the attention the viewers paid to an advertisement. The selection of the advertisement may be performed based on assessments of interests and attention, e.g., showing beer commercials to users whose interests appear aligned with those of typical drink-loving viewers.

Systems in accordance with certain embodiments may involve frameworks for making NFTs of products from a sponsor and turning them into a collectible that users may collect, play alter and/or share. These digital assets stored on the blockchain may be airdropped to users and/or earned as rewards. An example of this may be a game where you need a wrench to get to the next level. A hardware company that sells real wrenches in the real world may create N editions of a virtual NFT wrench and air-drop them to users playing the game as a way of sponsorship. The users may be tasked to get these wrenches in order to win the game. It may be possible for the users to combine the items they got with other tokens won throughout the game, to spawn another item (e.g., a super wrench) that accelerates their progress in the game.

Methods in accordance with numerous embodiments may enable the creation of reactive art, art that changes based on being viewed. For example, it may be determined based on users' views of an art piece (for example, in public, on a laptop screen) that the users observed a given first aspect of the art piece, but likely not a second aspect. The artist may have determined that when the first aspect is viewed, this causes portions of the content in the periphery of the first aspect to vanish, be replaced, change color, and/or change other visual appearance. Meanwhile, when the second aspect is being viewed, the content associated with the second aspect may gradually fade away and be removed, only to appear later in a different part of the art piece.

Methods in accordance with multiple embodiments may involve the triggering of evolutionary changes of artwork based on one or more criteria associated with the artwork being viewed. For example, an artwork that is being watched by at least 100 distinct people every day for at least a week may automatically modify itself, e.g., evolve. Technology to support evolution may be disclosed in co-pending U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical users Interface for Complex Token Development and Simulation,” filed Sep. 6, 2022; and U.S. patent application Ser. No. 18/045,400, titled “Cryptographic Content Co-Creation Mechanisms and Linking Physical Elements to Cryptographic Elements,” filed Oct. 10, 2022, incorporated by reference in their entireties.

Another artwork may modify temporarily when watched by a first person but not a second person also present, changing back when watched by the second person. For example, the artwork may include an image of a ghost when viewed by the first person and not when viewed by the second person. These “conditional” modifications and evolutions may be triggered by the content of nearby wallets that are communicating individual preferences.

The determination of focus, interests, attention, etc., may be done in a manner that is privacy-preserving. For example, the entity that performs the determination that users are paying attention may generate a profile for each user and maintain each such profiles for a limited time. Additionally or alternatively, during this time, the profiles may be associated with one or more descriptors associated with the observations of the user. For example, such descriptors may be “adult male”, “happy”, “interested in birds”, “paid attention to commercial #1”, “did not pay attention to commercial #2”. Later on, the profiles may be removed. The same users may be observed again, and new profiles built, this time with descriptors “adult male”, “sleepy”, “paying attention to dogs”, “very interested in commercial #4”.

Some descriptors may be communicated to service providers that select and/or generate content based on the descriptors. Such content requests may be communicated in anonymized manners, where the anonymization may be of the requested content; of the client device making the request; of a combination of such, etc. Methods for such anonymization techniques are disclosed in co-pending U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical users Interface for Complex Token Development and Simulation,” filed Sep. 6, 2022, incorporated by reference in its entirety.

Applications and methods in accordance with certain embodiments of the invention are not limited to use within NFT platforms. Accordingly, it should be appreciated that the capabilities of any immersive configurations described herein may also be implemented outside the context of an NFT platform network architecture unrelated to the storage of fungible tokens and/or NFTs. Moreover, any of the analysis processes described herein with reference to FIGS. 32-34 (including content configuration, user attention determination, and/or radio identification) may be utilized within any of the systems implemented within the NFT platforms described above.

### Identity Assurance System

### A. Identity Tokens

Systems and methods configured in accordance with certain embodiments of the invention may allow individuals to protect their likenesses, identities, and/or privacy from abuse including but not limited to impersonation. As mentioned above, in accordance with some embodiments of the invention, users including but not limited to natural persons, corporations, and/or groups of individuals and organizations, may be associated with identity tokens. The uses of identity tokens are described above and disclosed more thoroughly in U.S. patent application Ser. No. 17/808,264, titled “Systems and Methods for Token Creation and Management,” filed Jun. 22, 2022, incorporated by reference in its entirety.

The identity tokens may, additionally or alternatively, be tied to various additional elements (including but not limited to media elements) to assert relationships between the elements and the users associated with the identity tokens. Potential media elements include but are not limited to movies, text files, songs, voice files, and messages. As such, the corresponding identity tokens may identify users including but not limited to actors, writers, singers, speakers, and messengers.

In accordance with multiple embodiments of the invention, (including but not limited to media) elements may convey information that is associated with particular messages. Additionally or alternatively, elements may be associated with a manner of conveying the messages, such as characteristics including but not limited to appearance, manner of speaking, manner of moving, way of expressing opinions, choice of words, dialect, facial expression, personality, etc. Specifically, systems and methods in accordance with some embodiments may operate based on the premise that the manner of conveying a message is typically what people use to determine the individual(s) that conveyed the message (and/or traits about the individuals, including but not limited to whether they are earnest, interested, kind, etc.).

Additionally or alternatively, systems in accordance with many embodiments may be used to determine message authenticity. Here, a message may be deemed authentic when (intended to be) conveyed by the user(s) that are determined by the systems to be the conveyors of the messages, including but not limited to the speaker in a movie.

Systems and methods configured in accordance with certain embodiments of the invention, users may incorporate various anchor elements. Anchor elements may refer to elements that verifiers may determine (with predetermined levels of certainty) to be associated directly with the individual users. In doing so, systems may associate anchor elements (including but not limited to email accounts, social media accounts, employee accounts) to public keys for which the users may control the corresponding private key(s). Anchor elements may thereby include reference(s) to the public key(s). Additionally or alternatively, the anchor element(s) may be asserted through cryptographic authentication through means including but not limited to, digitally signing the anchor element(s) using the private key(s).

For example, verifiers may determine with reasonable certainty that a social media account of an influencer represents the influencer; therefore, a public key that is associated with the social media account may be understood to belong to the influencer. In such an example, the influencer may then use the social media account to assert that the public key belongs to them through means including but not limited to including it in a post, including it in the social media profile, referencing it in a manner that indicates an association, etc.

Another type of anchor is an anchor token, as disclosed in U.S. patent application Ser. No. 17/808,264, titled “Systems and Methods for Token Creation and Management,” filed Jun. 22, 2022, incorporated by reference in its entirety. Anchor tokens, as described above, may describe tokens (such as NFTs) that are intrinsically associated with one or more entities. For example, like identity tokens, anchor tokens may be associated with the user(s) whose biometrics and/or other authentication information enables control relative to the tokens. Anchor tokens may be associated with public keys through means including but not limited to including the public keys in the tokens, referencing the tokens, and/or linking the public keys to the tokens (including but not limited to cryptographic authentication of the user and/or of trusted third parties such as certificate authorities).

The association of anchor elements to public key(s) may enable the use of the corresponding private key(s) to make publicly verifiable assertions of identity (that may be tied to the anchor elements). These assertions may be in the form of digital signatures, zero-knowledge proofs, message authentication codes (including but not limited to using symmetric keys that are established using key establishment protocols using the public key and private key that is associated with the anchor element), and other manners of cryptographic authentication.

Assertions of the type described above may be referred to as identity proofs in this disclosure. Identity proofs may be positive or negative. A positive identity proof may be a claim that a given element and/or action is associated with the anchor element, whereas a negative proof may be a claim that it is not. The absence of a positive identity proof may, in some embodiments and usage scenarios, be used to infer that a given element and/or action is not associated with an anchor element, and in some embodiments and usage scenarios, the absence of a negative identity proof may be interpreted as an indication that the element is associated with the anchor element. Such absence-based determinations may have lower certainty than determinations that are based on the presence of proofs, whether positive and/or negative. A negative proof may, additionally or alternatively, be referred to as a repudiation.

In accordance with certain embodiments, positive identity proofs may include but are not limited to digital signatures of parties, one or more digital certificates associated with the public key(s) of the parties, references to data files (including but not limited to media files), and, optionally, assertions identifying one or more aspects of the media and/or data files (including but not limited to audio-only, selected audio components only, a portion of a visual component, etc.). For example, a party may generate and distribute a positive identity proof related to his and/or her presence in a movie, along the lines of “from the time stamp 1:04:12 to 1:04:26, upper right quadrant, this corresponds to the user with identity X”, where X may correspond to a public key and/or another unique identifier, which is associated with the identity of the party generating the proof. A party may, additionally or alternatively, generate and distribute a positive identity proof related to somebody else's presence in a media file, for example “from time stamp 0:32 to 0:49, the audio clip corresponding to the utterance ‘this is the best place for okonomiyaki’, corresponds to a user with identity Y”, where Y may be a public key and/or other identifier, and where the party generating the proof provides an assurance that this is Y. Such proofs may be associated with a reputation score indicating the trustworthiness of the prover, which may include one or more endorsements, a score indicating the rate of complaints, a reference to a bond that parties may obtain payment from when they file a complaint that becomes adjudicated in their favor, etc. Such scores may, additionally or alternatively, be part of a positive proof that refers to the user that generates the proof.

Similarly, negative proofs may relate to the identity of the prover and/or another party. In the former case, this would correspond to a statement such as “this is not me”, and/or “it is me, but I did not say what it seems I said”, “this is me and my voice, but I am taken out of context”, etc. Similar to positive proofs, the negative proofs may identify a portion of the file, and/or an aspect of it. They may be associated with one or more reputation scores.

In accordance with some embodiments, negative proofs may include (but are not limited to) zero-knowledge proofs, whether interactive or non-interactive. Traditionally, a zero-knowledge proof may be used to prove a positive statement (for example, “I am this person”, which may be expressed as “I have access to the private key associated with this particular public key”). A negative proof may be a proof that (a) may be verified to be correct, and (b) shows that a given property (such as “I am this person”) does not hold. In various embodiments, that may be achieved by a verifier receiving encrypted representations of a positive statement (for example, “I am X”), and where the verifier re-encrypts these representations, then generates separate encrypted representations (for example “I am Y”) of the statement to be proven the negative of. In certain embodiments, ElGamal encryption may be used. All of the ciphertexts, both those generated by the provers and those generated by the verifiers, may be generated using public keys (e.g., that the prover and/or the verifier doesn't have the corresponding private key for). For example, the public key may be a combination of the public keys of the prover and the verifier, as obtained using a Diffie-Hellman key exchange related to the keys of the prover and the verifier. Systems in accordance with certain embodiments may refer to the ciphertexts related to Y as the “inverted” ciphertexts.

In some embodiments, re-encrypted ciphertexts and/or inverted ciphertexts may be ordered in a random manner and provided to the prover. These ciphertexts may be indistinguishable from each other by the prover, since the prover cannot decrypt them. However, the prover may perform proofs on all of the ciphertexts, related to the supposed contents of each one being “I am X”, relative to the private key of entity X. This means that the proofs related to the ciphertexts that are indeed related to the statement about X will succeed (assuming the prover does not cheat, in which case they will fail) whereas the proofs related to the ciphertexts related to the statements about Y will fail. The prover does not know which ones will fail and which ones will succeed, but the verifier may determine this. When the verifier determines that all proofs related to X succeed, and/or all the proofs related to Y fail, then the verifier will conclude that the prover did not cheat, and that the prover did not use the key corresponding to Y, but the key corresponding to X. Here, X is not disclosed in plaintext, but it must be different from Y.

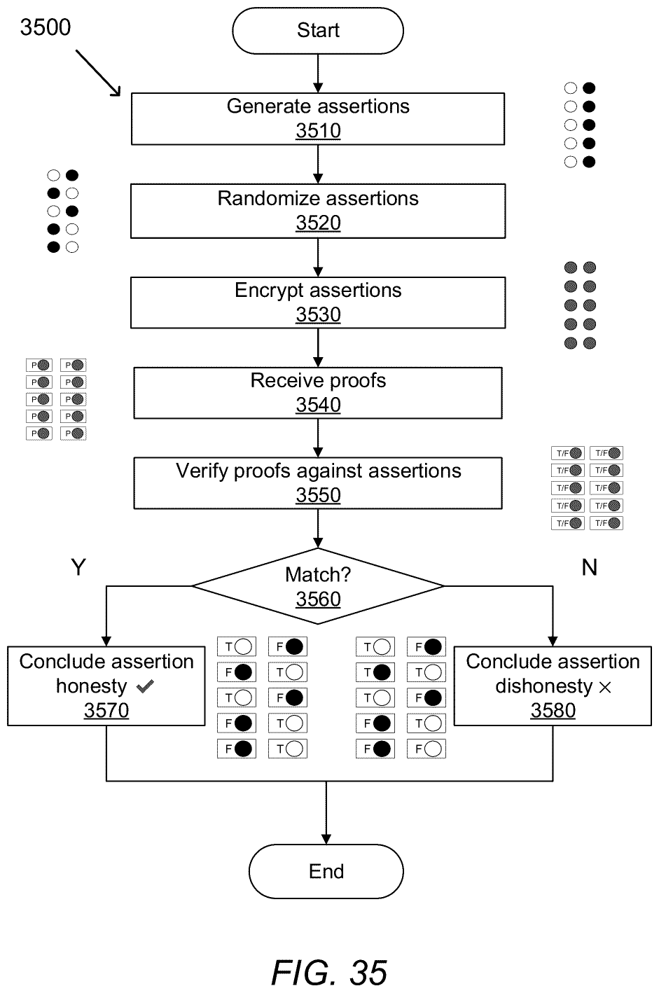

An encrypted identity proving scheme, performed in accordance with several embodiments of the invention, is illustrated in FIG. 35. Process 3500 may be performed by entities including but not limited to verifiers. Process 3500 generates (3510) one or more assertions and/or statements. The following description, corresponding to FIG., will describe process 3500 in relation to a collection of assertions, but the process 3500 applies equally to (collections of) statements and/or individual assertions. Further, FIG. 35 illustrates an instance where a collection of assertions are generated (3510). Collections of assertions may include assertions that hold (for a prover), and assertions that do not. FIG. 35 illustrates a collection of assertions, some of which hold and are indicated by a white circle, other assertions that do not hold and are indicated by a black circle. Process 3500 randomizes (3520) the assertions.

Process 3500 encrypts (3530) (each of) the assertions in the collection of assertions, producing a collection of encrypted assertions. Through this, the prover may be prevented from determining which assertion(s) holds and which does not. In accordance with some embodiments of the invention, randomization (3520) and encryption (3530) may be reversed in the process 3500 without affecting the encrypted identity proving scheme. Encrypted assertions are indicated in FIG. 35 by gray circles.

Process 3500 receives (3540) proofs, which may be constructed by the prover for (each of) the encrypted assertions. In FIG. 35, proofs for encrypted assertions are indicated by gray circles surrounded by white rectangles containing a letter P.

Process 3500 verifies (3550) each proof against each encrypted assertion. In verifying (3550) proofs, process 3500 produces proof outcomes of True (indicated by T) or False (indicated by F) in each case. After verification, each proof outcome is compared with the corresponding (unencrypted) assertions. Process 3500 determines (3560) whether a truth of each assertion matches a truth of the corresponding proof outcome. In doing so, when all the proof outcomes match/are correct, process 3500 concludes (3570) that the proof(s) pass and the honesty of the prover is verified. Additionally or alternatively, when a(t least one) truth of an assertion does not match, process 3500 concludes (3580) that the proof(s) fail, and that the prover was dishonest.

While specific processes for verifying proofs are described above, any of a variety of processes may be utilized for verification as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

The assertions that associate anchor elements with public keys may be repeated. In such cases, multiple public keys may be simultaneously associated with an anchor element, where an element may be associated with first one and then another public key that replaces the first public key. Certainty scores may be associated with given assertions. This may be based on risk-related events that are determined to be associated with a given anchor element. For example, a likely account take-over of a social media account, based on anomalous activity, may indicate a lower certainty score of an assertion taking place after the identified risk event. A higher certainty score may be inferred when a trusted third party such as a certificate authority and/or a government entity such as the DMV, digitally signs an assertion. Thus, a media file may be associated with one or more proofs, some of which may be positive and others which may be negative, and corresponding to disparate and/or overlapping segments of the media file.

In some instances, users may depend on multiple anchor elements to tie a public key to the two or more anchor elements. In some cases, the assertions that associate the public key may each be associated with a certainty score. By assessing multiple certainty scores, an aggregate certainty score may be generated, where the aggregate certainty score is a combination of the individual certainty scores, and where the combination may be computed using an AI, machine learning components, a maximum-likelihood filter, a set of heuristics and/or other rules, and/or a combination of such methods. Typically, the aggregate certainty score would be higher than the individual certainty score. Input certainty scores may be weighted using knowledge of events such as events about breaches, observations of anomalies, etc.

Proofs, whether positive and/or negative, may be evaluated along with the assertion(s) that associate(s) it to the anchor element(s), and their certainty score(s), resulting in a trust score. In a situation where there are multiple proofs, these may be assessed together to determine a trust score. Some of the proofs may be positive whereas others may be negative. The trust score is determined by assessing these and their associated certainty scores, using similar techniques as which may be used to determine an aggregate certainty score from multiple input certainty scores. The resulting trust score is compared to a threshold value, and a security action is taken.

### B. Security Actions

Depending on the configuration of the computational unit performing the security action, different actions may be taken. Example actions may include but are not limited to blocking a transaction, blocking the presentation of a message and/or a media element, marking up a media element with a warning, an endorsement, a notification, reporting media content to an admin associated with the user receiving the media, reporting media content to an entity associated with the media content and/or appearing to be associated with the media content, and the modification of one or more weights used to compute scores, as described above. These weights may relate to an AI, an ML component, a heuristic function, and/or another algorithm generating a score from one or more inputs. Multiple security actions may be taken, based on the computed scores, the media content being processed, and policies associated with the users associated with and/or appearing to be associated with the media. For example, media content may be marked up with a warning and/or blocked, and at the same time, a report may be generated to the apparent user associated with the media. In some instances, reporting is done to support royalty collection.

In accordance with multiple embodiments, proofs may be generated, conveyed and presented in a multiplicity of ways. In one usage scenario, a proof may be a digital signature associated with a media file, where the digital signature is verified on the media file and the public key that has been anchored to the identity associated with the media. There may be multiple digital signatures from different users, for instance, when the media includes content related to these multiple different users and each one of them generates (positive and/or negative) proofs related to the media content. The proofs may be relative to the entire media and/or only to portions of it. The digital signatures may be related to the entire media content to ascertain that there are no modifications to any of the media content, and at the same time, the proof (related to the identity claim) may be specific to only some portions (including but not limited to periods, screen parts, and/or aspects of the media—for example only video and audio but not subtitles) of the media content.

In another usage scenario, which may be in the same embodiments as the above usage scenario, a proof is interactive and corresponds to a protocol between a verifier and one or more provers. The verifier contacts a prover and conveys media and/or a reference to the media. The prover makes a determination and conveys a proof to the verifier. The proof may include a digital signature, as above, and/or simply an authenticated response, where the response indicates a positive and/or negative indication, along with optional limitations. The response may, for example, signal that the first 25 seconds of a media file correspond to a positive proof relative to the prover (which represents one or more users, indicated in the proof) while the remaining 15 seconds are negative. The prover may, additionally or alternatively, indicate a no-opinion proof in which a portion is declared to be neither positive nor negative. This may be a media portion that the prover cannot determine the authenticity of, for example.

In some embodiments of the above usage scenario, communication between the verifiers and the provers may be conducted through proxies (that may be trusted by the verifiers). For example, a verifier may transmit proof requests to a prover, and the prover may provide a response via proxy, which may redact some or all of the response, and may append an assessment of a validity of the proof, thus providing the verifier with an assessment of the validity of the proof without revealing sensitive information provided by the prover. In multiple embodiments, the proxy may be automated, for example, it may include an AI component, Machine Learning (ML) component, and/or algorithm and/or function for redacting the response and assessing the validity of the response.

Additional responses may mandate that automated determination methods associated with the prover cannot make a determination, and additional scrutiny may be required. The interactive proofs may either be tied to a session (for instance, the session in which the query is made) and/or to the media content. In the former case, the proofs may not be possible to associate, by a third party verifier, with the media content, but would require this third party verifier to contact the prover(s) anew. In the latter case, the proof may be delivered along with the media content to a third party verifier which may then verify the proofs relative to the media content. The tying of proofs to sessions and/or media content may be done by referencing the session number and/or a cryptographic hash of the media content in the proof. By using a so-called designated verifier proof, proofs may be made non-transferable as well. Making proofs non-transferable, i.e., not verifiable by a third party verifier without further interaction with a prover, enables control over who may verify content, and may be used to enable subscriptions, royalty payment collections, methods to trace distribution of media content, etc., by forcing each verifier to interact with the prover(s).

In order to receive a response to the request for a proof, verifiers may need to pass an authorization step. Authorization may involve paying a fee, having identity information recorded and/or stored in encrypted format in an escrow facility, having to provide evidence of a secure computational environment, etc. In accordance with some embodiments, verifiers may provide evidence of a secure computational environment, including but not limited to certificates indicating a trusted execution environment (TEE), validation information indicating an approved digital rights management (DRM) software environment, pass a software-based attestation verification, and/or provide information indicating that the computation environment is patched with respect to operating system version, browser version, anti-virus type and version, etc.

In several embodiments, homomorphic encryption may be used to provide a proof schema enabling a prover to provide a proof to a validator. In the proof schema, a prover and a validator may establish a sequence of actions, for example, an application of an algorithm, an arithmetic operation, and/or a function and/or sequence of functions over a secure channel, with the actions selected remaining homomorphic across the encryption scheme. Through this, aspects of the proof may be concealed from the prover, and aspects of a request from the validator to the prover may, additionally or alternatively, be concealed.

In many embodiments, the provers may provide, in addition to proofs as described above, one or more keys that enable the decryption of media content and/or keys governing access to media content. The proofs as well as the keys may be transmitted over secure channels, where a secure channel is an encrypted and authenticated communication link such as what may be obtained by use of Transport Layer Security (TLS) and/or Secure Sockets Layer (SSL).

Proof results may be conveyed to users from computational processes associated with the above-described verifier in a multiplicity of manners. For example, when the media content is an audio recording, this may be modified to indicate the verification result. For example, a recording with a negative proof associated with it may be blocked from playback and/or be played with a warning being inserted every ten seconds. The warning may clarify that the content has been identified as not authentic. In addition, a red LED may be lit on a device associated with the speaker used to play the audio. When the audio is played on a phone, the screen of the phone may display a warning identifying that the content received a negative indication, and therefore, its authenticity is disputed. A positive proof for audio content may be indicated by a green LED being lit during the playback, and/or by rendering information regarding the positive proof, such as “The indicated originator certifies that this is authentic.”

Similarly, audiovisual content may be associated with warnings, notices and/or endorsements, where one type of endorsement is an indication of the identity of the verified prover and associated user. This indication may include an image representing this party, including but not limited to a bank logo, a photo representing a person, a name, contact information and/or potential clickable links that enable the rendering of additional information. In some embodiments, a combination of trust scores, proof assessments and subject matter context may be interpreted by an AI and converted into a short meaningful sentence in a human language such as English.

The user devices used to render such information may, in accordance with various embodiments, be secured. Securing may make it impossible for an attacker to cause the rendering of information that is the same and/or very similar to the information used for endorsements. This may correspond to running in circumstances including but not limited to: a TEE, a DRM, having been verified not to have malware, being of a pre-specified type of device, having no anomaly associated with it detected by the prover, where such an anomaly may be a higher-than-reasonable number of requests during a given time interval. In certain embodiments, the manner in which one or more positive and/or negative proofs are processed and used for security action may be governed by a configuration provided by the user associated with the device used for the rendering and/or playback, and/or an admin associated with such a person and/or device.

The verifiers used in accordance with some embodiments, may be associated with wallets, which may be executed at least in part on devices including but not limited to a special-purpose device, on a smartphone, on a wearable device such as an Apple™ watch, a headset, smart glasses, a TV, a monitor, a speaker system, an appliance, a home computer, an ATM and/or other financial technology device, and more.

Verifiers in accordance with many embodiments may automatically determine whether a media element has an associated proof. Additionally or alternatively, when not, they may determine whether the media element appears associated with a given originator. For example, a movie appears to be associated with one or more people when it includes clips of people with a sufficient likeness to these people. Here, “sufficient” may correspond to a higher degree of likeness than a given threshold, and/or a likeness that results in a match score exceeding a threshold value. Similarly, an audio file is said to have sufficient likeness when the audio file has a voice element whose similarity is more similar than a threshold value to a target user. Other criteria may be used to determine whether a movie is associated with one or more people may include cross-correlation of likelihoods of a person being associated with a movie based on previously determined other people. For example, movies with a certain cast of actors are often directed by a specific director known to favor casting said actors.

Likeness may, additionally or alternatively, be determined by claims, including but not limited to a person (e.g., a character in a movie) who claims to be a particular person, e.g., saying “I am the King of Morocco”. While this may be in jest, it may, additionally or alternatively, be an attempt to deceive. Automated analysis of other portions of the media content may identify whether the content is to be considered deceptive or not in such instances, including but not limited to heuristics matching common deceptive practices, such as Nigerian prince scams. Other heuristic risk rules may be used. Any user that is identified as likely corresponding to the media file causes a lookup of contact information for the corresponding prover, which is then contacted and a proof requested. The request may include the content, a reference to the content such as a hash of the content and/or a portion thereof. Warnings may be added to content as it is being rendered when the content matches a heuristic, such as including known false accusations, known fake news, known tricks used by scammers, etc. Based on the configuration of the devices associated with the verifier, content may, additionally or alternatively, be blocked, degraded, quarantined, etc., in response to a risk rule being triggered, and/or based on what particular rule(s) was and/or were triggered.

In accordance with numerous embodiments, proofs associated with media content do not have to be generated by the party appearing in media the content. For example, a news organization may have a reporter interview various people, some of which are famous and some of which are not. Based on the jurisdiction, the interviewees may have to provide consent for the footage to be used. The news outlet may offer assurances that the interviewees provided consent, in contrast to each interviewee doing so. This may be part of the proof, and/or one of several proofs provided by the news outlet. The news outlet may additionally attest to that some of the people were the actual famous people that they appeared to be, as opposed to impersonators. This would be something the news outlet would have to carefully verify before making such an attestation. The news outlet would then generate a proof that attests to the identity of some of the interviewees. When a person wishes to contest having been interviewed here, he and/or she could offer negative proofs and distribute these, along with taking legal action against the news outlet for not having carefully vetted the identities of the interviewees. Alternatively or in addition, one or more of the interviewees may, additionally or alternatively, provide positive proofs (e.g., to concur that they were not cited out of context, that they had agreed for the material to be made public). Doing so may, additionally or alternatively, help these people build a brand, as verifiers and their associated users may request additional content associated with these people, and/or cache their public keys and/or other identity information for later verifications.

Furthermore, the sources of media content (e.g., the news outlet) may be able to provide additional context through proofs, for example, “we interviewed ten people who really love peaches”. That context may include but is not limited to a background, a story, a selection process, a demographic description, etc. In the news outlet example, somebody who believes the added context is not correct may dissent by generating a negative proof relative to the news outlet's positive proof. Thus, one media element (such as a movie and/or an audio recording) may be associated with a multiplicity of proofs from one or more sources. These proofs may be directly attached to the media content, may be delivered independently of the media content, and/or may be delivered only in response to a request from a verifier. The proofs may be accessible only to selected (i.e., designated) parties and/or groups of parties, and/or may be publicly verifiable.

Verifiers of proofs may determine whether to accept the proof based on a variety of factors, including but not limited to the identity of the party and/or parties generating the proof(s); the reputation score(s) of such parties; past interaction between the verifier and this and/or these prover(s); the assertion being made by the prover. Proofs may, additionally or alternatively, include a certainty level, including but not limited to a statement of probability and/or confidence level such as “I believe this to be true with a 80% probability”. This probability may, additionally or alternatively, be factored into the verifier's decision of whether to accept and/or deny the proof. This determination may, additionally or alternatively, be influenced by an assessment of what is at stake for situations including but not limited to accepting a proof of a statement that is untrue and/or not accepting a proof of statement that is true. This assessment may be generated based on a machine learning model, based on a rule-based system, based on one or more lookups and/or requests to parties that specialize in generating such assessments, and/or a combination of such approaches and other approaches.

Proofs may refer to media (including but not limited to movies) that has already been generated at the time of the making of the proof. Proofs may, additionally or alternatively, refer to media content that is being streamed, where the proof may relate to a media segment that, at the time the proof is started to be generated (and/or verified) may not have been completed. One way to achieve this is by breaking media files into sections, that may include but are not limited to sections based on time intervals, and to associated proofs with distinct sections and/or series of sections. Another type of section may correspond to one particular dimension of media, such as image media, but not to another dimension, such as audio. Such proofs may be cross-correlated, chained, and/or connected through a graph, in which attestation proofs include digitally signed references to other proofs and metadata concerning the other proofs.

Methods in accordance with several embodiments, may be combined with methods for escrow such as those disclosed in U.S. patent application Ser. No. 18/176,920, titled “Partitioned Address Spaces in Blockchain Wallets,” filed Mar. 1, 2023, incorporated by reference in its entirety, and techniques related to ombudsman technology and envoy technology, as disclosed in U.S. patent application Ser. No. 18/323,344, titled “Systems and Methods for Facilitating Access to Token Content,” filed May 24, 2023, incorporated by reference in its entirety. Such technologies may be used as additional modules in the context of the technology disclosed herein. The ombudsman/envoy technology, for example, may be configured to initially associate positive identity proofs with a high threshold for acceptance of the proof, making any unclear cases flagged to the user(s), while making negative proofs associated with a low threshold causing many alerts and warnings, as well as other security actions.

As systems in accordance with some embodiments learn about user behavior and what risks the users are likely vulnerable to, based on their observed behavior, the systems may modify the configuration so that some types of positive proofs use a lower threshold of acceptance than the initial configuration and/or thresholds for the negative proofs may be increased. For another user, the thresholds for positive proofs may be modified as a result of observations of user behavior, while the thresholds for negative proofs remain low.

In some settings, the thresholds may set according to the context; for instance, one set of thresholds may be for financial information and another for entertainment information. Based on the type of political content the user is consuming, the system may modify the thresholds for media content with political content, including but not limited to block false news. The classification of the media content may be performed by an AI-based on automated analysis of audio, text, facial recognition results of video, the presence and/or absence of proofs, whether positive and/or negative, and more. The classification may, additionally or alternatively, be performed using clustering of content based on who created it, who commented on it, who indicated that they liked it and/or otherwise forwarded and/or promoted it, and based on the cluster such entities are determined to belong to.

Systems in accordance with multiple embodiments, may be incorporated in media recording devices, such as phones and cameras, allowing media content, whether communicated in real-time and/or after being recorded, to be associated with proofs. Such proofs may indicate the nature of the media, such as “this is a recording of X responding to a question”, and/or may include proofs of authorship and/or origination. The authorship indication may indicate the identity of the entity in charge of the recording, whether a natural person, a corporation, and/or both types of indications at the same time. The origination may indicate rights, such as the entity claiming the rights to royalties, and/or an entity assuring the recipient of the media of its truthful content and/or valid nature.

Systems and methods in accordance with various embodiments, may be used to embed hash-linked lists in media files, including but not limited to video files and/or audio files. In numerous embodiments, each frame of the media file includes a hash of a number of previous frames, which in some embodiments may be digitally signed using a private key of the media recording device. As the number of previous frames themselves may include hashes of earlier frames, back to an original frame of the media file, digitally-signed hash-linked lists may be generated as the media recording device records the media file, thus providing an attestation by the media recording device that the media file has not been tampered with.

Alterations may, in accordance with various embodiments, take various forms. For example, one type of alteration is an enhancement, such as where a user increases the contrast in an image. Another type of alteration is a modification that changes the meaning of an image, such as removing a person, adding a cow, replacing a text, etc. Different types of alterations may be allowed by different users, or not allowed at all, including but not limited to alterations based on policy. The type of the alteration may be determined based on the types of transformations made to the media, based on how a neural network may classify the original media and the altered media, and/or based on other criteria, including but not limited to degree of similarity. Here, “original” may refer to the version before the modification, to a version output by a sensor, such as a camera, and/or to both, and/or to a series of versions that are generated from each other using processing steps such as editing tools. An excerpt of media may be acceptable under certain circumstances, whereas the inclusion of most of the media may not be. One or more policies associated with a token may identify what alterations are permitted by entities with various access rights. In accordance with some embodiments of the invention, potential access rights for a given token may include but are not limited to viewing content associated with the token, editing content associated with the token, copying the token, transferring the token, deleting digital assets associated with the token, and assigning at least one access right to another entity. The entities that permit alterations may be classified in terms of their roles (owner, journalist, etc.), and/or the use of the resulting media (local display only, public rendering), as well as whether the altered media, when being used, results in royalty payments of a pre-set type to an indicated entity.

Media recording devices configured in accordance with several embodiments of the invention may query surrounding devices for identity information before and/or during the recording of the media content, as a way of determining the valid identities of these devices and associated users, where such identity information may be incorporated with and/or referenced by the recorded media content and/or associated proofs. By referencing one or more identities, such as Bluetooth device addresses and/or public keys transmitted by the devices, the level of assurance of the proofs is increased.

In accordance with various embodiments, positive proofs may cite the presence of relevant identifiers. Additionally or alternatively, negative proofs may cite all identifiers present to show the absence of the claimed non-present identifier. While this may be manipulated by a malicious recording device, it may be audited by comparing the observed constellations of identities of nearby devices, when available, and/or by using a trusted execution environment (TEE) and/or a digital rights management (DRM) component in the recording device to provide assurance of the validity of the recording, including the presence of identifiers, the difficulty of cheating increases.

Furthermore, systems in accordance with multiple embodiments may use blocklists and/or allowlists. By managing blocklists of believed compromised recording devices, systems may identify repeat offenders and provide warnings to verifiers about what provers not to trust. Similarly, allowlists of believed benevolent recording entities, indicated by identities associated with them, may be managed and used in the verification of proofs, whether these lists are distributed to verifiers and/or kept centrally in a database that may be queried by verifiers of proofs.

Media recording devices may include locating equipment and code, that may include but is not limited to GNSS receivers and positioning software, WIFI locating equipment and software, Bluetooth locating equipment and software, Ultra-wideband (UWB) locating equipment and software, etc. Additionally or alternatively, they may insert and/or merge location and time information during the recording of the media content, as a way of determining the valid identities of these devices, associated users, and persons present in the media content. In some embodiments, location information may be encrypted and/or hashed in a manner that prevents leaks of privacy but permits construction of proofs providing supporting evidence that persons featured in the media content were likely and/or truly present. For example, for verification and/or strong evidence that a person featured in the media content was present at the time of the creation of the media content, results from a proof of location for the media content, the media recording device, and/or the person featured may be compared to determine reasonable and/or unreasonable proximity at the time of the creation.

Provers may, additionally or alternatively, be associated with insurances, a form of endorsement that enables a party that believes to have been wronged to audit the process, file complaints, and/or obtain reparations. Such insurances may be implemented where a device is found to likely have been compromised. Such determinations may be made by the insurance company performing assessments using two or more independent complaints against an insured entity, by requesting information from a device against which a complaint has been filed, and/or by requiring a minimum software and/or hardware standard of devices in order for these to be insured. The standard may specify the use of required hardware components such as TEEs, the use of specified software such as anti-virus and DRM software, and/or proper updating of software, for example within a week of a patch being provided. The standard may, additionally or alternatively, include policies regarding access to the device, for example that the device must use biometric authentication of any user for the user to operate the device.

Systems and methods in accordance with some embodiments may be incorporated with messaging applications, with real-time video-conferencing applications, with native applications such as phone call applications, etc. This allows the verification of identity of a user (including but not limited to using a biometric authentication used for unlocking the device, and/or voice-verification software to determine the identity of the speaker) to be performed by the device and proofs be generated and incorporated with media (such as streamed voice data) as it is being transmitted. This enables traditional communications technology such as phone calls, to be augmented with capabilities to convey proofs of identity to a call recipient, enabling assurances that the caller is whom he and/or she claims to be, whether by indications of personal identity and/or corporate membership, and/or both.

### C. Identification Verification Intermediation

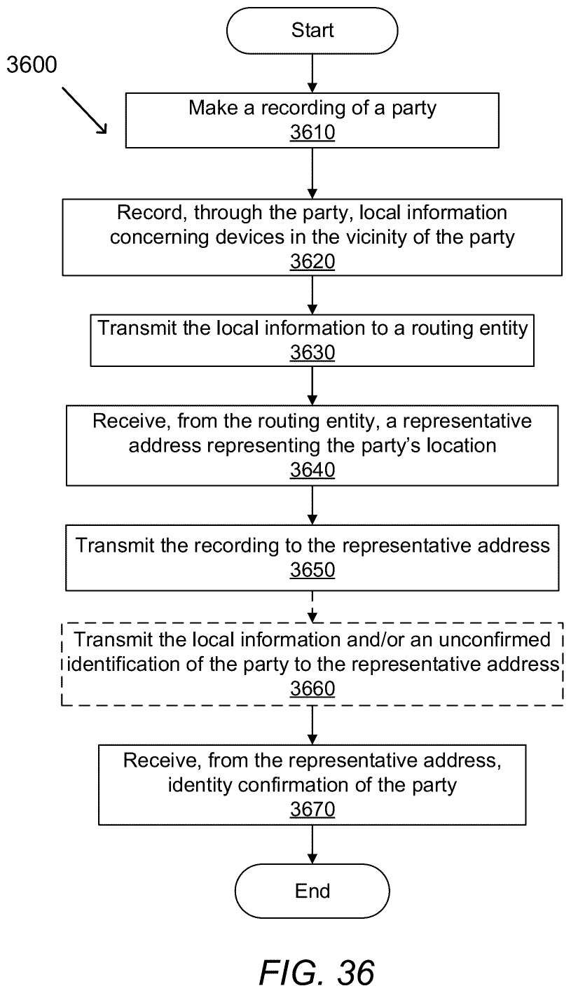

In accordance with various embodiments of the invention, servers may operate on behalf of users to generate proofs of identity. A process for identity assurance, performed in accordance with multiple embodiments of the invention, is illustrated in FIG. 36.

Process 3600 may be performed by a recording device belonging to a particular user. Process 3600 makes (3610) a recording of a party (such as a movie). Process 3600, through devices such as (but not limited to) the recording device, records (3620), through the party, local (such as digital identifying) information concerning devices in the vicinity of the party. The local information may include but is not limited to local information about networked devices and/or non-networked devices carried by and/or in the vicinity of the party. These devices could be Bluetooth Low Energy (BLE) devices, for example.

Process 3600 transmits (3630) the local information to a routing entity, in order to obtain the address(es) corresponding to the local information. Potential routing entities may include but are not limited to DNS lookup services. In accordance with some embodiments, potential routing entities may be part of a hierarchical structure where they request information from other routing entities when unable to resolve the address of the local information.

Process 3600 receives (3640), from the routing entity, a representative address representing the party's location. Specifically, the local information may be resolved to the representative address. Process 3600 transmits (3650) the recording to the representative address. In accordance with multiple embodiments, the representative address may take a form including but not limited to media files.

Process 3600 optionally transmits (3660) local information and/or an unconfirmed identification of the party to the representative address. The entity/entities associated with the representative address may include but is not limited to devices and/or users. The entity may make determinations identifying the party within the recording. Determinations may include but are not limited to automated assessments, for example, based on facial recognition. The determination may, additionally or alternatively, include querying users including but not limited to the parties and/or representatives of the parties. Local information and/or the unconfirmed identification of the party, when transmitted (3660), may be used in making the determination.

Process 3600 receives (3670), from the representative address, identity confirmation of the party. In some embodiments, the determination may include but is not limited to a positive proof on behalf of the party when the entity associated with the representative address determines that the party is in the recording, a negative proof when the entity determines that the party is not in the recording, and an indeterminate proof indicating a lack of ability to make a positive and/or negative determination.

While specific processes for verifying proofs are described above, any of a variety of processes may be utilized for identity verification as appropriate to the requirements of specific applications. In some embodiments, steps may be executed or performed in any order or sequence not limited to the order and sequence shown and described. In numerous embodiments, some of the above steps may be executed or performed substantially simultaneously where appropriate or in parallel to reduce latency and processing times. In many embodiments, one or more of the above steps may be omitted.

Proofs are not limited to positive, negative and indeterminate findings. The proofs may additionally or alternatively, an indication of a degree, where this may go from −100 (negative) to +100 (positive), and wherein the degree 0 would correspond to an inability to determine and, for example, 50 corresponds to a relatively high degree of conviction of a positive indication. The degree is different from a reputation score of the party that generates the proof. The reputation score represents how trustworthy the prover is. The reputation score may be used as a weight to scale the degree.

Different verifiers may apply the weight in different ways. One verifier may simply multiply the two values together and use the product as an indicator. Another verifier may dismiss any proof that is associated with a reputation score below a set threshold, and accept any proof above the threshold, where accepted proofs are represented by the degree. A user wallet may include a security control unit (e.g., ombudsmen) that determines whether a proof is accepted or not, where different security control units may use different thresholds, thereby making it more difficult for an adversary to determine the minimum score required to make a proof pass for a given user and her wallet.

Other functions may be used to combine proof indications. For example, when a set {s₁, s₂, . . . , sₙ} includes indication scores from provers p₁ through to pₙ, with the provers assigned weightings w₁ through to wₙ, and with indication scores ranging between a maximum value Max and a minimum value Min, in general a final score generation function:
f(s₁, . . . , sₙ, w₁, . . . , wₙ, pₙ, . . . , pₙ, Max, Min)=indication score may be used to generate the indication score.

Verifiers may be publicly-available services, creating various business opportunities. Therefore verifiers, in turn, may be certified by a third-party regarding the trustworthiness of the verifier, either in total and/or for specific users/users. Such certification could take the form of verifier badging and/or other designation. In turn, ombudsman protections, for example writing a wallet, may interact with this verification to decide what transactions to allow.

### D. Proof Decryption

In accordance with several embodiments, identity proofs may, at least in part, be encrypted in a manner that may be decrypted only by a designated authority, such as an escrow authority and/or two or more entities that together make up an escrow authority. This allows a content creator and/or a third party to include a proof with media content, and/or otherwise associate such a proof with the media content, while limiting what parties may verify the proof. For example, by encrypting the proof using a public key of law enforcement, the prover enables law enforcement—but not others—to verify the proof, and thereby verify the proof as part of an assessment of the identity of an indicated user and/or users, and/or aspects (such as voice) thereof. That enables the designated law enforcement entity to use the private key associated with the public key used for encryption to decrypt the ciphertext including the proof, after which the proof may be verified. The designated authority may forward the decrypted proof to one or more additional verifiers, which these may verify, unless the proof is a designated verifier proof, as disclosed in the 2001 publication titled “Designated Verifier Proofs and Their Applications” by Markus Jakobsson, Kazue Sako and Russell Impagliazzo, the disclosure of which is incorporated by reference in its entirety.

In accordance with various embodiments, designated verifier proofs may be used for the identity proofs disclosed herein, and/or may be encrypted in a manner that it is only accessible to a designated authority including but not limited to an escrow authority. The entity that is designated to decrypt may be different from the entity that is designated to verify the proof, requiring collaboration between the two entities. One and/or both of these entities may include multiple parties, through methods including but not limited to secret sharing methods of the private key used. Related escrow techniques are disclosed in U.S. patent application Ser. No. 18/176,920, titled “Partitioned Address Spaces in Blockchain Wallets,” filed Mar. 1, 2023, incorporated by reference in its entirety.

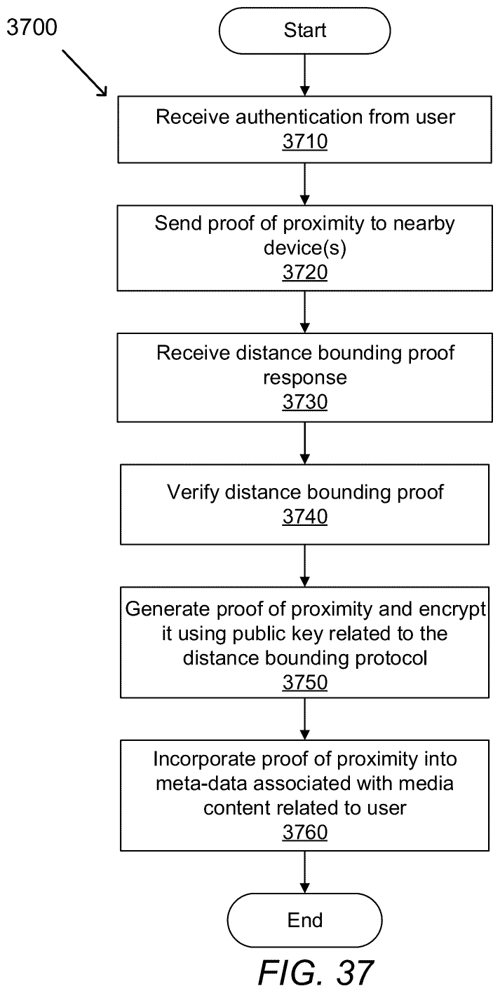

A process for continuous proximity attestation, performed in accordance with various embodiments of the invention, is illustrated in FIG. 37. Process 3700 may be performed by a (first) device including but not limited to smartphones, computing devices, and/or appliances. Process 3700 receives (3710) an authentication from a user. The authentication may be received using modes including but not limited to biometric reader, username and password, and/or personal identifier. In accordance with numerous embodiments, process 3700 may periodically verify that the first device is in the continued possession of the user. In accordance with multiple embodiments, process 3700 may perform periodic verification through modes including but not limited to verifying voices, gait biometrics, and/or facial biometrics. Additionally or alternatively, process 3700 may perform periodic verification by gaining assurance that the first device is continually associated with the user. Assurance may be gained by being physically bonded with the user, through modes including but not limited to RFID-enabled under-skin implants.

Process 3700 sends (3720) proofs of proximity to nearby devices, including but not limited to a second device. To make sure that proofs of proximity are not conveyed to a device that is distant from the first device, the device may require that the second device (receiving the proof(s) of proximity) is physically close. Process 3700 receives (3730) a distance bounding proof response from the second device. The distance bounding proof may be used to confirm physical closeness. In some embodiments, the prover(s) in the distance bounding protocol, in this case the second device may, additionally or alternatively, include a proof of knowledge of the private key associated with a public key of the distance bounding proof. In doing so, process 3700 verifies (3740) the distance bounding proof.

Process 3700 generates (3750) the proof of proximity and encrypts it using the public key related to the distance bounding protocol. In accordance with certain embodiments, the proof of proximity may be prevented from being conveyed (including but not limited to using a proxy in the surroundings of the first device) to a device that is too distant. Additionally or alternatively, the proof of proximity may include reference to one or more fixpoints (including but not limited to constellations of SSID addresses and/or GPS coordinates measured by the first device/trusted third-party devices). The second device may receive the proof of proximity and, additionally or alternatively, uses the proof of proximity as evidence that the user (known to be associated with the first device) is near the first device.

Process 3700 incorporates (3760) the proof of proximity into meta-data associated with media content related to the user. In doing so, process 3700 may provide assurance that one or more people identified in the media content (including but not limited to using facial recognition and/or voice recognition) match the user of the first device, with whom there is a match of (including but not limited to biometric) information.

While specific processes for proximity attestation are described above, any of a variety of processes may be utilized for verification as appropriate to the requirements of specific applications. In multiple embodiments, steps may be executed or performed in any order or sequence not limited to the order and sequence shown and described. In a number of embodiments, some of the above steps may be executed or performed substantially simultaneously where appropriate or in parallel to reduce latency and processing times. In various embodiments, one or more of the above steps may be omitted.

In accordance with several embodiments, identity proofs may be associated with areas of visual displays, and may track people over time using methods including but not limited to facial recognition. Thus, a positive identity proof may be applied to one snapshot by a prover and then associated with a series of frames of a video. A negative identity proof of a first party may include a positive identity proof of another party, where both proofs refer to the same area, and by the second party claiming the association with an identity, this is a useful indication to support that this party is not the first party.

Identity proofs may be applied to media beyond recorded media, including but not limited to streamed media, surveillance camera footage, etc. For example, users may associate an identity with a screenshot of camera footage by badging in using a corporate ID, by performing a biometric verification, by entering a PIN associated with the user, etc., and/or use a combination of such identification efforts. The identity may then subsequently be associated with other screenshots, and portions of camera footage by determining that one person in a first frame is the same as a second person in a second frame by means of determining continuity of location, coloration, gait, etc., between the two frames, including but not limited to automated analysis of frames (e.g., frames temporally located between the first and the second frame in the footage). Brief discontinuities may be resolved, including but not limited to by AI-based models that track people as they pass behind obstacles; such methods are common in high-end cameras and used for purposes of autofocus among other things. A positive identity proof may be applied by a security system of an environment and attest to the continuity of an identity, which may be combined with an identity proof tying the same persona to an identity, as described in various places in this application. The attestation of the security system in this example use does not require knowledge of the identity, as it only specifies that two entities are the same, including but not limited to by analysis of continuity as described above. This attestation survives cutting of the footage, and the continuity may be audited, including but not limited to by consulting a repository with the uncut footage, by querying the security systems, etc.

In accordance with a number of embodiments, one or more access rights may be associated with a biometric identifier. The access right may be to the storage used to store a private key used to modify the ownership of one or more tokens. The access rights may, additionally or alternatively, be used to decrypt data, including but not limited to payload data associated with a token (to gain permission of a trusted platform module (TPM) and/or digital rights management module).

One or more policies identifying the requirements for obtaining access rights may be encoded in access right elements that may be associated with payload elements, including but not limited to elements attached to and/or referenced by the same. One example policy is that a user matches one out of a collection of specified biometric templates with a score exceeding a specified threshold. The association between access rights and a biometric template, and/or other policy, may be temporary, for instance “only until the end of the month”, “only for two usages”, etc. The temporary aspects of the access rights may be specified by one or more policies, which may refer to and/or incorporate data stored on a blockchain, provided by a user (such as using a sensor), and/or obtained from an oracle. The association of access rights to a set of requirements, such as a satisfactory match between a sensor output and a biometric template wherein satisfactory may correspond to exceeding a threshold, may be incorporated in a certificate, recorded on a blockchain, and/or be part of private storage, including but not limited to wallets. Policies may, additionally or alternatively, be expressed using smart contracts, as described above.

In accordance with certain embodiments, the association between access rights and conditions may be revoked. One way to do this is to make the associated policy dependent on a revocation status associated with the item, wherein an item may correspond to one or more tokens. Revocation may be performed by a third party, such as a consumer representative, an industry conglomerate, a governmental entity, and/or an entity appointed by a token owner, a token creator, a token marketplace, etc. Revocation may, additionally or alternatively, be enabled by a party with access rights, and/or otherwise matching a policy identifying access rights. This way, revocation capability is just another capability that may be governed, as other capabilities, by policies and access rights. Tokens may be identified with multiple policies, including but not limited to one policy related to what parties and under what conditions content associated with the token may be accessed and/or rendered; a second policy identifying who may modify ownership, the manners in which it may be modified, and the conditions that need to be satisfied for a modification to be allowed; a third policy to identify temporal aspects; and a fourth policy to govern what entities may modify one or more of the policies associated with the token, incl. what policies and the conditions under which these may be modified.

In many embodiments, one or more policies may be used to determine and generate assurance that there is at least one human operator associated with tokens. For example, this may include but is not limited to determining liveness for a biometric identifier. When a biometric identifier is used, liveness may be determined without disclosing what biometric identifier is being matched, and/or by providing partial information about various characteristics (e.g., that the user is an adult, a Canadian citizen, and/or a person registered to vote). Such assertions may be the sole output from the token; these assertions may then be consumed by other tokens and/or other services. The assertions may, additionally or alternatively, be used to satisfy policies associated with a given token. For example, the playing of some payload content such as a movie may require that a user provides evidence of liveness during a commercial associated with the payload content; this way, the content creator verifies the presence of a human user during the rendering of an advertisement, as a condition of the continued rendering of the movie content associated with the token.

Systems and methods in accordance with various embodiments present new inventions in the context of the Ethereum smart contract blockchain ecosystem. However, on reading the present disclosure, those skilled in the art will appreciate the novel aspects of the inventions presented, and will further appreciate in light of the disclosure that such novel aspects may be readily applied to other smart contract blockchain and distributed ledger systems able to instantiate tokens, such as, but not limited to: EVM compatible layer 2 chains such as Polygon and Arbitrum, Cardano, NEAR, Polkadot, Cosmos, Solana, Hedera, etc.

### E. Monitoring Token Quantities

Ethereum uses unsigned 256-bit integers (uint256) as the largest number that may be stored natively. As a result, the largest amount of tokens an entity owns in a standard ERC20 instantiated contract, which uses a mapping from an address to a uint256 to store balances, is 2²⁵⁶−1.

In accordance with some embodiments, the balance of addresses may be stored in two (or more) mappings within smart contracts. One address to uint256 mapping may be used for a first balance between 0 and 2²⁵⁶−1, and a second uint256 mapping may be used for a second balance between 2²⁵⁶ and 2⁵¹²−1. Those skilled in the art will now appreciate in the light of this disclosure that an arbitrarily large number may be represented through the use of further mappings.

To verify that a transfer of an amount of tokens where the amount is greater than the first balance is permitted, the smart contract may verify that the second balance is greater than 1. Subsequently, the smart contract may reduce the second balance by 1, and may set the first balance equal to 2256 minus the amount of tokens to transfer, plus the initial value of the first balance. When the transfer is for an amount of tokens less than the first balance, then the amount is subtracted from the first balance.

In an example, presented for illustrative purposes only and not meant to be limiting in any way, when the first balance of an address is 10 tokens, and a transaction is received by the smart contract for a transfer of 12 tokens, the smart contract may check that the second balance is greater than 0. For the purposes of the present example, we may assume the second balance is 6. The smart contract may reduce the second balance by 1, to a value of 5, and the smart contract may then set the first balance to 2²⁵⁶−12+10, i.e. 2²⁵⁶−2.

The method disclosed above may be implemented in transfer functions of smart contracts. For example, for ERC20-compliant smart contracts, the transfer( ) and transferFrom( ) functions may be implemented using the above method.

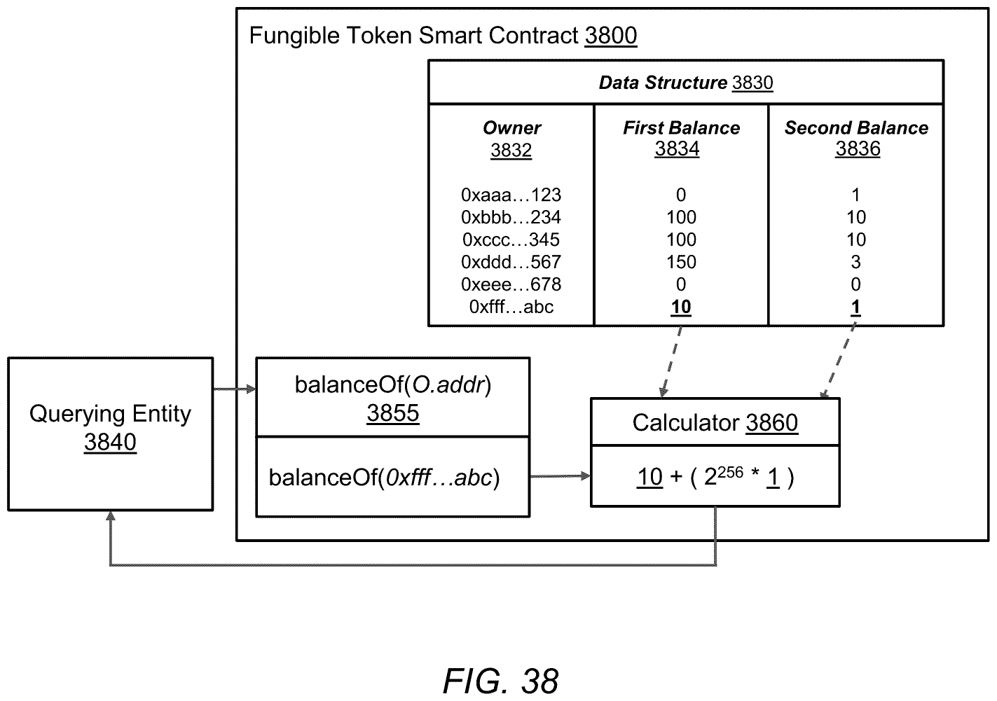

A block diagram depicting the storage of token balances by smart contracts configured in accordance with many embodiments of the invention is illustrated in FIG. 38. Querying entities 3840 may query fungible token smart contracts 3800, configured in accordance with several embodiments of the invention, that include but are not limited to balance data structures 3830, at least one function, and a balance calculation component 3860. The balance data structure 3830 may include (but is not limited to) a mapping from owners 3832 (via owner addresses) to two and/or balance columns such as a first balance 3834 column and a second balance 3836 column. The first balance 3834 column may record balances (e.g., uint256 values) representing place values corresponding to single units (e.g., singular cryptocurrency units). Additionally or alternatively, the second balance 3836 column may record balances (e.g., using uint256 values) representing (balance) place values corresponding to multiples of 2²⁵⁶. In accordance with several embodiments, the balance data structure 3830 depicted in FIG. 38 may thereby account for balances of up to 2⁵¹²−1. In accordance with some embodiments, larger sums may be recorded by increasing the number of balance recording columns (a third balance column, a fourth balance column, etc.).

In accordance with multiple embodiments of the invention, querying entities 3840 may submit transactions that call on functions associated with the fungible smart contracts 3800. Example transactions may be submitted to query the balance(s) associated with specific (smart contract) addresses. In such cases, the transaction(s) may call a balanceOf function 3855. In an example based on FIG. 38, the querying entity 3840 may wish to know the balance of address 0xfff . . . abc, and may therefore submit a transaction, making a call to the balanceOf function 3855 associated with the fungible token smart contract 3800, with 0xfff . . . abc as a parameter.

The fungible token smart contract 3800 may retrieve a first balance value and a second balance value from the balance data structure 3830, using the input (owner 3832) address to locate the corresponding entry. In doing so, the fungible token smart contract 3800 may retrieve the values, as mapped to from the owner 3832. In the example retrieval illustrated in FIG. 38, the first balance is 10 and the second balance is 1.

In accordance with numerous embodiments of the invention, a balance calculation component 3860, upon receiving a first balance 3834 and second balance 3836, may be configured to calculate a total token balance. In the example of FIG. 38, the balance calculation component 3860 calculates that the token balance includes 10 units from the first balance 3834 and (2²⁵⁶*1) units from the second balance 3836. The total balance may then be returned to the querying entity 3840.

In some embodiments of the invention, the total balance may be returned as a tuple, with one element of the tuple representing units, and the other element of the tuple representing 2²⁵⁶-ths. In certain embodiments, the total balance may be returned as a string of digits, a JSON object representing a bignum, a byte array, and/or some other data structure capable of storing and communicating large number values.

In various embodiments, unlike Ethereum smart contracts that only support unsigned integers, smart contracts may enable negative balances through the use of an interpretation of an unsigned integer, for example a uint256. In accordance with a few embodiments, a most significant bit may be used to represent a sign of a balance. Additionally or alternatively, a second mapping to Booleans and/or integers, henceforth referred to as sign mappings, may be used to represent the sign of the balance (for example using True to indicate a positive balance and False to indicate a negative balance where a Boolean is used, using 0 to indicate a positive balance, and/or using non-zero value for a negative balance). Systems in accordance with multiple embodiments may be more efficient in data storage requirements, with a trade-off in the magnitude of the balance, which in Ethereum using a uint256 is reduced to ±2²⁵⁵. Systems may, additionally or alternatively, produce more readable code and may support an expected balance of ±2²⁵⁶. Larger and smaller balances may be supported through a combination of the above characteristics.

In accordance with certain embodiments, when a positive balance A is reduced by a (greater) amount B, where B is greater than A, then the balance may be set to (B-A) and/or followed by flipping the most significant bit from 0 to 1. Additionally or alternatively, the balance may be set to (B-A), and the sign mapping may be changed from True to False for a Boolean sign mapping, and/or from 0 to a positive integer for an integer sign mapping. Similarly, when a negative balance C is increased by an amount B, where B is greater than the absolute value of C, the balance may be set to (B-C), and the sign mapping may be changed from False to True for a Boolean sign mapping, and/or from a positive integer to 0 for an integer sign mapping. Transfers of negative values from a first address to a second address may function implicitly. In accordance with some embodiments, transfer functions may take extra parameters constituting a sign of the amount being transferred.

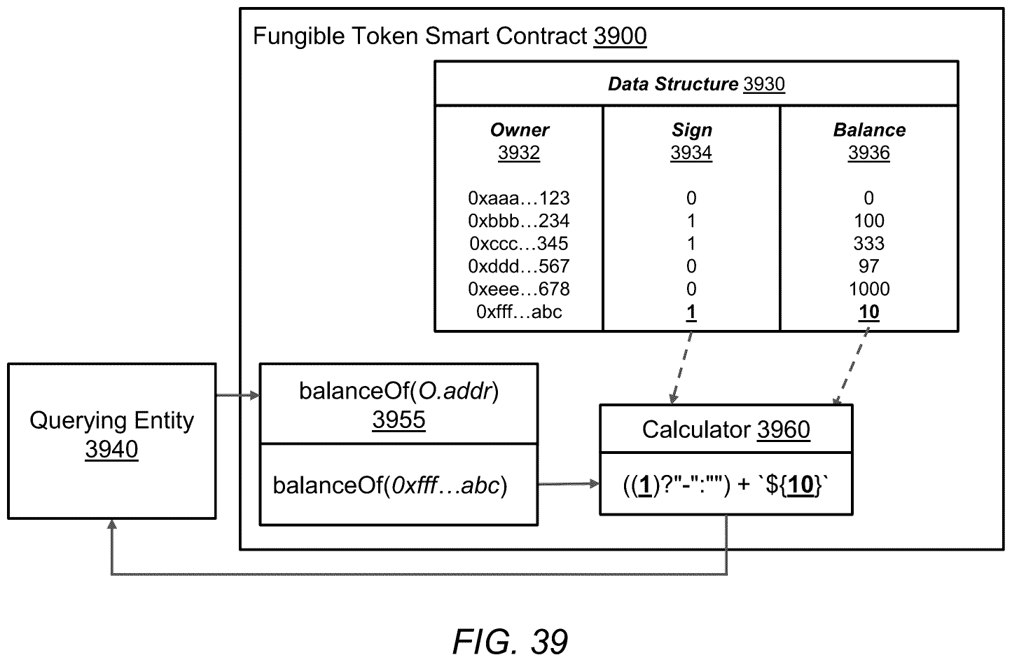

A block diagram depicting the storage of signed integer token balances by smart contracts configured in accordance with various embodiments of the invention is illustrated in FIG. 39. Querying entities 3940 may query fungible token smart contracts 3900, configured in accordance with miscellaneous embodiments of the invention, that include but are not limited to balance data structures 3930, at least one function, and a balance calculation component 3960.

The balance data structure 3930 may include (but is not limited to) a mapping from owners 3932 (via owner addresses) to two or more columns such as a sign 3934 column and a balance 3936 column. The balance column may record balances (such as uint256 values) through representing units of balance. The sign 3934 column may record whether a particular balance is positive and/or negative. In doing so, the sign 3934 column may use data types able to distinguish between two values including but not limited to uint values (like uint256), Booleans, and/or strings.

In accordance with numerous embodiments of the invention, querying entities 3940 may submit transactions that call on functions associated with the fungible smart contracts 3900. Example transactions may be submitted to query the balance(s) associated with specific (smart contract) addresses. In such cases, the transaction(s) may call a balanceOf function 3955. In an example based on FIG. 39, the querying entity 3940 may wish to know the (signed) balance of address 0xfff . . . abc, and may therefore submit a transaction, making a call to the balanceOf function 3955 associated with the fungible token smart contract 3900, with 0xfff . . . abc as a parameter.

The fungible token smart contract 3900 may retrieve a sign 3934 value and a balance 3936 value from the balance data structure 3930, using the input (owner 3932) address to locate the corresponding entry. In doing so, the fungible token smart contract 3900 may retrieve the values, as mapped to from the owner 3932. In the example retrieval in FIG. 39, the sign value is 1, indicating that the signed integer balance is a negative. Further, the balance value is 10, indicating that the “magnitude” of the balance is 10 units.

In accordance with many embodiments of the invention, a balance calculation component 3960, upon receiving a sign 3934 and balance 3936, may be configured to calculate a total signed balance. As mentioned, the sign value is 1, indicating that the signed integer balance is negative, and the balance value is 10 units, reflecting that the balance of the 0xfff . . . abc address is −10 (units). In the example of FIG. 39, the balance calculation component 3960 uses a JavaScript conditional statement, presented for illustrative purposes only:

$$( ( sign ) ? - : ) + {}^{‵} \$ {\{ balance \}}^{‵} \to ( ( 1 ) ? - : ) + {}^{‵} \$ {\{ 10 \}}^{‵}$$

The total balance may then be returned to the querying entity 3940. In some embodiments of the invention, the signed balance may be returned in the form of a data type which may include but is not limited to a string and/or a JSON object.

Currently, Ethereum ERC20 tokens implement fixed point arithmetic by storing balances as unsigned integers, typically 256-bit unsigned integers, and by including a decimals value. Thus, for example, a dollar-pegged stablecoin may store a number of units of the balance representing 1/1 000 000 of a dollar, and may specify a decimals value of 6, thus indicating that the dollar-pegged stablecoin balance should be divided by 1 000 000 to obtain a dollar balance. Floating point arithmetic is not supported. In accordance with a number of embodiments, floating point arithmetic may be provided by specifying a balance as a 2-tuple, for example a two-element array and/or some other two-element data structure, with one element of the array representing the balance, and another element of the array representing a number of decimal places. In an example presented for illustrative purposes only and not meant to be limiting in any way, (1, 0) may represent 1, and (3, 2) may represent 0.03. In accordance with several embodiments, the 2-tuple may be ordered such that a first element represents the number of decimal places and the second element represents the balance.

In accordance with a number of embodiments, when an amount (X, D) is transferred to an address holding a balance of (Y, E), and D>E, a new balance for the address becomes:

$$( X + Y * {10}^{( D - E )} , D )$$

and when D<E, a new balance for the address becomes:

$$( X * {10}^{( E - D )} + Y , E )$$

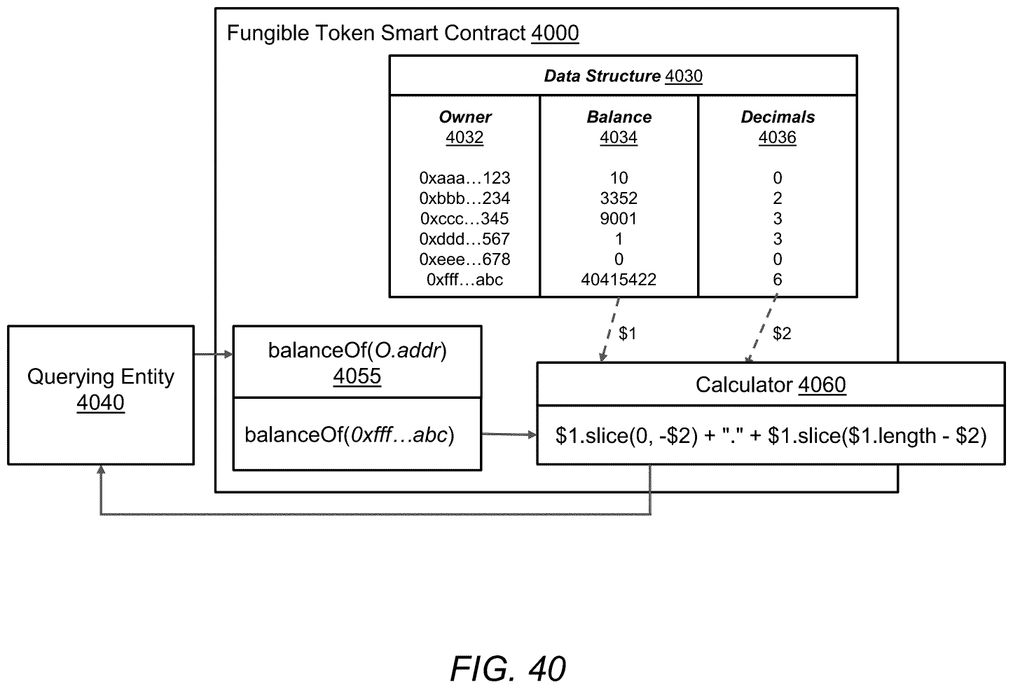

A block diagram depicting the storage of floating point integer token balances by smart contracts configured in accordance with many embodiments of the invention is illustrated in FIG. 40. Querying entities 4040 may query fungible token smart contracts 4000, configured in accordance with various embodiments of the invention, that include but are not limited to balance data structures 4030, at least one function, and a balance calculation component 4060.

The balance data structure 4030 may include (but is not limited to) a mapping from owners 4032 (via owner addresses) to two or more columns such as a decimal 4036 column and a balance 4034 column. The balance column may record balances (e.g., using uint256 values) through representing units of balance. The decimal 4036 column may record where a decimal point should be placed within the balance (for instance, using uint256 values).

In accordance with a number of embodiments of the invention, querying entities 4040 may submit transactions that call on functions associated with the fungible smart contracts 4000. Example transactions may be submitted to query the balance(s) associated with specific (smart contract) addresses. In such cases, the transaction(s) may call a balanceOf function 4055. In an example based on FIG. 40, the querying entity 4040 may wish to know the (floating point) balance of address 0xfff . . . abc, and may therefore submit a transaction, making a call to the balanceOf function 4055 associated with the fungible token smart contract 4000, with 0xfff . . . abc as a parameter.

The fungible token smart contract 4000 may retrieve a decimal 4036 value and a balance 4034 value from the balance data structure 4030, using the input (owner 4032) address to locate the corresponding entry. In doing so, the fungible token smart contract 4000 may retrieve the values, as mapped to from the owner 4032. In the example retrieval in FIG. 40, the balance value is 40415422, indicating that the balance is 10 units. Further, the decimal value is 6, indicating that a decimal point is placed 6 digits into the balance value. Thus a floating point balance of the 0xfff . . . abc address depicted in FIG. 40 would be 40.415422.

In accordance with several embodiments of the invention, a balance calculation component 4060, upon receiving a decimal 4036 value and balance 4034, may be configured to calculate a total floating point balance. In the example of FIG. 40, the balance calculation component 4060 uses a JavaScript statement, presented solely in generalized form for brevity and used for illustrative purposes:

$$\$1 . slice ( 0 , - \$2 ) + . + \$1 . slice ( \$1 . length - \$2 )$$

where $1 is a variable representing the balance (40415422) and $2 is a variable representing the number of decimal places (6).

The floating point balance (40.415422) may then be returned to the querying entity 4040. In certain embodiments of the invention, the floating point balance may be returned in the form of a data type which may include but is not limited to a string and/or a JSON object.

An example implementation of the balance calculation for returning a floating point value in JavaScript, given a balance and a number of decimals, may take the form:

```
function floatValue(balance, decimals) {
  if (decimals === 0) {
    return balance + “.0”
  } else when (balance.length === decimals) {
    return “0.” + balance
  } else when (balance.length < decimals) {
    return “0.” + “0”.repeat(decimals − 1) + balance
  } else return balance.slice(0, −decimals) + “.” +
balance.slice(balance.length − decimals)
}
```

In accordance with many embodiments, a token contract may store balances as an array instead of an integer. For example, in Ethereum, a balance mapping may be from an address to an array, such as address=>uint256[N] for a dimension N, where N indicates a number of elements of the array. In accordance with a number of embodiments, the token contract may store balances as a structure, that is, a group of several variables of the same and/or different types. The token contract may define an algebra across a finite vector space and/or vector field of the array of structure of the mapping. The algebra may be one or more of: associative or non-associative, unital or non-unital, and/or commutative or non-commutative. The algebra may include definitions for addition and multiplication of values of the array and/or structure. In some embodiments, some or all elements of the array may, additionally or alternatively, take the form of arrays.

Those skilled in the art of mathematics will appreciate that an array may correspond to a vector representation. Elements of the array and/or structure may include but are not limited to positive values, negative values, and/or zero. In accordance with certain embodiments, elements of the array and/or structure may be represented as floating point values.

Systems and methods in accordance with certain embodiments may include transform functions including a set of one or more matrices. The matrices may be applied to the balance through multiplying one or more of the matrices with the balance. In some embodiments, the set may only include matrices that do not alter the magnitude of a vector during multiplication, thus implementing a rotation, permutation, and/or flipping of the vector while preserving the magnitude of the vector, corresponding to a preservation of the size of the balance. In multiple embodiments, a matrix may only be applied through multiplication to the vector when the vector is an eigenvector of the matrix.

In an example, provided for illustrative purposes only and not meant to be limiting, a token contract may have relevance to a game, and may implement a balance of the token as an array with three elements, thus representing a position in a three-dimensional space within the game. Players may trade and/or transfer position balances, thus increasing and/or decreasing magnitude and/or directions of the balance. Additionally or alternatively, the balance may represent a volume of known space that a player is permitted to explore.

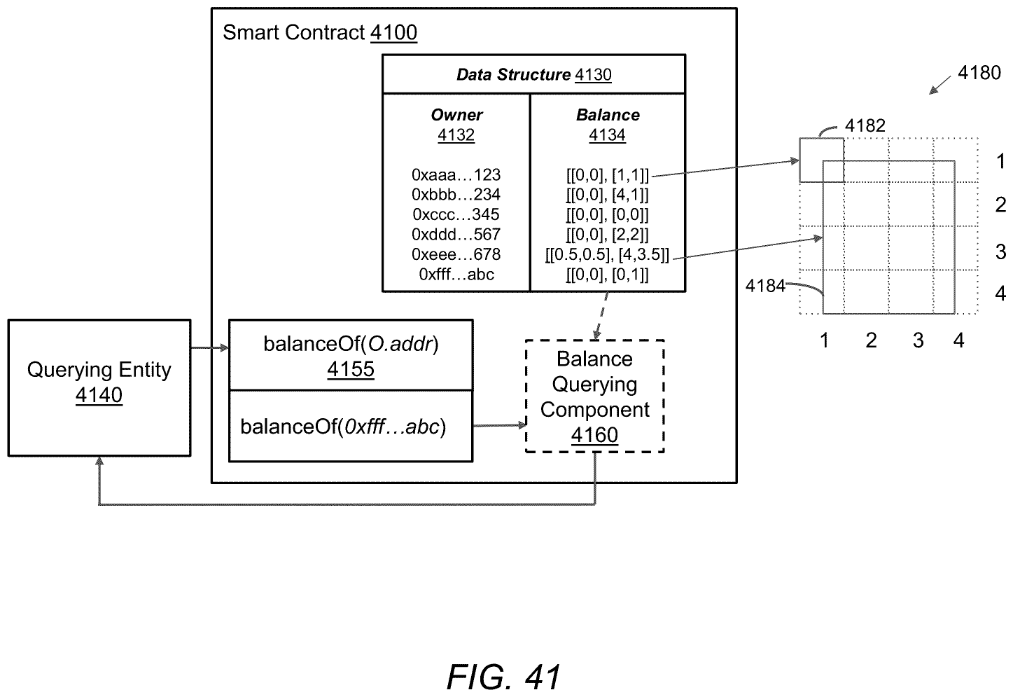

A block diagram depicting the storage of balances, corresponding to a specific game, by smart contracts configured in accordance with some embodiments of the invention is illustrated in FIG. 41. Querying entities 4140 may query token smart contracts 4100, configured in accordance with multiple embodiments of the invention, that include but are not limited to balance data structures 4130, at least one function, and a balance calculation component 4160. The smart contract 4100 may instantiate balances for token owners, wherein the balances 4134 represent an area within a game-playing field (such as one that each token owner may visit). As indicated above, the balance data structure 4130 may include (but is not limited to) a mapping from owners 4132 (via owner addresses) to one or more columns, such as a balance 4134 column. The balance column may record balances representing units of balance.

In accordance with numerous embodiments of the invention, querying entities 4140 may submit transactions that call on functions associated with the smart contracts 4100. Example transactions may be submitted to query the balance(s) associated with specific (smart contract) addresses. In such cases, the transaction(s) may call a balanceOf function 4155. In an example based on FIG. 41, the querying entity 4140 may wish to know the balance of address 0xfff . . . abc, and may therefore submit a transaction, making a call to the balanceOf function 4155 associated with the smart contract 4100, with 0xfff . . . abc as a parameter.

The smart contract 4100 may retrieve the balance 4134 value from the balance data structure 4130, using the input (owner 4132) address to locate the corresponding entry and retrieve it (such as using a balance querying component 4160). The balance 4134 may then be returned to the querying entity 4140.

In some embodiments, the balance may take the form of an array. Balance 4134 arrays may represent an area within the game playing field 4180 that may be visited by an owner (such as 0xaaa . . . 123 in FIG. 41) of a first address. In such a case, the balance 4134 array may be used to represent the bounds of a specific (e.g., rectangular, circular, square) area. For example, for owner 0xaaa . . . 123, a first element (for example, [0,0] in FIG. 41) of the balance 4134 array may indicate a top-left corner of a first area. Additionally or alternatively, a second element (such as [1,1] in FIG. 41) of the balance 4134 array corresponding to 0xaaa . . . 123 may indicate a bottom-right corner of the first area. This may indicate that a valid playing area for owner 0xaaa . . . 123 is a square as indicated by 4182. A second owner of a second address (i.e., 0xeee . . . 678 in FIG. 41) may have a balance of [[0.5,0.5],[4,3.5]], indicating that a valid playing area for the second owner is a rectangle indicated by 4184.

### F. Token-Based Transactions

Currently, standard implementations for NFTs separate a transfer of an NFT from a payment for an NFT, and thus either two transactions are required for a trade, and/or an escrow smart contract is required as an intermediary for the trade. Furthermore, a deployer and/or creator of a smart contract instantiating NFTs may wish to tie transactions to a specific issued fungible token, for example USDC, DAI, and/or a token issued by the deployer and/or creator of the NFT smart contract. There is therefore a need for NFT smart contracts that enable transactions to be tied to a specific fungible token.

In current NFT smart contract standards, for example Ethereum Request for Comment 721 (ERC721), a call to an approve(recipient, tokenID) function may approve a recipient address to transfer a token with an identifier specified by tokenID. A transaction signed by the recipient address to transfer the token with the identifier specified by tokenID may subsequently succeed without any payment and/or corresponding token transfer to the owner of the token with the identifier specified by tokenID.

In accordance with some embodiments, NFT smart contracts may be tied to specific fungible tokens through a modification to approval functions (in the NFT smart contracts). An owner of an NFT may approve a recipient for an NFT with a specified token identifier, subject to receiving a corresponding transfer of a specified amount of a fungible token in return. The recipient may subsequently only transfer the NFT to an address of the recipient's choosing when the transaction to transfer the NFT includes a corresponding transfer of the specified amount of the fungible token.

Approve functions of NFT smart contracts configured in accordance with various embodiments of the invention may include parameters specifying recipients and/or NFTs (e.g., NFTs identified by a token identifier as per the ERC721 standard). Additionally or alternatively, approve functions and may include but are not limited to parameters of: an amount of a fungible token, and an identifier of the fungible token. In numerous embodiments, the identifier of the fungible token may include an address of a smart contract instantiating the fungible token. An owner of the NFT identified by the token identifier may approve a recipient using the approve function, specifying the amount of the fungible token. The recipient may, additionally or alternatively, approve the NFT smart contract with the fungible token smart contract as an operator permitted to transfer the amount of the fungible token. Subsequently the recipient may submit a transaction to the NFT smart contract to transfer the NFT identified by the token identifier to an address of the recipient's choosing (for example, the address of the recipient). The NFT smart contract may then use the approval to transfer the amount of the fungible token from the recipient to the owner, and the NFT identified by the token identifier to the address of the recipient's choosing. When the NFT smart contract is unable to transfer the amount of the fungible token to the owner, then the transaction may revert.

Systems and methods in accordance with many embodiments may commence with owners approving transfers of NFTs by NFT contracts. Transfers may be made to receivers and/or parties may be provided an amount of fungible tokens in return. In some embodiments, a single fungible token type may be specified, whereas, in various embodiments, the fungible token type may be selected from a list of acceptable fungible token types.

In accordance with multiple embodiments of the invention, receivers may approve NFT contracts to transfer amounts of the fungible tokens. The receivers may submit transactions to transfer NFTs from owner to recipient. The NFT contracts may transfers the amount of the fungible token to the owner and transfer the NFT to the recipient. In the event of either transfer failing, both transfers may fail (i.e., an atomic transaction).

Recital (17) of the Regulation (EU) 2023/1114 of the European Parliament and of the Council of 31 May 2023 on markets in crypto-assets states that “Digital assets that cannot be transferred to other holders do not fall within the definition of crypto-assets. Therefore, digital assets that are accepted only by the issuer and/or the offeror and that are technically impossible to transfer directly to other holders should be excluded from the scope of this Regulation.”

There is a need among some projects to avoid launching a token that falls under crypto-asset regulations, and a token that is not directly transferable would avoid EU regulation 2023/1114, also known as MiCA. However, some projects still require that tokens may be transferred to any address, just not directly. Systems and methods in accordance with certain embodiments of the invention may be used for transferring tokens from an owner to a receiver in an indirect manner, thereby side-stepping recital (17) of Regulation (EU) 2023/1114.

In accordance with several embodiments, token smart contracts may instantiate classes of token, for example fungible tokens (such as an Ethereum Request for Comment 20 (ERC20) type token), and/or non-fungible tokens (NFTs). In accordance with some embodiments, token smart contracts may, additionally or alternatively, instantiate transfers. In doing so, they may include, but are not limited to one or more transfer functions, limited to only allow transfers to permitted relay smart contracts. A token may thus exclusively be transferred from an owner of the token to the relay smart contract. The one or more transfer functions may, additionally or alternatively, take a further parameter, namely a final destination address parameter. The relay smart contract may subsequently be called by the token smart contract, either as part of a transfer transaction, and/or through a separate transaction, with the further parameter. The relay smart contract may then transfer the token to the final destination address as specified by the further parameter. The token smart contract may include a specific transfer function, only callable by the relay smart contract.

In accordance with numerous embodiments, actions may commence with owners of an amount of transfer limited tokens deciding to transfer the amount of transfer limited tokens to a recipient. This is not directly possible as the token smart contract only permits transfers to and/or from the permitted relay smart contract. The owners may subsequently transfer the amount of transfer limited tokens to the permitted relay smart contract, and the transfer transaction may, additionally or alternatively, include an address of the recipient. Actions may proceed with the permitted relay smart contract transferring the amount of transfer limited tokens received from the owners to the address(es) of the recipients. Through this, the amount of transfer limited tokens may end up in the possession of the recipient, without the transfer being direct.

In various embodiments of the invention, sequences of actions may commence with transactions to transfer tokens, instantiated by token contracts, from the owner of the tokens to relay smart contracts. The transactions may include a final destination address parameter. A first action taken by the token contracts on receipt of the transaction may be to transfer the token to the relay smart contract. A second action taken by the relay contracts on receipt of the transaction may be to transfer the tokens from the relay smart contracts to the final destination addresses. Thus the transfers of the tokens from the owners to the final destination addresses may not be limited to a direct transfer.

In accordance with certain embodiments, sequences of actions may commence with a transaction to transfer tokens instantiated by token contracts, from the owner of the token to a relay smart contract. The transaction may include a final destination address parameter. A first action taken by the token contract on receipt of the transaction may be to transfer the token to the relay smart contract. A second action taken by the relay contract on receipt of the transaction may be to approve a transfer of the token from the relay smart contract to the final destination address. A subsequent action initiated through a second transaction, submitted by a recipient specified by the final destination address, may be to transfer the token from the relay smart contract to the final destination address, said transfer authorized through the prior approval. Thus the transfer of the token from the owner to the final destination address is not a direct transfer.

Smart contracts in blockchains such as Ethereum are registered with an Ethereum address, which resembles an address of an externally owned account (EOA), in that it consists of the characters Ox followed by 40 hexadecimal characters. Nevertheless, smart contract addresses are generated through a different process to EOA addresses. Producing an EOA address requires a private key, namely a randomly generated 256-bit number, from which an ECDSA public key is derived that is 512 bits long. The public key is then hashed with the Keccak-256 hash function, and the rightmost 160 bits are used to produce the Ethereum address. An EOA address therefore has a corresponding private key that may be used to sign transactions, and such signatures may subsequently be verified to confirm the validity of the transaction. Smart contracts on Ethereum do not have a private key, as such a private key cannot be stored privately on the Ethereum blockchain, which is a public unencrypted record readable by anyone. Instead, a smart contract address is derived from the Ethereum address of the EOA deploying the contract, and a nonce, through Keccak-256 hashing and using the rightmost 160 bits. Smart contracts are therefore currently not able to digitally sign things.

Nevertheless, there are occasions where an Ethereum smart contract may be required to digitally sign something. For example, a smart contract may instantiate a multi-sig wallet registered as the owner of a token smart contract, and a crypto exchange may require a digital signature to prove that the token contract is owned by a particular entity before listing the token on the exchange. Such multi-sig wallet smart contracts are currently not able to perform such a signing activity. A clumsy workaround is to temporarily transfer ownership of the token smart contract to an EOA, produce and provide the signature, and then transfer ownership back to the multi-sig wallet smart contract. However, when the co-owners of the multi-sig wallet smart contract do not fully trust one another, this workaround is not practical.

In accordance with many embodiments, smart contracts may include data fields for storing addresses (e.g., “signatory”, “authorized signatory” and/or other equivalent terms) referred to as a signatory field. In some embodiments, the signatory may be set at the time of creation of the smart contract, and may be equal to a deployer of the smart contract and/or an owner of the smart contract. In multiple embodiments, the smart contracts may include a function for setting the signatory after the smart contract is created. In various embodiments, the signatory field may include but is not limited to an array of addresses, and a further data field recording a number of signatures required for a decision to be ratified and/or a contract to be valid.

By standardizing on expected naming and storage convention for smart contracts to grant procuration to an address and/or addresses of externally owned accounts, such addresses may subsequently perform digital signing off-chain on behalf of the smart contracts.

Applications and methods in accordance with many embodiments of the invention are not limited to use within NFT platforms. Accordingly, it should be appreciated that the capabilities of any assurance systems described herein may also be implemented outside the context of an NFT platform network architecture unrelated to the storage of fungible tokens and/or NFTs. Moreover, any of the processes for identity, authenticity, and transaction security described herein with reference to FIGS. 35-41 may be utilized within any of the systems implemented within the NFT platforms described above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for verifying user identity, the method comprising:
associating a biometric identifier of a user with:
a token; and
a cryptographic key, wherein the cryptographic key is associated with a set of access rights to the token;
obtaining, from a sensor, biometric data, wherein the biometric data corresponds to the user;
verifying whether the biometric data matches the biometric identifier; and
when the biometric data matches the biometric identifier beyond a pre-determined threshold:
obtaining access to at least part of the cryptographic key; and
accessing the token, wherein access is performed:
using the cryptographic key, and
according to the set of access rights.

2. The method of claim 1, wherein the token is a non-fungible token (NFT).

3. The method of claim 2, wherein:
the NFT is associated with media content; and
the NFT is stored in a digital wallet owned by the user.

4. The method of claim 3, wherein an access right of the set of access rights is selected from the group consisting of viewing the media content associated with the token, editing the media content associated with the token, copying the token, transferring the token, deleting digital assets associated with the token, assigning at least one access right to another entity, and revoking the association between the biometric identifier and the set of access rights.

5. The method of claim 4, wherein the sensor is:
a camera; and
additionally configured to:
detect when the user views the media content associated with the token; and
identify aspects of the media content that the user focuses on.

6. The method of claim 5, further comprising at least one of:
curating additional content in the digital wallet according to the aspects; and
sending a creator of the token a royalty when the user views the media content associated with the token.

7. The method of claim 1, wherein the set of access rights is determined based on a policy associated with the token.

8. The method of claim 7, wherein the policy is associated with a smart contract.

9. The method of claim 1, wherein the association between the biometric identifier and the set of access rights is at least one of:
an association expressed using a certificate;
an association that has a pre-determined duration based on a policy associated with the token; or
an association that is revocable by a party with an access right.

10. The method of claim 1, wherein access to a remaining part of the cryptographic key is obtained using a digital signature.

11. A non-transitory computer-readable medium storing instructions that, when executed by a processor, are configured to cause the processor to perform operations for verifying user identity, the operations comprising:
associating a biometric identifier of a user with:
a token; and
a cryptographic key, wherein the cryptographic key is associated with a set of access rights to the token;
obtaining, from a sensor, biometric data, wherein the biometric data corresponds to the user;
verifying whether the biometric data matches the biometric identifier; and
when the biometric data matches the biometric identifier beyond a pre-determined threshold:
obtaining access to at least part of the cryptographic key; and
accessing the token, wherein access is performed:
using the cryptographic key, and
according to the set of access rights.

12. The non-transitory computer-readable medium of claim 11, wherein the token is a non-fungible token (NFT).

13. The non-transitory computer-readable medium of claim 12, wherein:
the NFT is associated with media content; and
the NFT is stored in a digital wallet owned by the user.

14. The non-transitory computer-readable medium of claim 13, wherein an access right of the set of access rights is selected from the group consisting of viewing the media content associated with the token, editing the media content associated with the token, copying the token, transferring the token, deleting digital assets associated with the token, assigning at least one access right to another entity, and revoking the association between the biometric identifier and the set of access rights.

15. The non-transitory computer-readable medium of claim 14, wherein the sensor is:
a camera; and
additionally configured to:
detect when the user views the media content associated with the token; and
identify aspects of the media content that the user focuses on.

16. The non-transitory computer-readable medium of claim 15, further comprising at least one of:
curating additional content in the digital wallet according to the aspects; and
sending a creator of the token a royalty when the user views the media content associated with the token.

17. The non-transitory computer-readable medium of claim 11, wherein the set of access rights is determined based on a policy associated with the token.

18. The non-transitory computer-readable medium of claim 17, wherein the policy is associated with a smart contract.

19. The non-transitory computer-readable medium of claim 11, wherein the association between the biometric identifier and the set of access rights is at least one of:
an association expressed using a certificate;
an association that has a pre-determined duration based on a policy associated with the token; or
an association that is revocable by a party with an access right.

20. The non-transitory computer-readable medium of claim 11, wherein access to a remaining part of the cryptographic key is obtained using a digital signature.
